(19) United States
(12) Patent Application Publication
(10) Pub. No.: US 2025/0300346 A1
(43) Pub. Date: Sep. 25, 2025

(54) SELF CALIBRATION OF PHASED ARRAY ANTENNA WITH OVER-THE-AIR AND IN-LINE CALIBRATION MEASUREMENTS

(71) Applicant: Space Exploration Technologies Corp., Hawthorne, CA (US)

(72) Inventor: Ersin Yetisir, Redmond, WA (US)

(21) Appl. No.: 19/081,987

(22) Filed: Mar. 17, 2025

Related U.S. Application Data
(60) Provisional application No. 63/567,348, filed on Mar. 19, 2024.

(51) Int. Cl. H01Q 3/26; H01Q 1/28

(52) U.S. Cl. CPC H01Q 3/267; H01Q 1/288

(57) ABSTRACT

A method includes performing a first relative calibration of a first plurality of periodically spaced antenna elements of an antenna lattice based on OTA calibration measurements to obtain a calibrated first plurality of periodically spaced antenna elements, performing a second relative calibration of a second plurality of periodically spaced antenna elements of the antenna lattice based on OTA calibration measurements, performing a third relative calibration of complex gains of a first subset of the first plurality of periodically spaced antenna elements and a second subset of antenna elements of the second plurality of periodically spaced antenna elements based on in-line calibration measurements of coupling between a calibration line and respective antenna elements of the first subset of antenna elements and the second subset of antenna elements and calibrating complex gains of the first plurality of periodically spaced antenna elements and the second plurality of periodically spaced antenna elements.

### CROSS-REFERENCE TO RELATED APPLICATIONS

The present application claims the benefit of, and priority to, U.S. Provisional Patent Application No. 63/567,348 filed Mar. 19, 2024 entitled “SELF CALIBRATION OF PHASED ARRAY ANTENNA WITH OVER-THE-AIR AND IN-LINE CALIBRATION MEASUREMENTS”, the contents of which are hereby incorporated by reference in their entirety.

### TECHNICAL FIELD

The present disclosure pertains to antenna apparatuses for satellite communication systems and calibration architectures for antenna arrays.

### BACKGROUND

Satellite communication systems generally involve Earth-based antennas in communication with a constellation of satellites in orbit. Earth-based antennas are, of consequence, exposed to weather and other environmental conditions. Therefore, described herein are antenna apparatuses and their housing assemblies designed with sufficient durability to protect internal antenna components while enabling radio frequency communications with a satellite communication system, such as a constellation of satellites.

Phased array antennas are used in a variety of wireless communication systems such as satellite and cellular communication systems. The phased array antennas can include a number of antenna elements arranged to behave as a larger directional antenna. Moreover, a phased array antenna can be used to increase an overall directivity and gain, steer the angle of array for greater gain and directivity, perform interference cancellation from one or more directions, determine the direction of arrival of received signals, and improve a signal to interference ratio, among other things. Advantageously, a phased array antenna can be configured to implement beamforming techniques to transmit and/or receive signals in a preferred direction without physically repositioning or reorientation.

In some cases, variations in weather and other environmental conditions can change performance characteristics of antenna elements in a phased array antenna such as gain, phase, delay, or the like. Various calibration procedures can be performed during operation of a phased array antenna to compensate for variations in performance characteristics.

### SUMMARY

In accordance with one embodiment of the present disclosure, a method for calibrating a phased array antenna is provided. The method includes performing a first relative calibration of complex gains of a first plurality of periodically spaced antenna elements of an antenna lattice based on OTA calibration measurements to obtain a calibrated first plurality of periodically spaced antenna elements, performing a second relative calibration of complex gains of a second plurality of periodically spaced antenna elements of the antenna lattice based on OTA calibration measurements, performing a third relative calibration of complex gains of a first subset of antenna elements of the first plurality of periodically spaced antenna elements and a second subset of antenna elements of the second plurality of periodically spaced antenna elements based on in-line calibration measurements of coupling between a calibration line and respective antenna elements of the first subset of antenna elements and the second subset of antenna elements to obtain a relative calibration, and calibrating complex gains of the first plurality of periodically spaced antenna elements and the second plurality of periodically spaced antenna elements based on the relative calibration.

In accordance with another embodiment of the present disclosure, an apparatus for calibrating phased array antenna is provided. The apparatus includes an antenna lattice comprising a first plurality of periodically spaced antenna elements coupled to a first carrier and a second plurality of periodically spaced antenna elements coupled to a second carrier, wherein periodicity of the antenna lattice is disrupted between the first plurality of periodically spaced antenna elements and the second plurality of periodically spaced antenna elements; a calibration line coupled to a first subset of antenna elements of the first plurality of periodically spaced antenna elements and a second subset of antenna elements of the second plurality of periodically spaced antenna elements, wherein the calibration line comprises a plurality of calibration line segments between pairs of antenna elements included in at least one of the first subset of antenna elements or the second subset of antenna elements and wherein respective effective lengths of the plurality of calibration line segments are known; and one or more calibration components configured to: perform a first relative calibration of complex gains of the first plurality of periodically spaced antenna elements based on over-the-air (OTA) calibration measurements to obtain a calibrated first plurality of periodically spaced antenna elements; perform a second relative calibration of complex gains of the second plurality of periodically spaced antenna elements based on OTA calibration measurements; perform a third relative calibration of complex gains of the first subset of antenna elements and the second subset of antenna elements based on in-line calibration measurements of coupling between the calibration line and respective antenna elements of the first subset of antenna elements and the second subset of antenna elements to obtain a relative calibration; and calibrate complex gains of the first plurality of periodically spaced antenna elements and the second plurality of periodically spaced antenna elements based on the relative calibration.

In another example, a non-transitory computer-readable medium is provided that has stored thereon instructions that, when executed by one or more processors, cause the one or more processors to: perform a first relative calibration of complex gains of a first plurality of periodically spaced antenna elements of an antenna lattice based on OTA calibration measurements to obtain a calibrated first plurality of periodically spaced antenna elements, perform a second relative calibration of complex gains of a second plurality of periodically spaced antenna elements of the antenna lattice based on OTA calibration measurements, perform a third relative calibration of complex gains of a first subset of antenna elements of the first plurality of periodically spaced antenna elements and a second subset of antenna elements of the second plurality of periodically spaced antenna elements based on in-line calibration measurements of coupling between a calibration line and respective antenna elements of the first subset of antenna elements and the second subset of antenna elements to obtain a relative calibration, and calibrate complex gains of the first plurality of periodically spaced antenna elements and the second plurality of periodically spaced antenna elements based on the relative calibration.

In accordance with another embodiment of the present disclosure, an apparatus for calibrating a phased array antenna is provided. The apparatus includes: means for performing a first relative calibration of complex gains of a first plurality of periodically spaced antenna elements of an antenna lattice based on OTA calibration measurements to obtain a calibrated first plurality of periodically spaced antenna elements, means for performing a second relative calibration of complex gains of a second plurality of periodically spaced antenna elements of the antenna lattice based on OTA calibration measurements, means for performing a third relative calibration of complex gains of the first subset of antenna elements of the first plurality of periodically spaced antenna elements and a second subset of antenna elements of the second plurality of periodically spaced antenna elements based on in-line calibration measurements of coupling between a calibration line and respective antenna elements of the first subset of antenna elements and the second subset of antenna elements to obtain a relative calibration, and means for calibrating complex gains of the first plurality of periodically spaced antenna elements and the second plurality of periodically spaced antenna elements based on the relative calibration.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a not-to-scale diagram illustrating a simple example of communication in a satellite communication system, in accordance with some embodiments of the present disclosure;

FIG. 2A is an example illustration of a top view of a phased array antenna system, in accordance with some embodiments of the present disclosure;

FIG. 2B is an example illustration showing a beamformer (BF) lattice associated with a phased array antenna system, in accordance with some embodiments of the present disclosure;

FIG. 3 shows a polar plot illustrating an example main lobe and side lobes emanating from an exemplary phased array antenna system, in accordance with some embodiments of the present disclosure;

FIG. 4A illustrates an example phased array antenna system in a transmit (TX) configuration, in accordance with some embodiments of the present disclosure;

FIG. 4B illustrates the example phased array antenna system of FIG. 4A in a receive (RX) configuration, in accordance with some embodiments of the present disclosure;

FIG. 4C and FIG. 4D illustrate example over-the-air (OTA) calibration configurations for calibrating phased array antenna systems with dual-use antenna ports, in accordance with some embodiments of the present disclosure;

FIG. 4E illustrates an example calibration configuration for calibrating a TX antenna array with antenna elements that have two antenna ports and use the functional TX port as a dual-use antenna port for calibration, in accordance with some embodiments of the present disclosure;

FIG. 4F illustrates an additional example calibration configuration for calibrating a TX antenna array of antenna elements with a dual-use antenna port that is different from the functional TX port, in accordance with some embodiments of the present disclosure;

FIG. 4G illustrates an example calibration configuration for calibration based on a TX signal without requiring a coherent receive (RX) measurement port from BFs or front end modules (FEMs), in accordance with some embodiments of the present disclosure;

FIG. 5A illustrates an example calibration configuration for calibrating antenna elements in a phased array antenna with antenna elements having dual-use ports for transmitted and received calibration signals, in accordance with some embodiments of the present disclosure;

FIG. 5B illustrates an additional example calibration configuration for a phased array antenna with antenna elements having common calibration ports for transmitted and received calibration signals, in accordance with some embodiments of the present disclosure;

FIG. 5C and FIG. 5D illustrate example calibration configurations for resolving ambiguity in calibration solutions based on OTA calibration measurements, in accordance with some embodiments of the present disclosure;

FIG. 6 illustrates an example calibration configuration for a phased array antenna system including antenna elements with dedicated antenna ports for transmitting and for receiving, in accordance with some embodiments of the present disclosure;

FIG. 7 illustrates an example calibration measurement configuration for a phased array antenna system including antenna elements with dedicated antenna ports for transmitting and for receiving, in accordance with some embodiments of the present disclosure;

FIG. 8A illustrates an example calibration configuration incorporating additional redundancy to supplement OTA mutual coupling measurements for OTA calibration of a phased array antenna system, in accordance with some embodiments of the present disclosure;

FIG. 8B illustrates a detailed view of a subsection of the antenna lattice of the calibration configuration 800 of FIG. 8A including a portion of a calibration line, in accordance with some embodiments of the present disclosure;

FIG. 8C illustrates an example calibration result for calibration of antenna elements coupled to a calibration line, in accordance with some embodiments of the present disclosure;

FIG. 8D and FIG. 8E illustrate an example calibration configuration that can be used to perform OTA calibration of columns of antenna elements using a reference subset of self-calibrated antenna-elements coupled to a calibration line, in accordance with some embodiments of the present disclosure;

FIG. 8F illustrates an example calibration configuration that can be used to perform OTA calibration of rows of antenna elements using a reference subset of self-calibrated antenna-elements coupled to a calibration line, in accordance with some embodiments of the present disclosure;

FIG. 9A illustrates an example configuration of a two-way FEM with dedicated transmit and receive ports coupled to respective dual port antenna elements of a sub-array of two antenna elements of an antenna lattice, in accordance with some embodiments of the present disclosure;

FIG. 9B illustrates an example configuration of a three-way FEM with dedicated transmit and receive ports coupled to respective dual port antenna elements of a sub-array of three antenna elements of an antenna lattice, in accordance with some embodiments of the present disclosure;

FIG. 9C and FIG. 9D illustrate example configurations for sharing radio frequency input/output (RFIO) ports between pairs of two-way FEMs coupled to four antenna element sub-arrays arranged in a linear configuration, in accordance with some embodiments of the present disclosure;

FIG. 9E through FIG. 9H illustrate example configurations for sharing RFIO ports between pairs of two-way FEMs coupled to four antenna element sub-arrays arranged in a rectangular configuration, in accordance with some embodiments of the present disclosure;

FIG. 9I illustrates an example calibration configuration for calibrating a rectangular array of antenna elements that includes four rows and four columns, in accordance with some embodiments of the present disclosure;

FIG. 10A illustrates an example calibration configuration for calibrating antenna elements in a two-dimensional (2D) phased array antenna, in accordance with some embodiments of the present disclosure;

FIG. 10B illustrates an example calibration configuration for calibrating rows of antenna elements in the example calibration configuration of FIG. 10A, in accordance with some embodiments of the present disclosure;

FIG. 10C illustrates an example calibration outcome for calibrating rows of antenna elements using the example calibration configuration of FIG. 10B, in accordance with some embodiments of the present disclosure;

FIG. 10D illustrates an example calibration configuration for calibrating columns of antenna elements in the example calibration configuration of FIG. 10A, in accordance with some embodiments of the present disclosure;

FIG. 10E illustrates an example calibration outcome for calibrating columns of antenna elements using the example calibration configuration of FIG. 10D, in accordance with some embodiments of the present disclosure;

FIG. 11A and FIG. 11B illustrate example calibration configurations including four antenna element sub-arrays for calibrating a phased array antenna system using a single sub-array parameter, in accordance with some embodiments of the present disclosure;

FIG. 12 illustrates an example edge antenna element calibration configuration, in accordance with some embodiments of the present disclosure;

FIG. 13A illustrates an example antenna lattice configuration for performing OTA calibration measurements for a phased array antenna system with antenna elements distributed on different printed circuit boards (PCBs), in accordance with some embodiments of the present disclosure;

FIG. 13B illustrates an example calibration configuration that can be used to calibrate the antenna elements in the antenna lattice configuration 1300 of FIG. 13A, in accordance with some embodiments of the present disclosure;

FIG. 13C illustrates an additional example calibration configuration that can be used to calibrate the antenna elements in the antenna lattice configuration 1300 of FIG. 13A across two dimensions, in accordance with some embodiments of the present disclosure;

FIG. 14 illustrates a cross-sectional view of a row of antenna elements along a calibration line extending between different PCBs of a phased array antenna system, in accordance with some embodiments of the present disclosure;

FIG. 15 is a flow diagram illustrating a process for OTA calibration of antenna elements for a phased array antenna system, in accordance with some embodiments of the present disclosure;

FIG. 16 illustrates an example computing system, in accordance with some embodiments of the present disclosure.

### DETAILED DESCRIPTION

Various embodiments of the disclosure are discussed in detail below. While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Language such as “top”, “bottom”, “upper”, “lower”, “vertical”, “horizontal”, “lateral”, in the present disclosure is meant to provide orientation for the reader with reference to the drawings and is not intended to be the required orientation of the components or to impart orientation limitations into the claims.

The phrase “coupled to” refers to any component that is physically connected to another component either directly or indirectly, and/or any component that is in communication with another component (e.g., connected to the other component over a wired or wireless connection, capacitive or inductive RF coupling scheme, and/or other suitable communication interface) either directly or indirectly.

Embodiments of the present disclosure are directed to antenna apparatuses including phased array antenna systems designed for sending and/or receiving radio frequency signals and calibration systems and techniques for such antenna apparatuses.

The phased array antenna systems of the present disclosure may be employed in communication systems providing high-bandwidth, low-latency network communication via a constellation of satellites. Such constellation of satellites may be in a non-geosynchronous Earth orbit (GEO), such as a low Earth orbit (LEO).

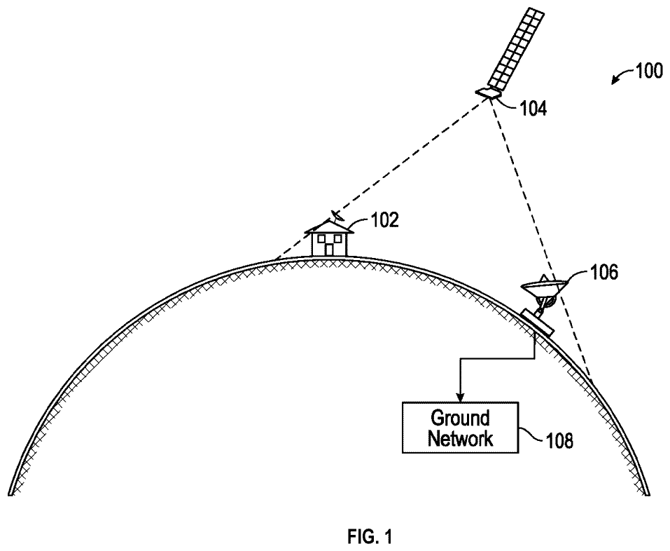

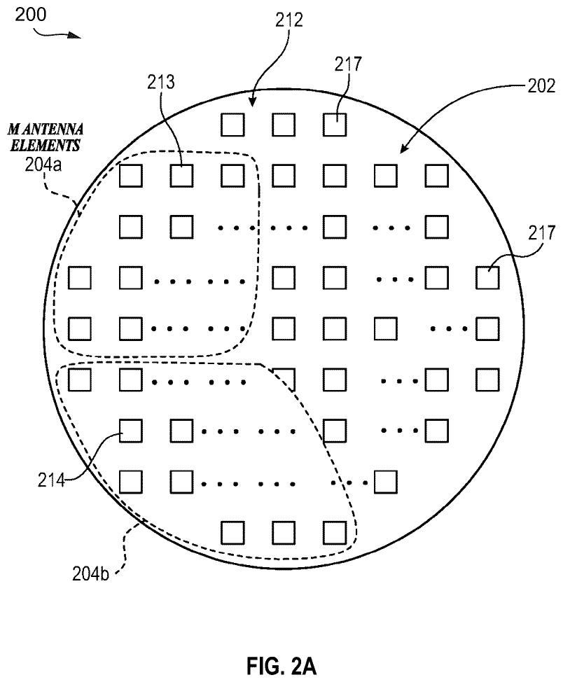

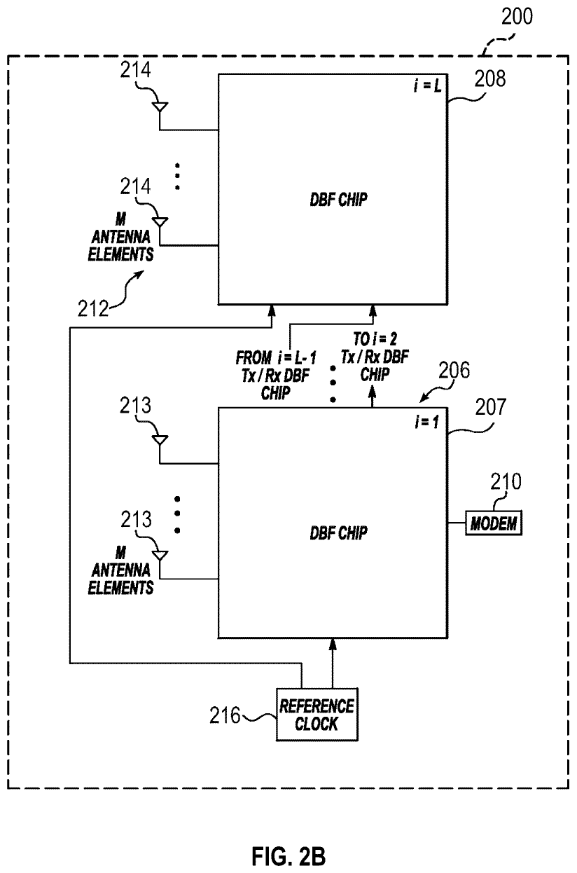

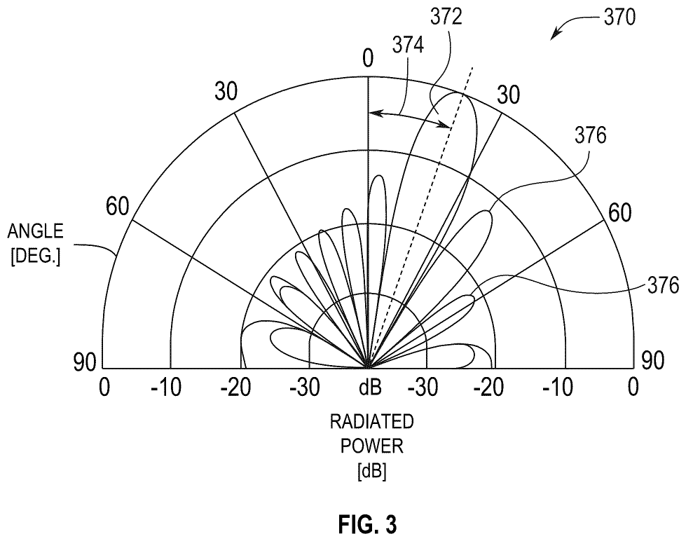

The disclosed systems and techniques will be described in the following disclosure as follows. The discussion begins with a description of example systems and technologies for wireless communications and example phased array antenna systems and circuits, as illustrated in FIG. 1, FIG. 2A, and FIG. 2B. A plot showing an example main lobe and side lobes emanating from an exemplary antenna array of a phased array antenna system, as illustrated in FIG. 3, will then follow.

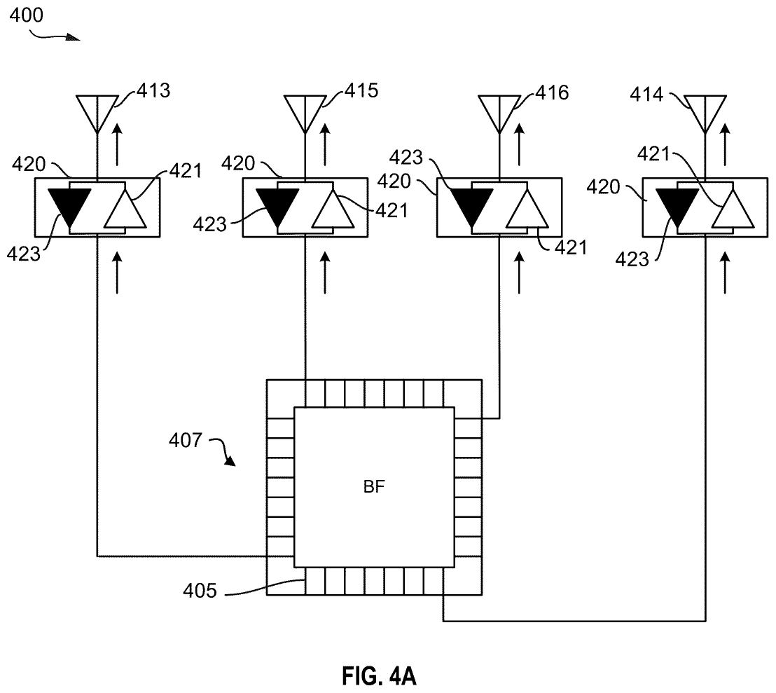

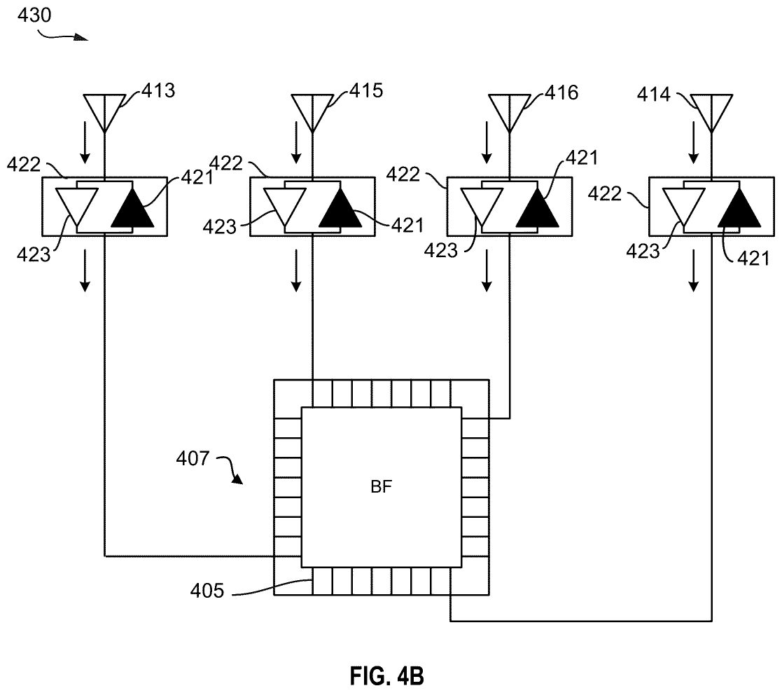

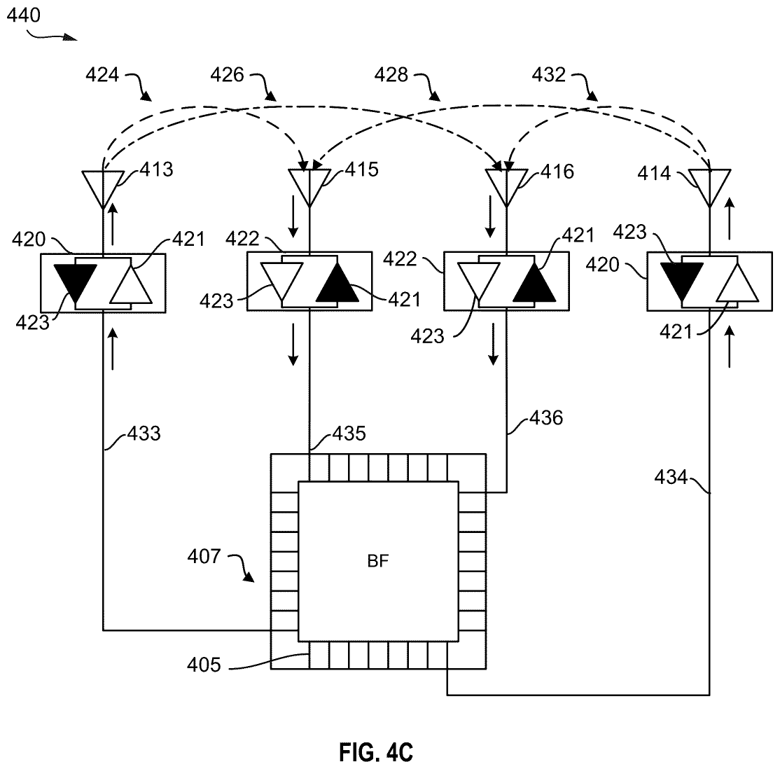

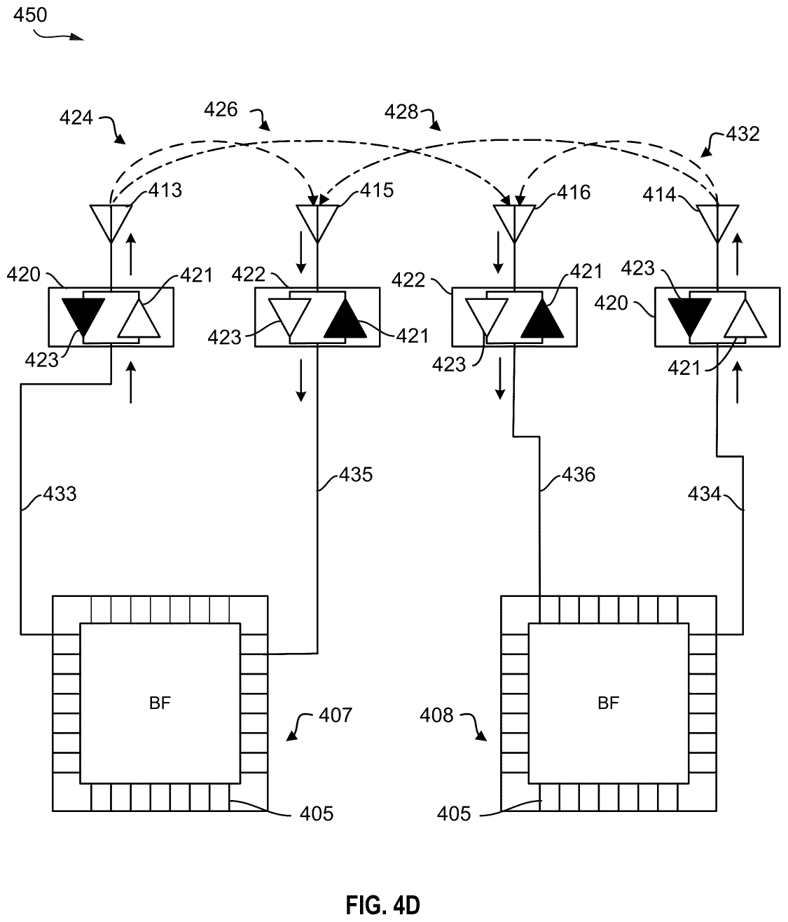

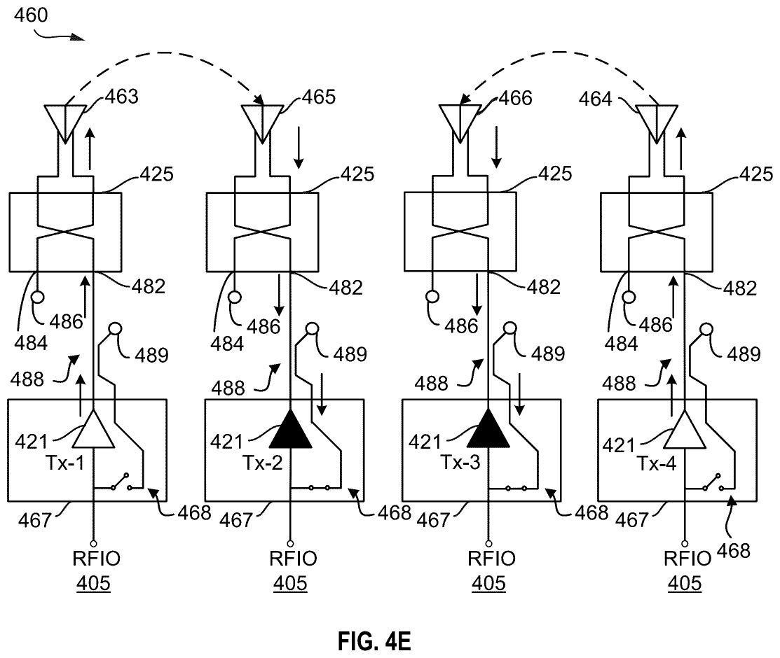

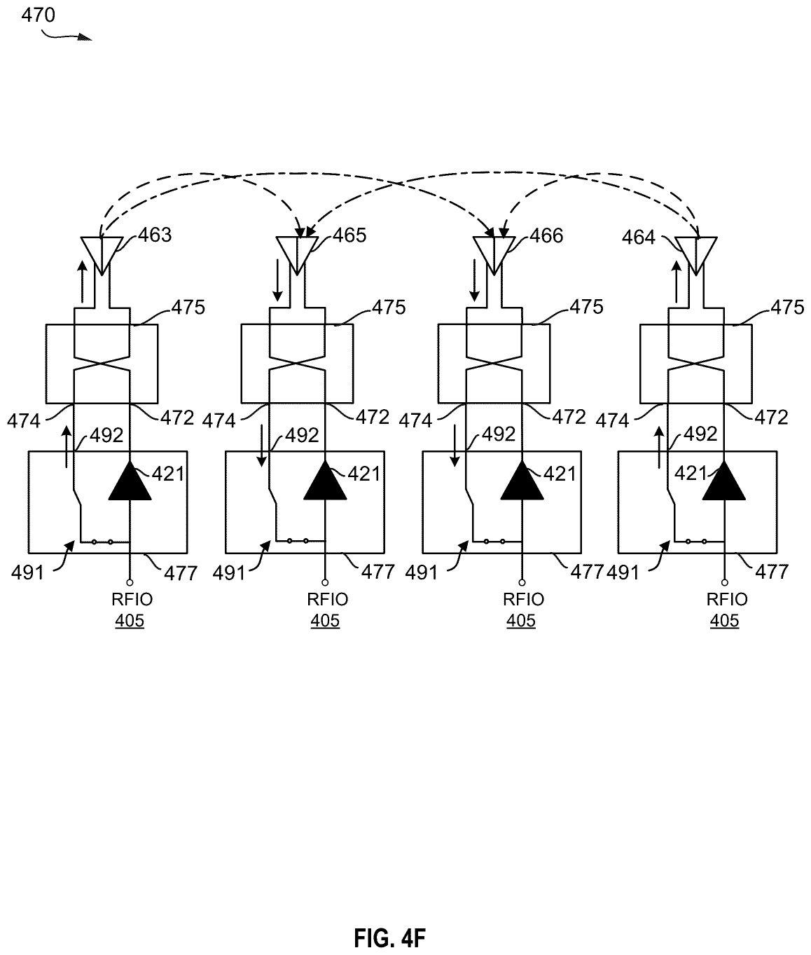

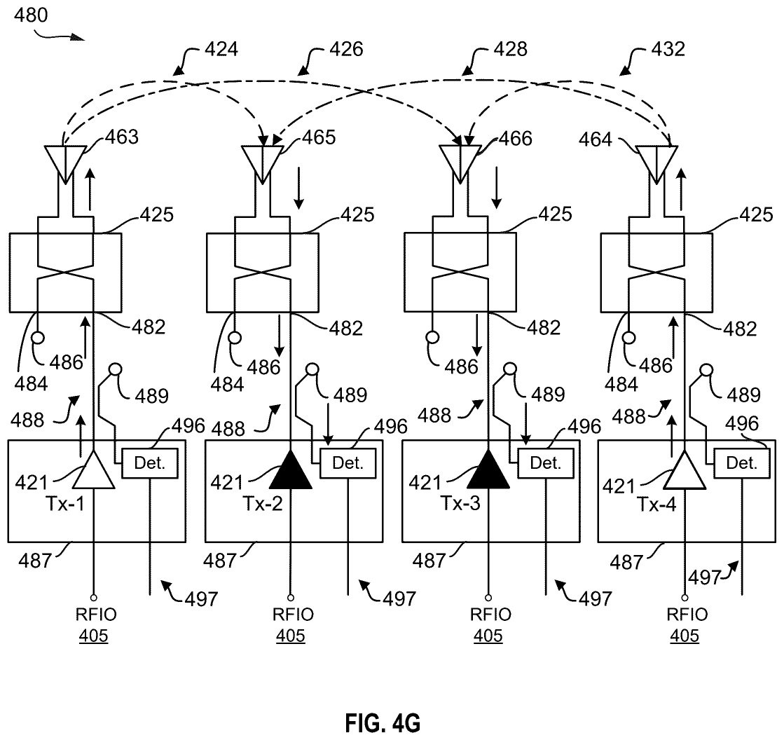

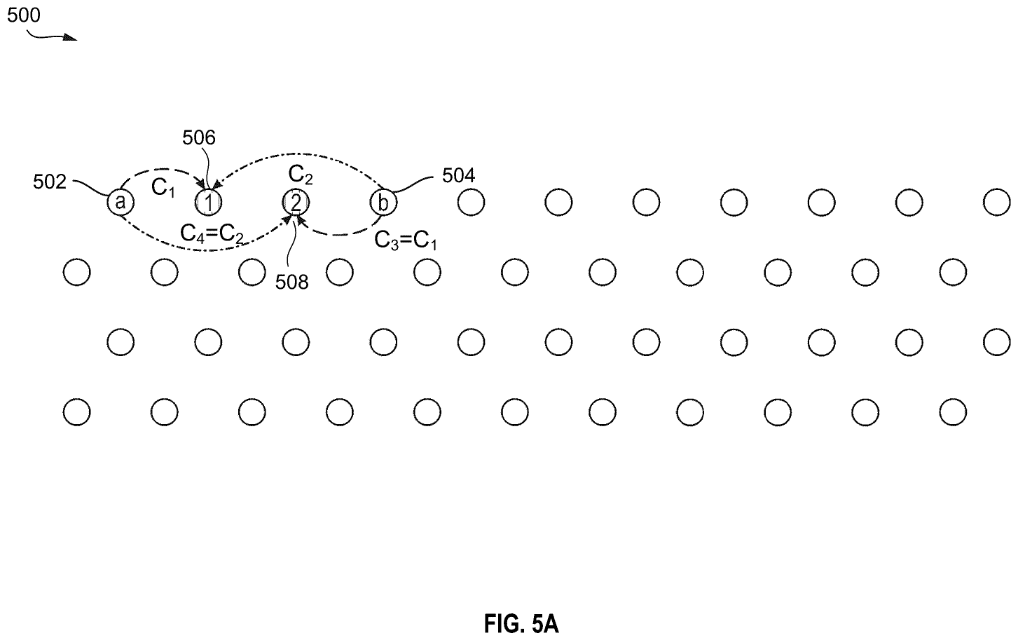

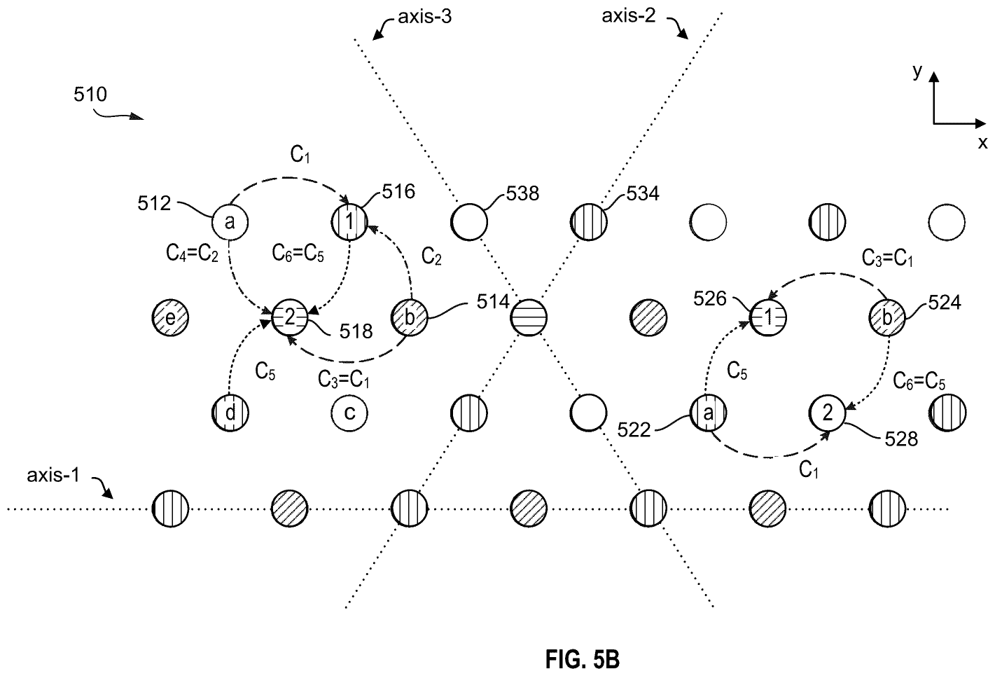

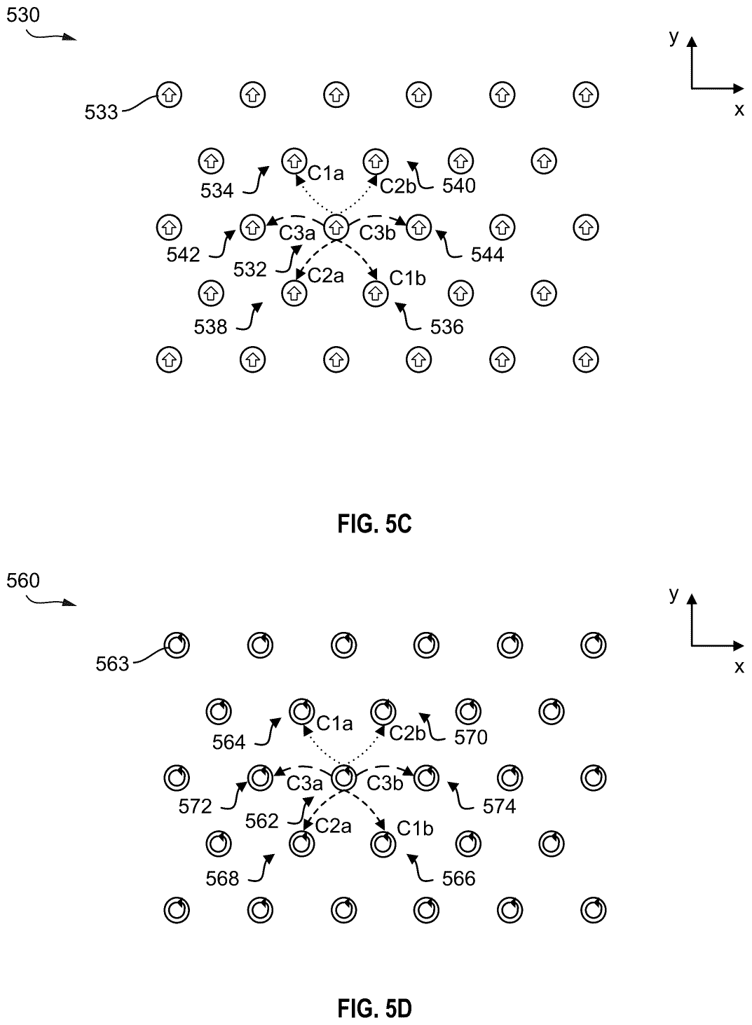

Example configurations for operating a phased array antenna system in transmit (TX) and receive (RX) configurations, as illustrated in FIG. 4A and FIG. 4B, will then follow. Example over-the-air (OTA) calibration configurations for a phased array antenna system with antenna elements having dual-use antenna ports, as illustrated in FIG. 4C and FIG. 4D, will then follow. Example illustrations of calibration configurations for calibrating antenna arrays with antenna elements having two antenna ports that use one of the antenna ports as a dual-use port for transmitting and receiving signals during calibration, as illustrated in FIG. 4E and FIG. 4F, will then follow. Example calibration configurations for a phased array antenna with antenna elements having dual-use ports for transmitted and received calibration signals, as illustrated in FIG. 5A and FIG. 5B, will then follow. Example calibration configurations for resolving ambiguity in calibration solutions based on OTA calibration measurements, as illustrated in FIG. 5C and FIG. 5D, will then follow.

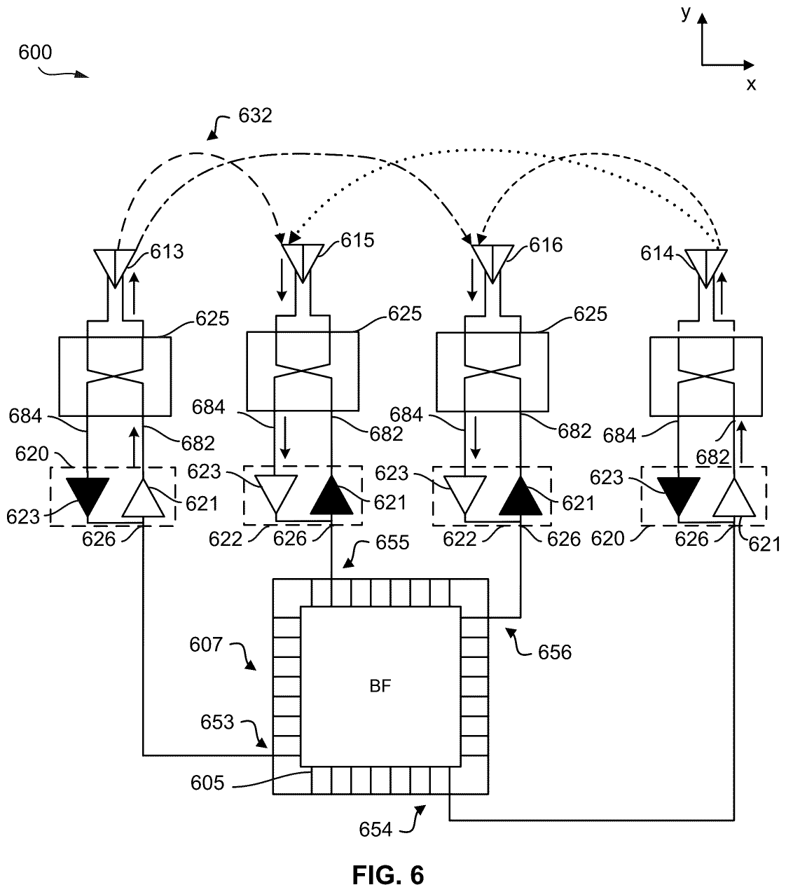

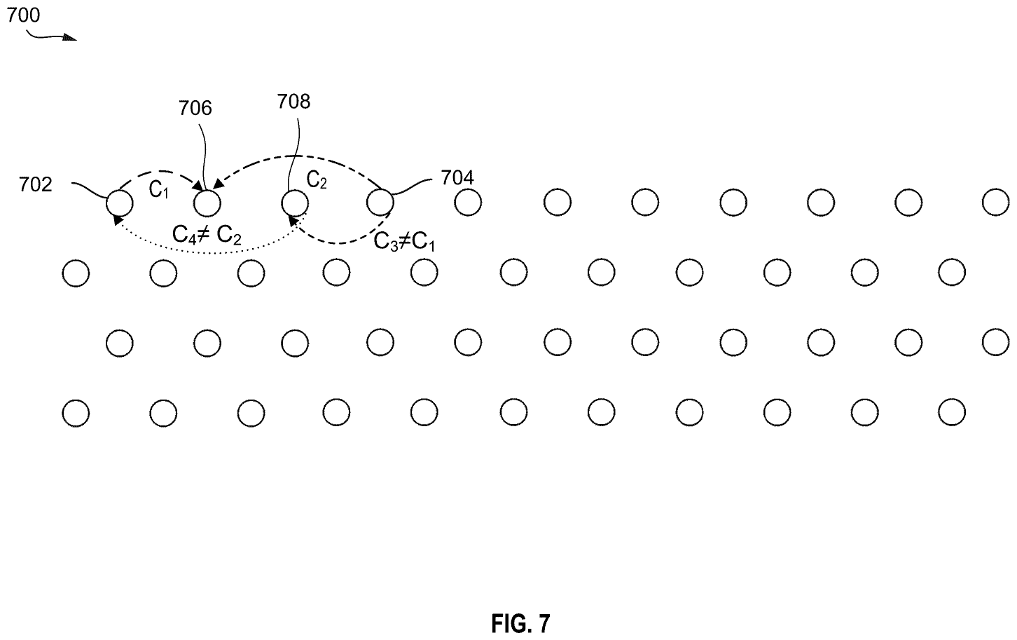

Example calibration configurations for a phased array antenna system including antenna elements with dedicated antenna ports for transmitting and for receiving (e.g., transmit and receive pins of the FEM and/or beamforming components are each connected to a different port of a dual-polarized antenna element), as illustrated in FIG. 6, will then follow. Example calibration measurements for a phased array antenna system including antenna elements with dedicated antenna ports for transmitting and for receiving, as illustrated in FIG. 7, will then follow.

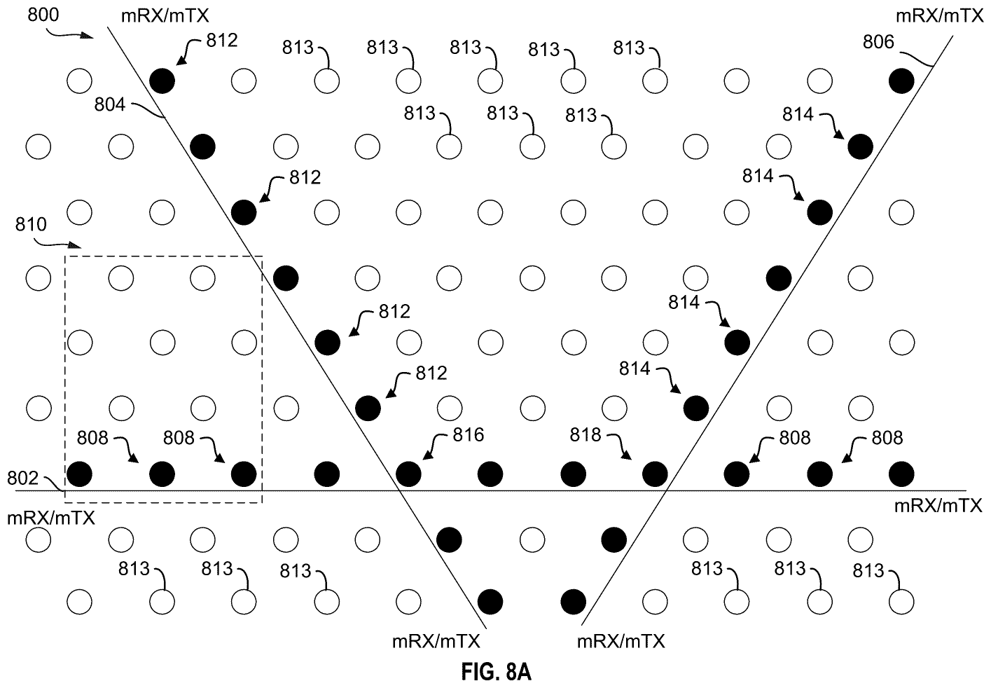

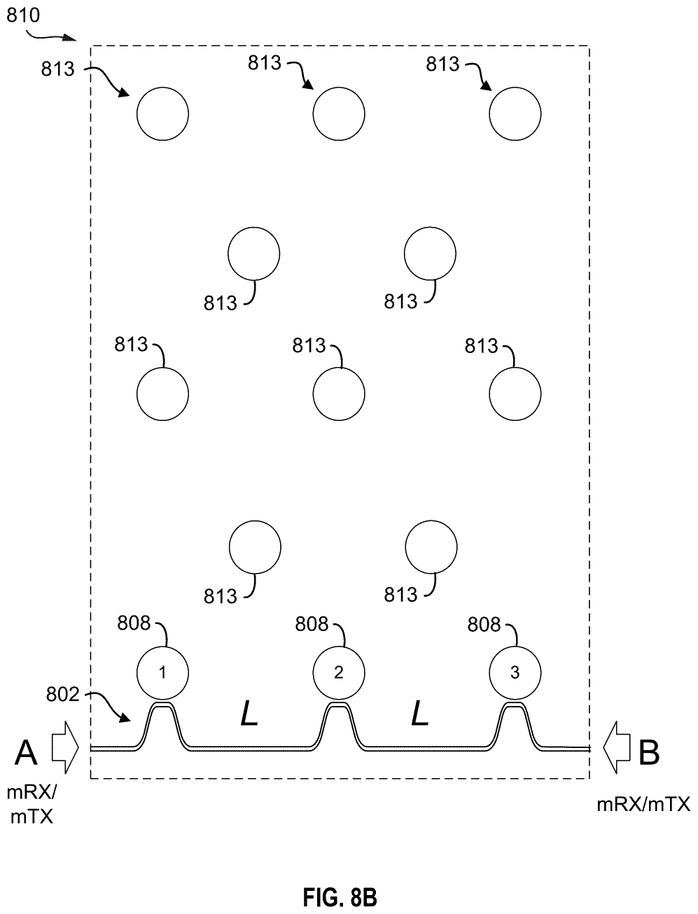

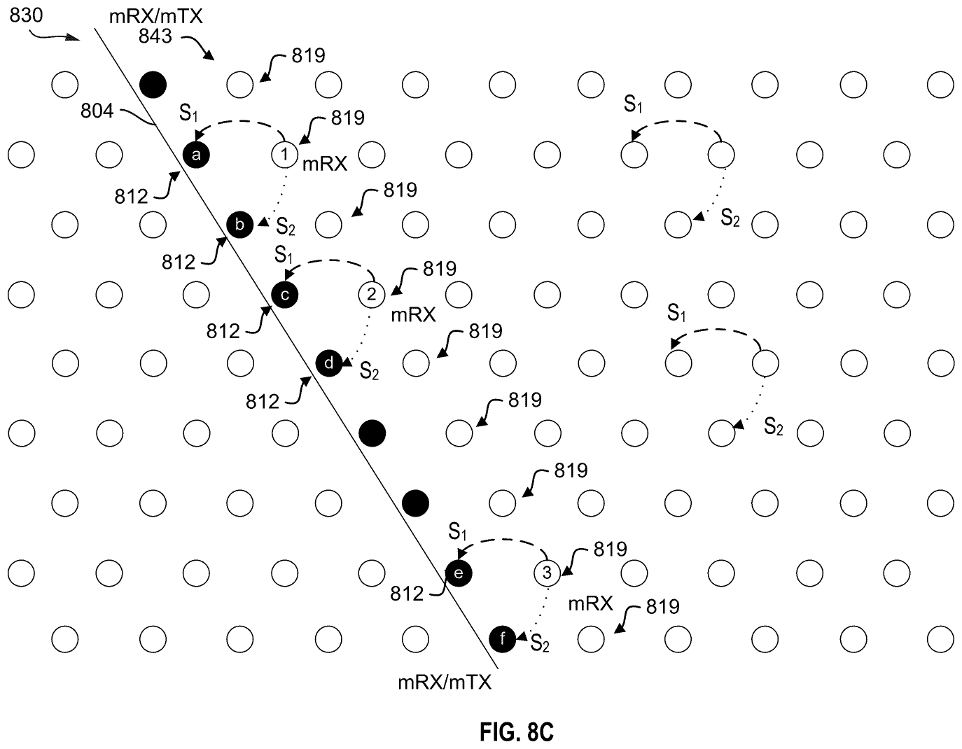

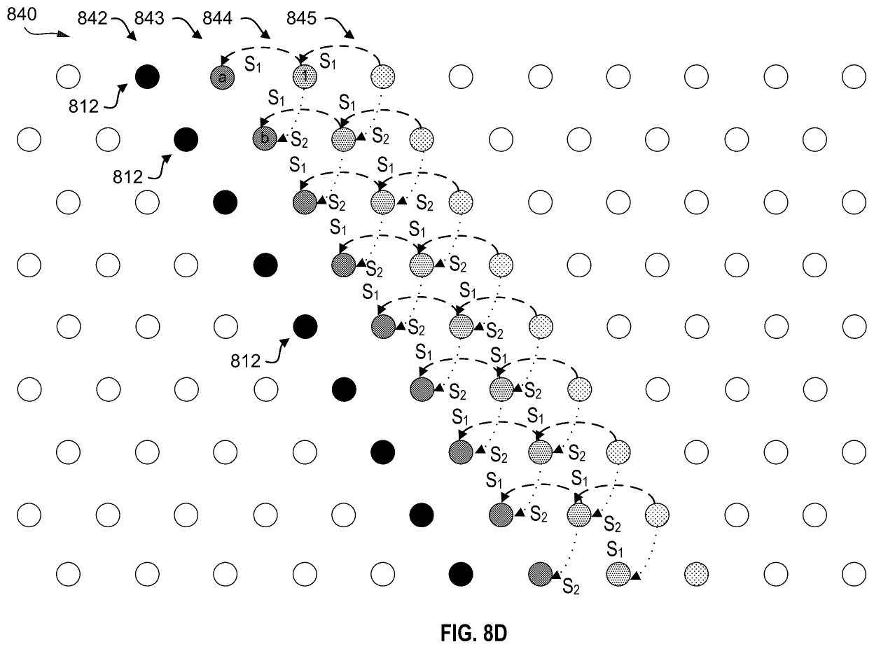

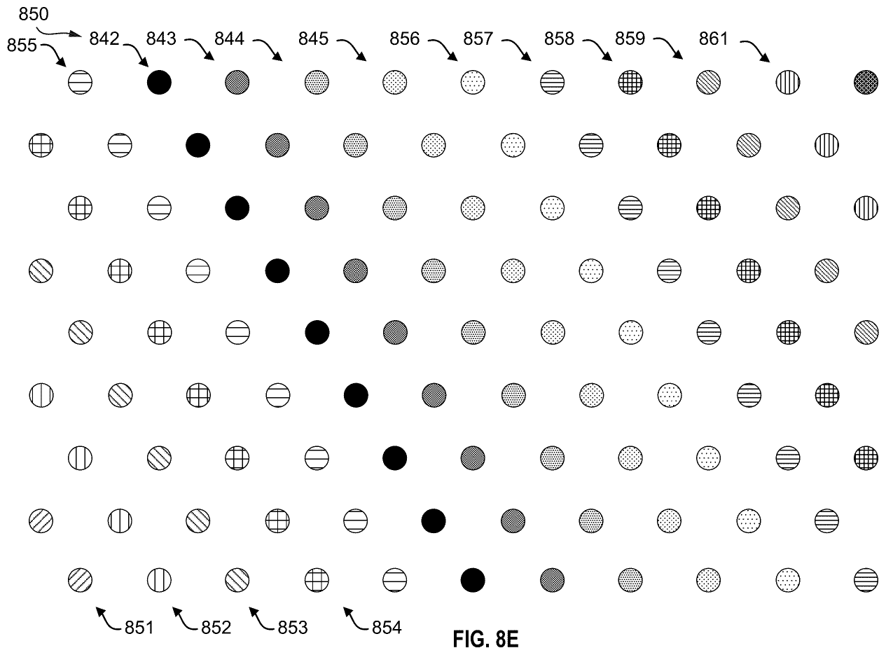

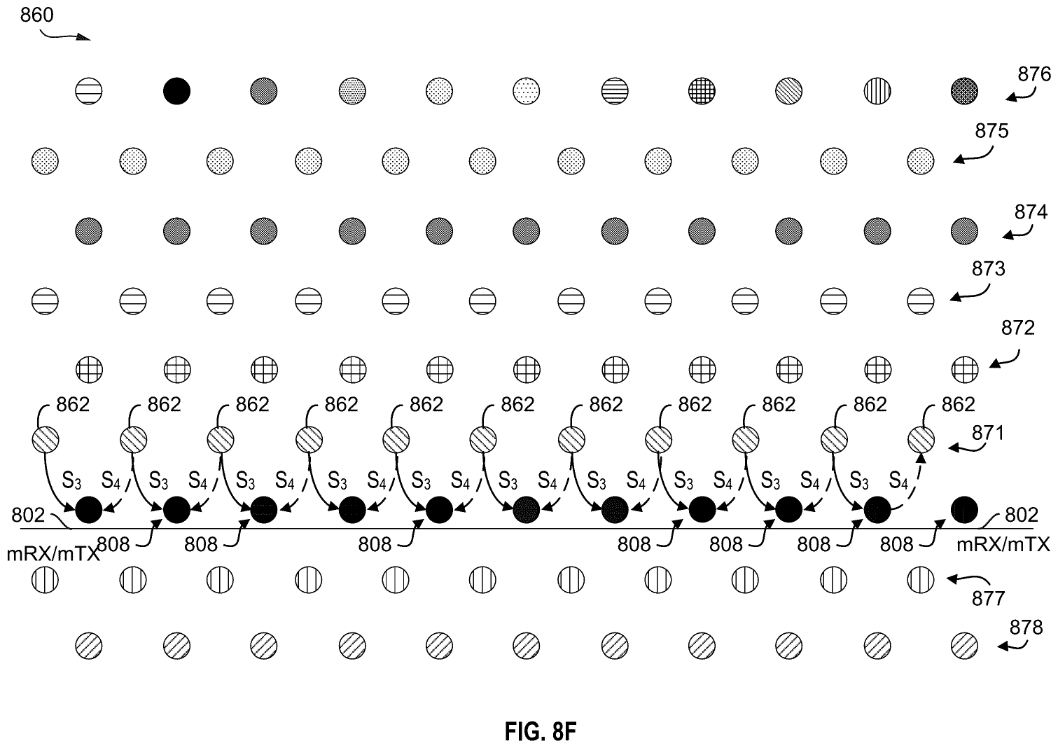

An example calibration configuration incorporating additional redundancy to supplement OTA mutual coupling measurements for OTA calibration of a phased array antenna system, as illustrated in FIG. 8A, will then follow. A detailed view of a subsection of the antenna lattice of the calibration configuration 800 of FIG. 8A including a portion of a calibration line, as illustrated in FIG. 8B, will then follow. An example calibration result for calibration of antenna elements coupled to a calibration line, as illustrated in FIG. 8C, will then follow. An example calibration configuration that can be used to perform OTA calibration of columns of antenna elements using a reference subset of self-calibrated antenna-elements coupled to a calibration line, as illustrated in FIG. 8D and FIG. 8E, will then follow. An example calibration configuration that can be used to perform OTA calibration of rows of antenna elements using a reference subset of self-calibrated antenna-elements coupled to a calibration line, as illustrated in FIG. 8F, will then follow.

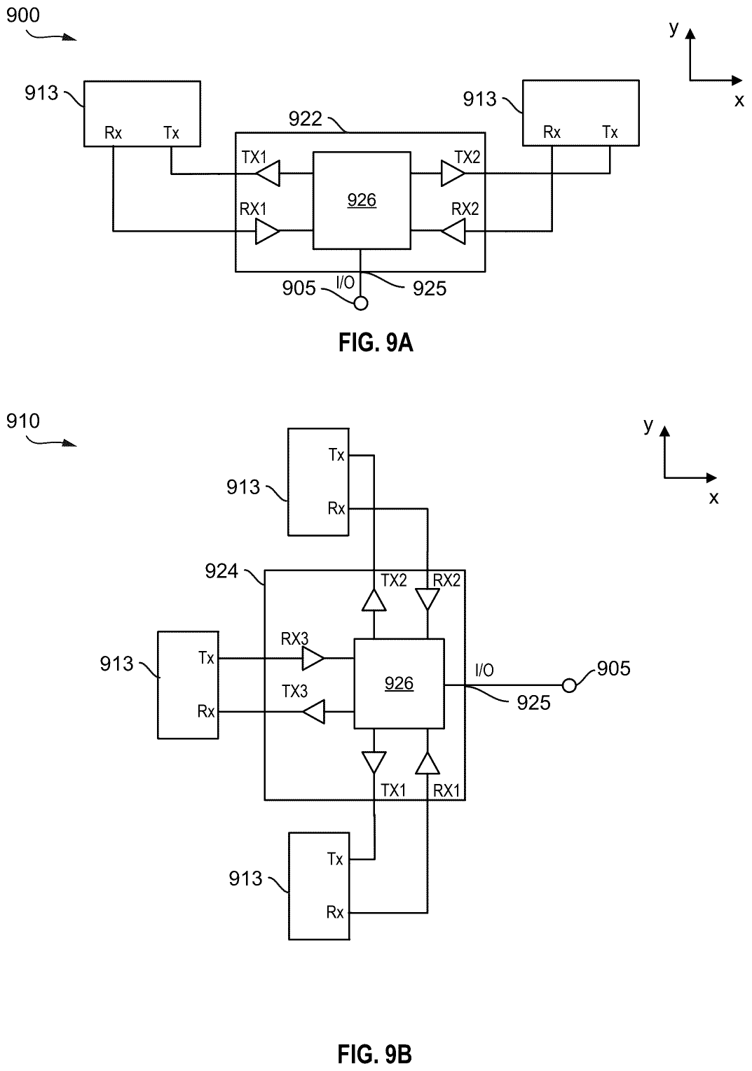

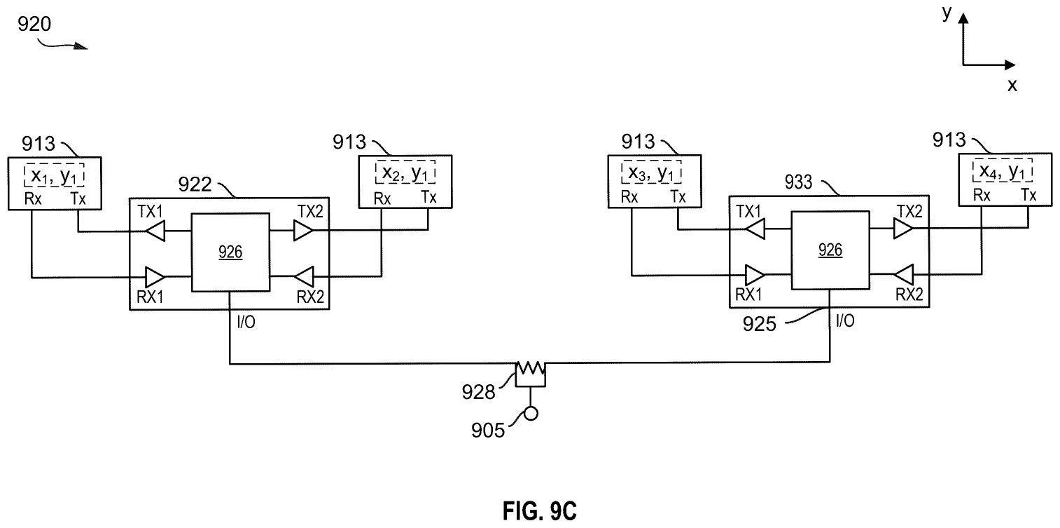

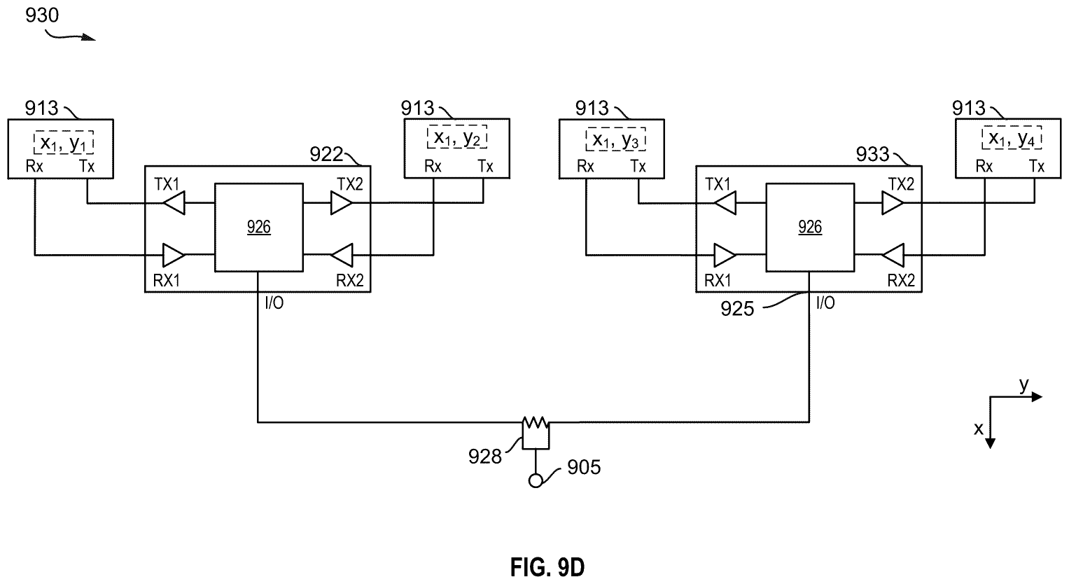

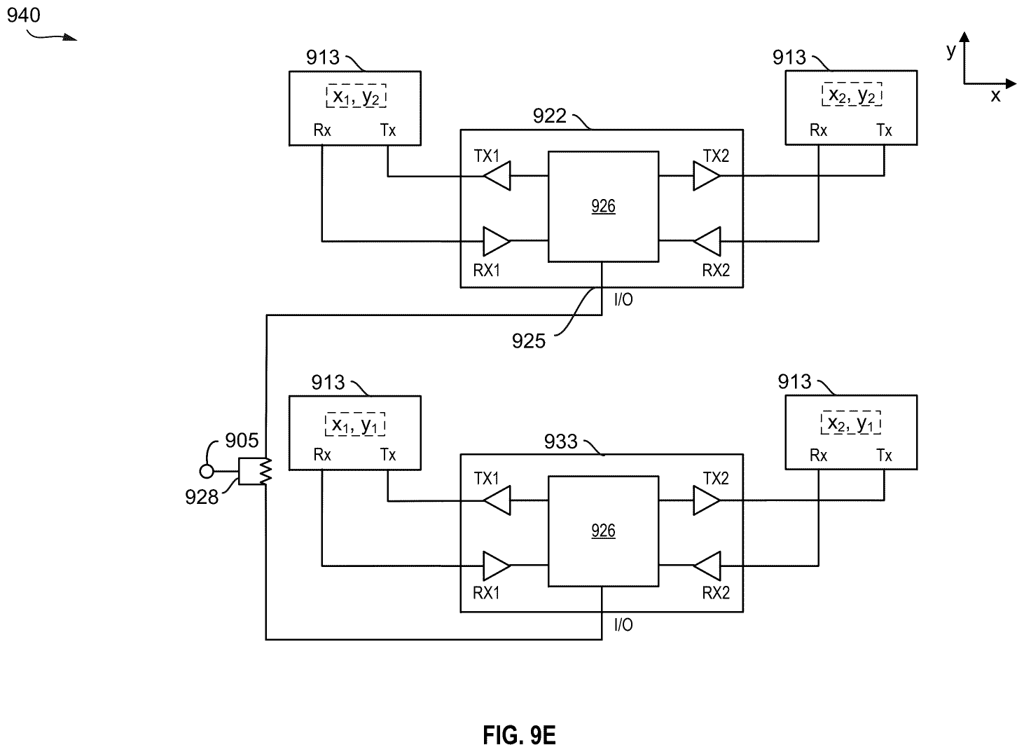

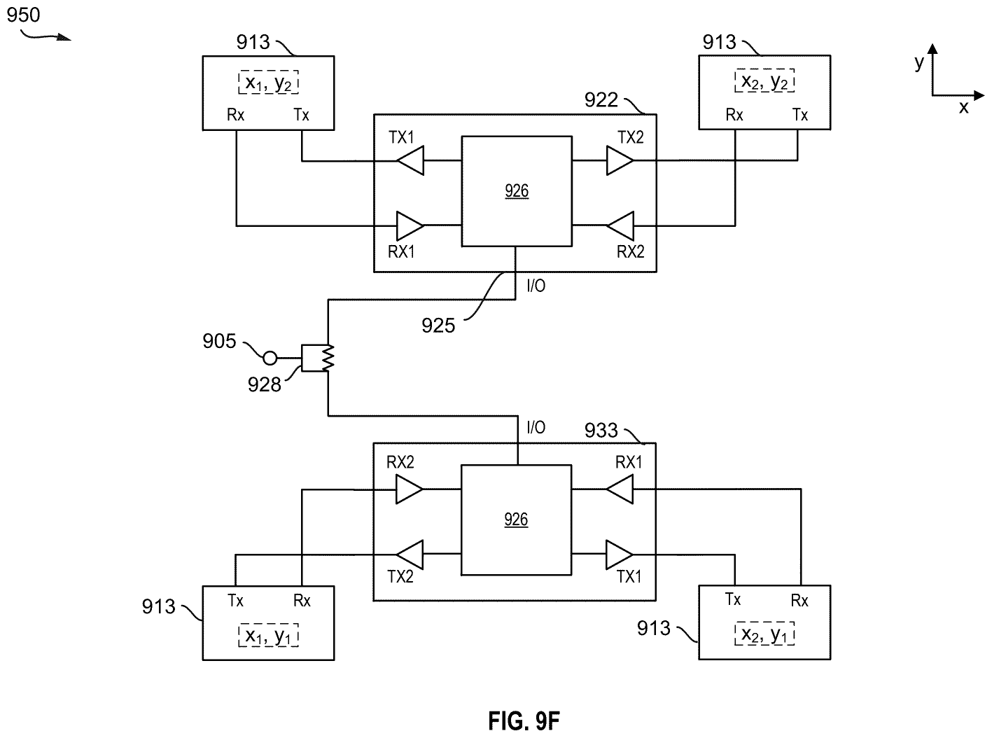

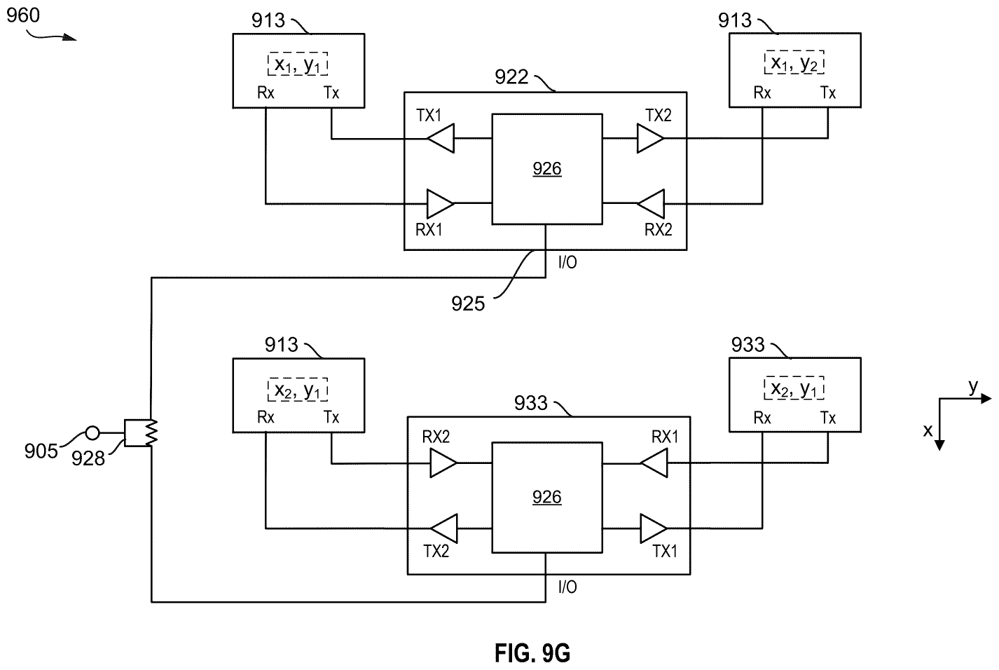

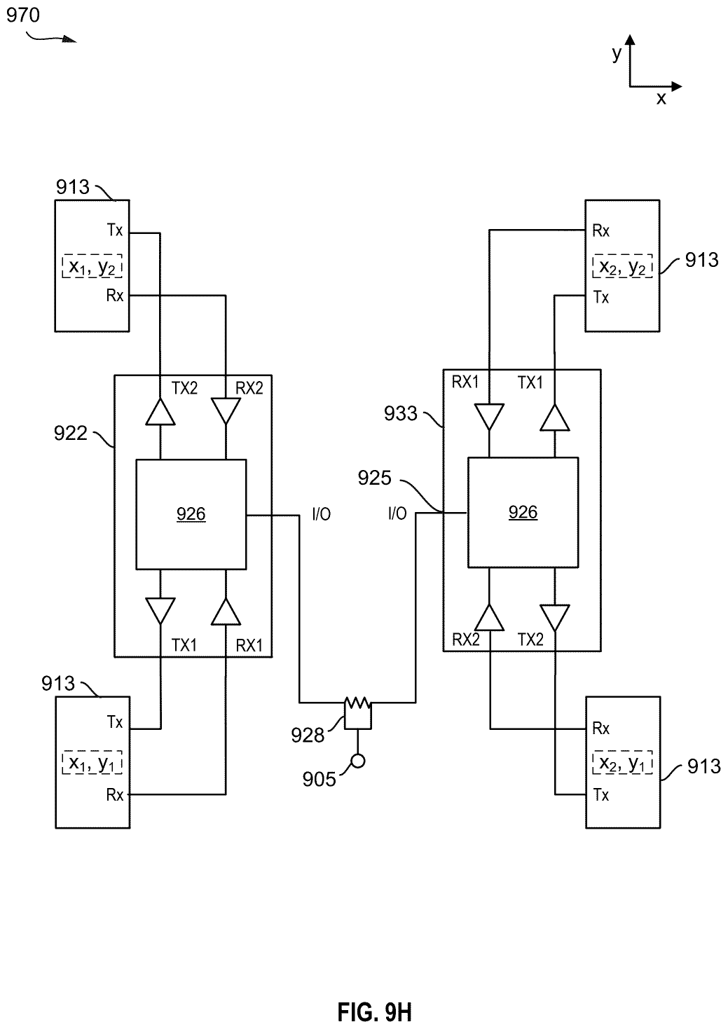

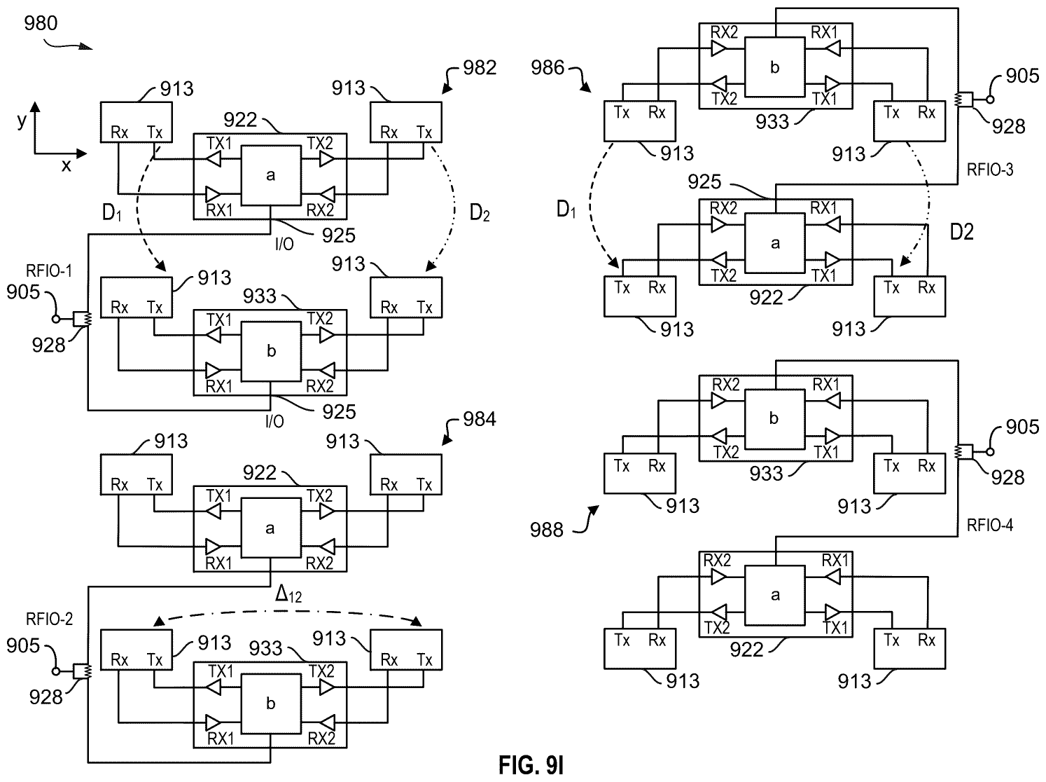

An example configuration of two-way FEMs with dedicated transmit and receive ports coupled to respective dual port antenna elements of a sub-array of two antenna elements of an antenna lattice, as illustrated in FIG. 9A, will then follow. An example configuration of three-way FEMs with dedicated transmit and receive ports coupled to respective dual port antenna elements of a sub-array of three antenna elements of an antenna lattice, as illustrated in FIG. 9B, will then follow. Example configurations for sharing radio frequency input/output (RFIO) ports between pairs of two-way FEMs coupled to four antenna element sub-arrays arranged in a linear configuration, as illustrated in FIG. 9C and FIG. 9D, will then follow. Example configurations for sharing RFIO ports between pairs of two-way FEMs coupled to four antenna element sub-arrays arranged in a rectangular configuration, as illustrated in FIG. 9E through FIG. 9H, will then follow. An example configuration for providing additional redundancy for OTA calibration using pairs of two-way coupled to four antenna element sub-arrays, as illustrated in FIG. 9I, will then follow.

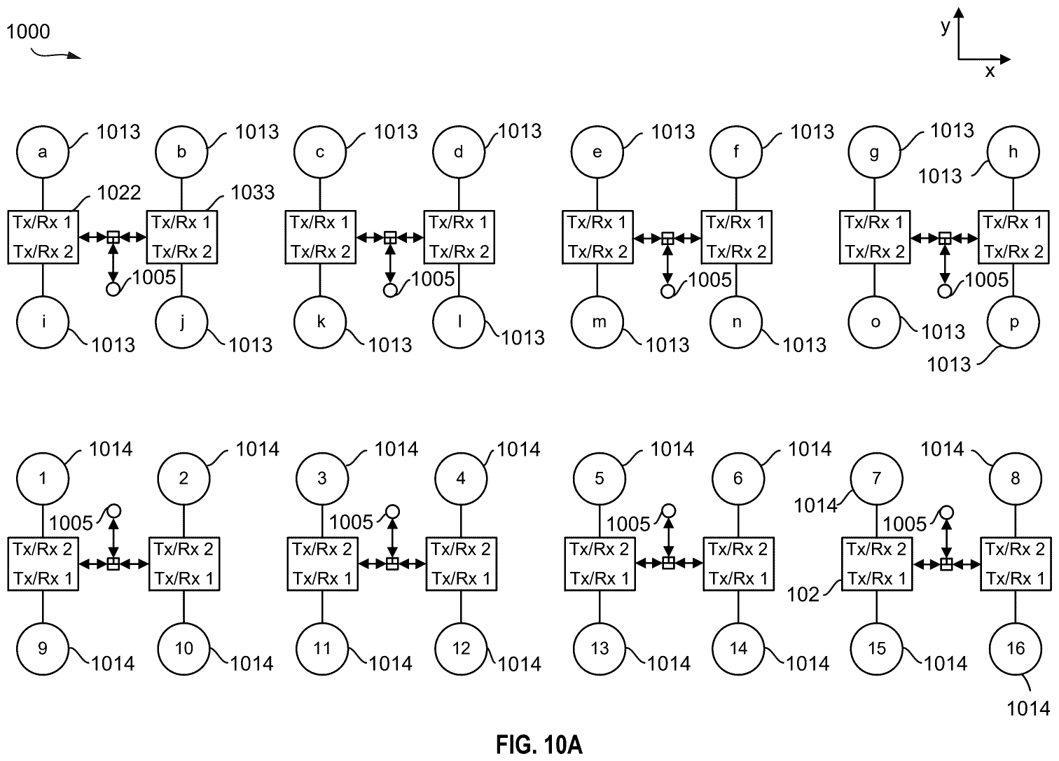

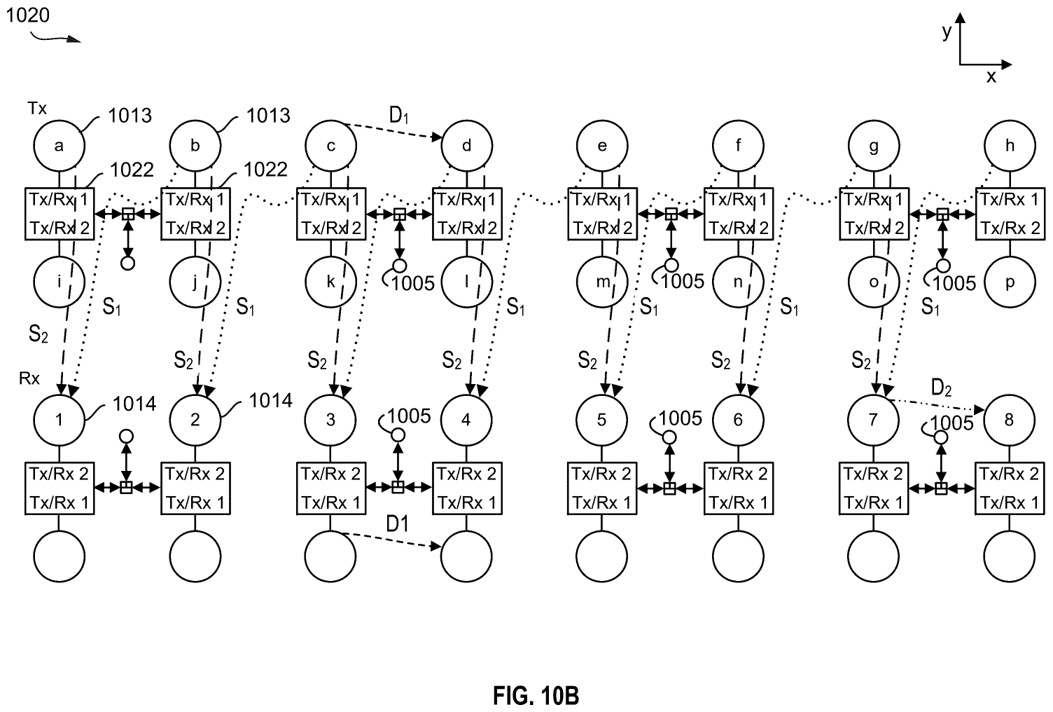

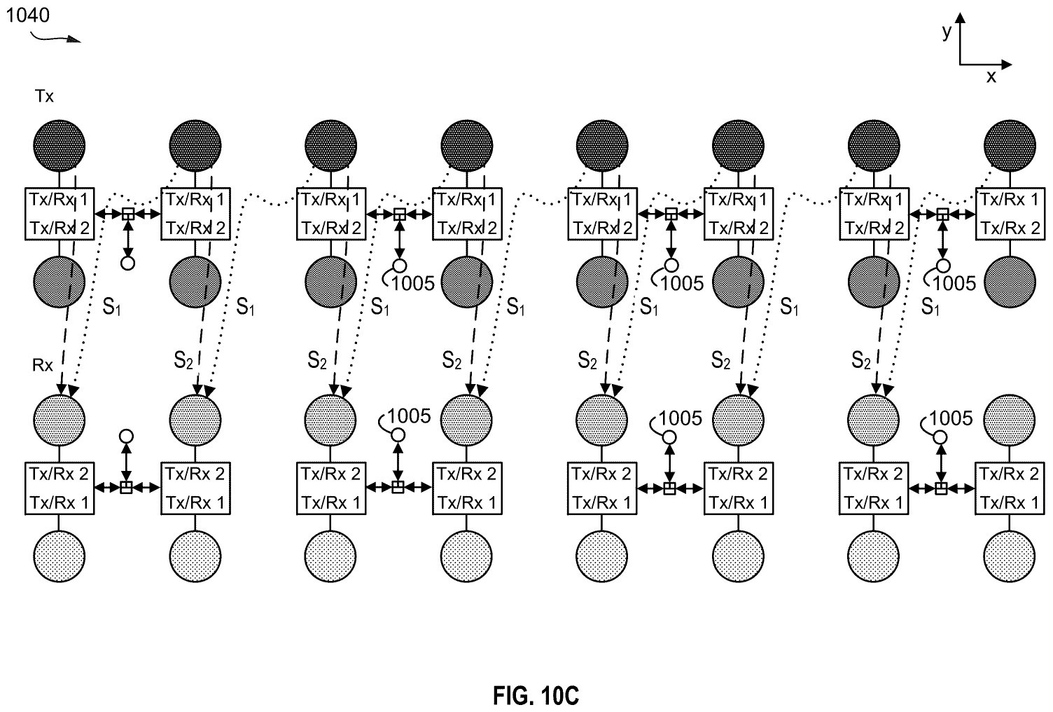

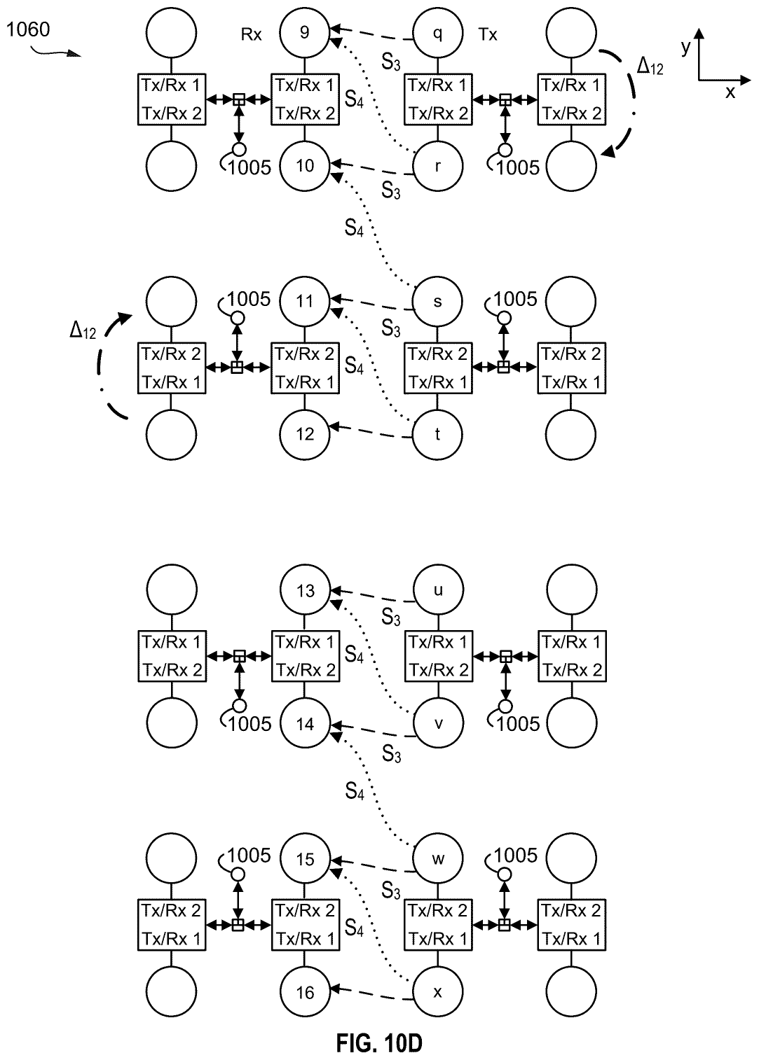

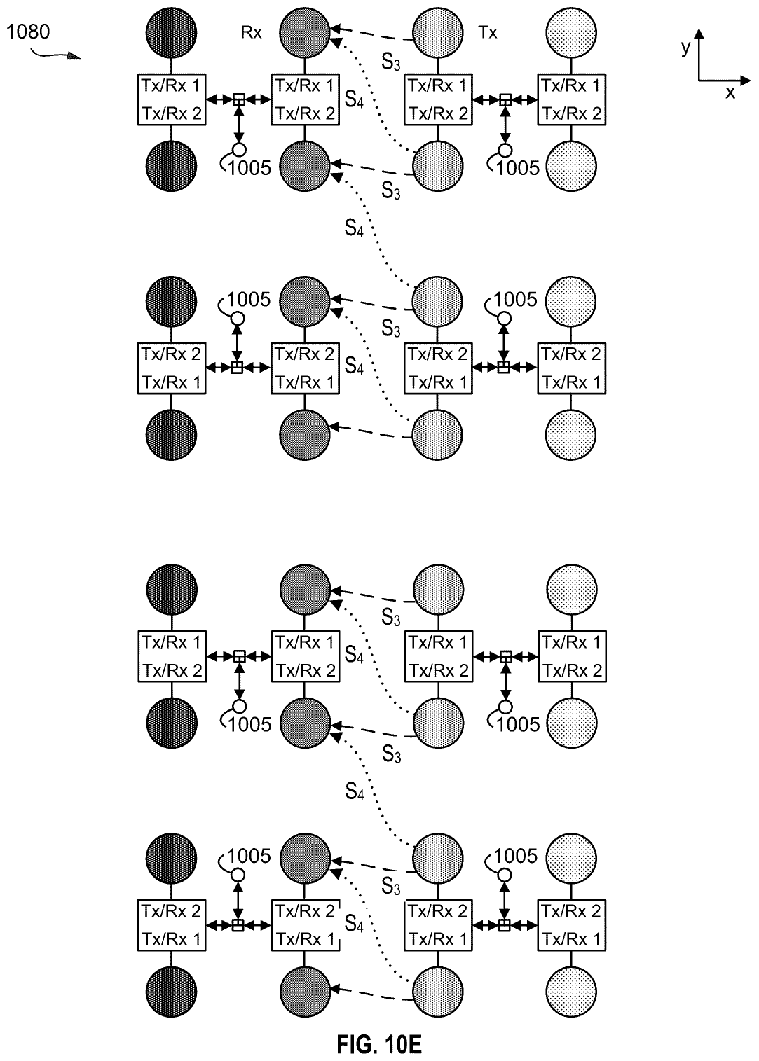

An example calibration configuration for calibrating antenna elements in a two-dimensional (2D) phased array antenna, in accordance with some embodiments of the present disclosure, as illustrated in FIG. 10A, will then follow. An example calibration configuration and corresponding calibration outcome for calibrating rows of antenna elements in the example calibration of FIG. 10A, as illustrated in FIG. 10B and FIG. 10C, will then follow. An example calibration configuration and corresponding calibration outcome for calibrating columns of antenna elements in the example calibration configuration of FIG. 10A, as illustrated in FIG. 10D and FIG. 10E, will then follow.

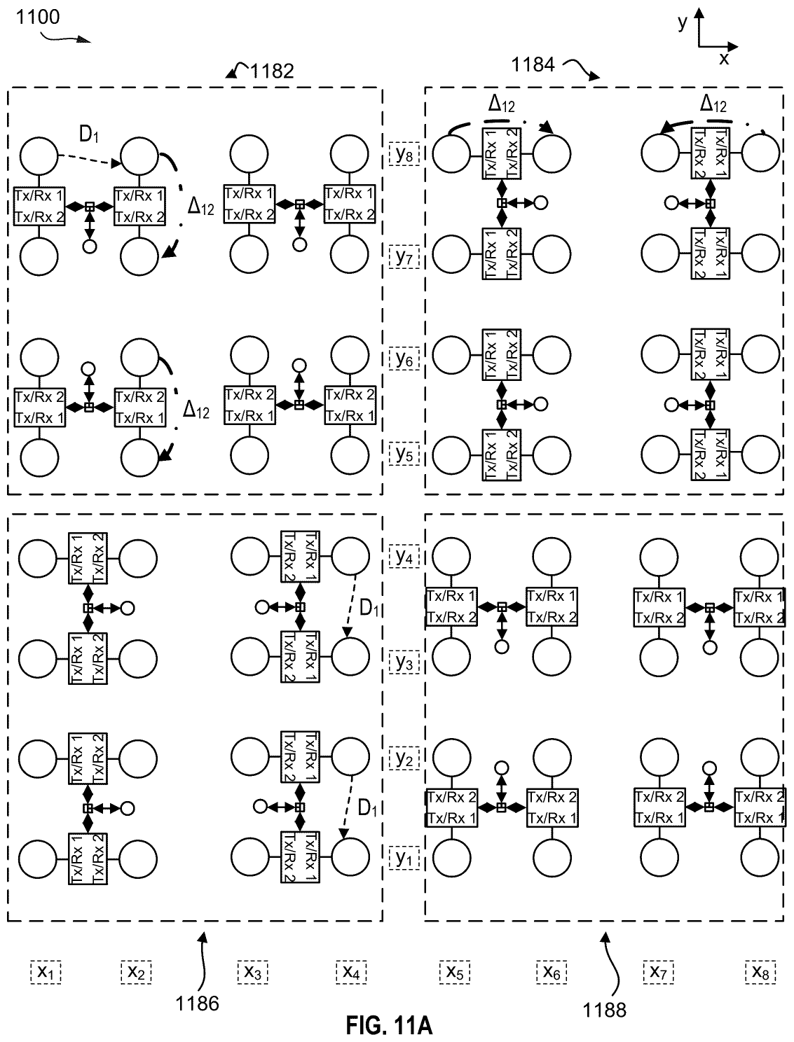

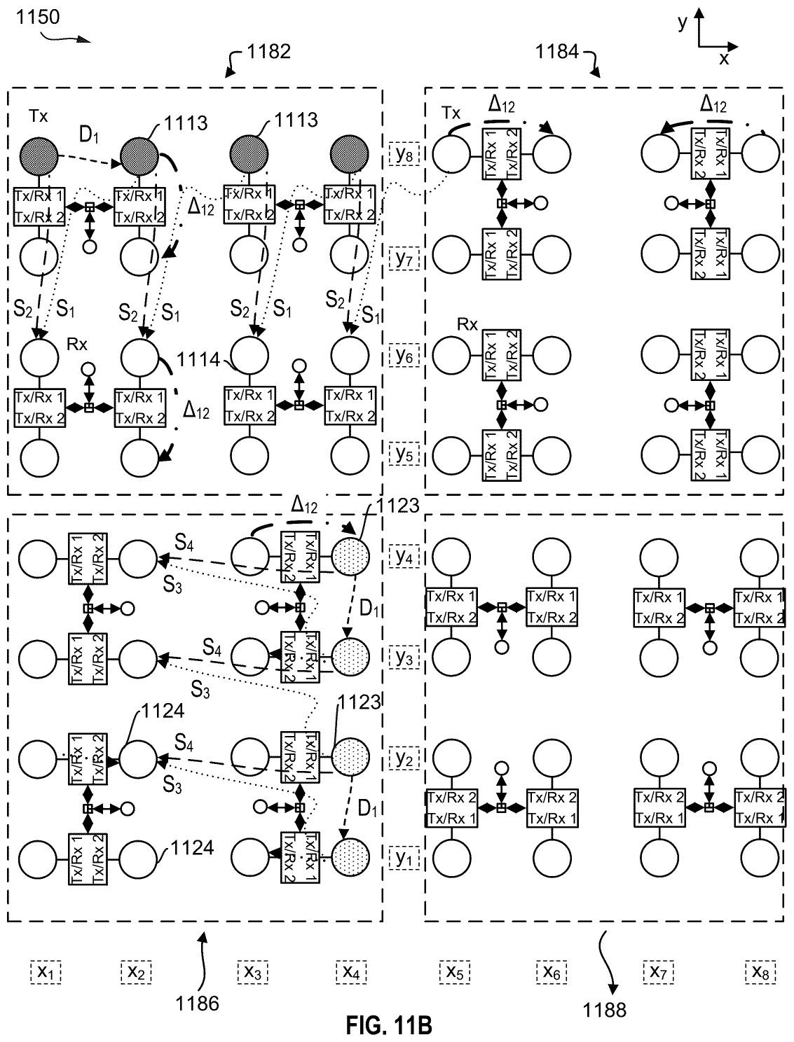

Example calibration configurations including four antenna element sub-arrays for calibrating a phased array antenna system using a single sub-array parameter, as illustrated in FIG. 11A and FIG. 11B, will then follow.

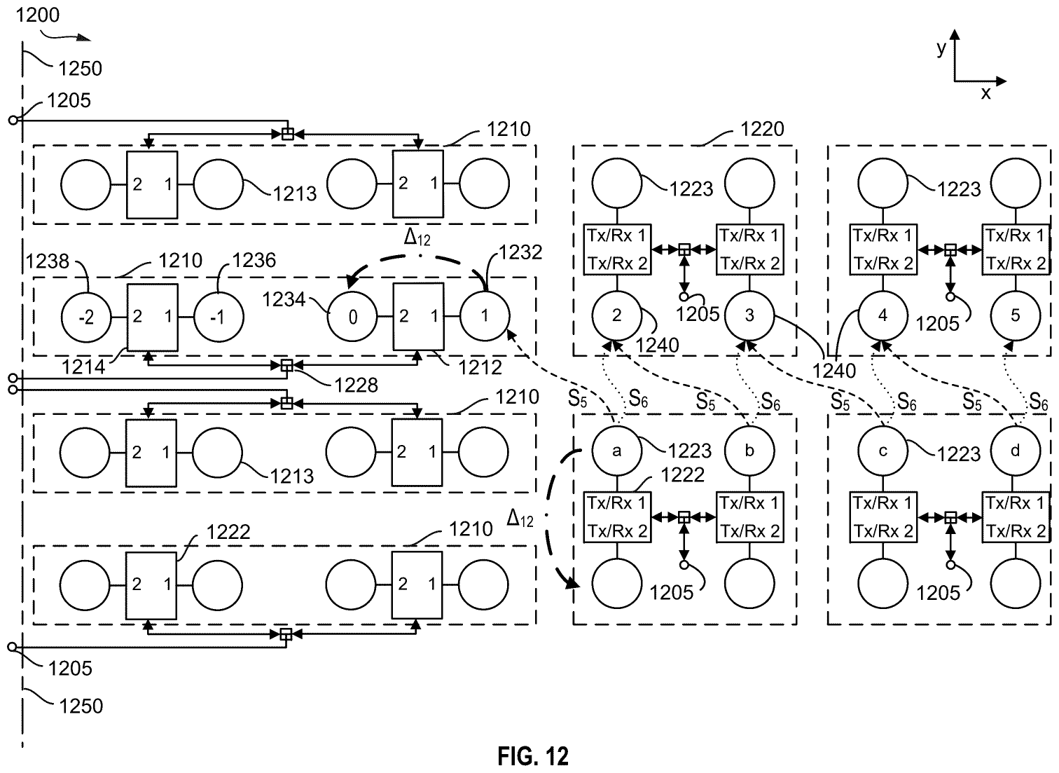

An example edge antenna element calibration configuration, as illustrated in FIG. 12, will then follow.

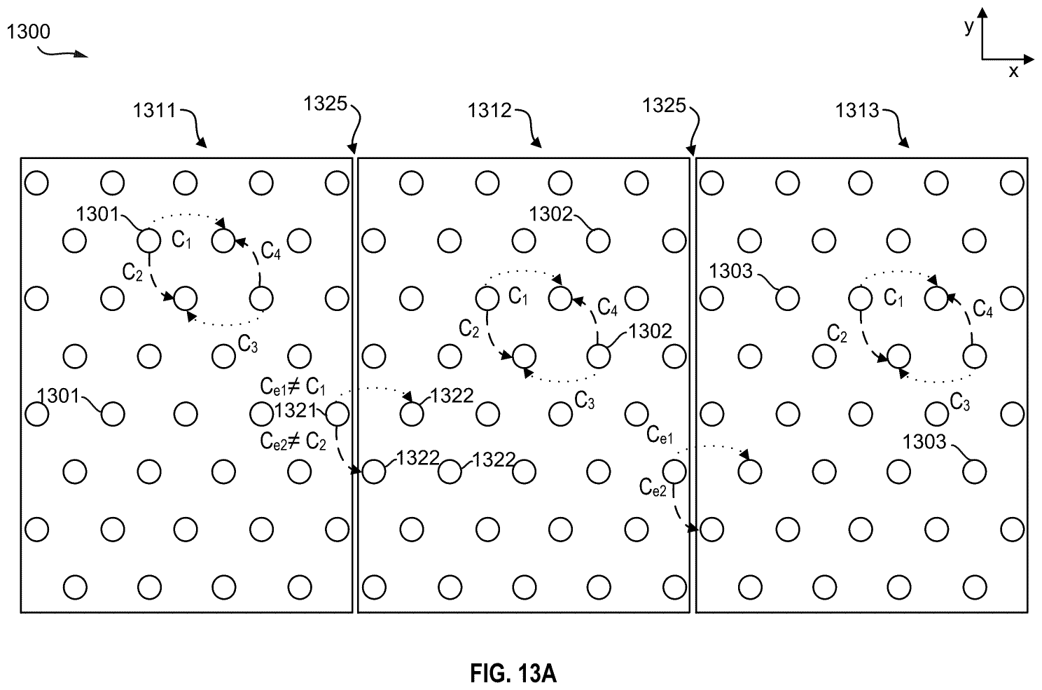

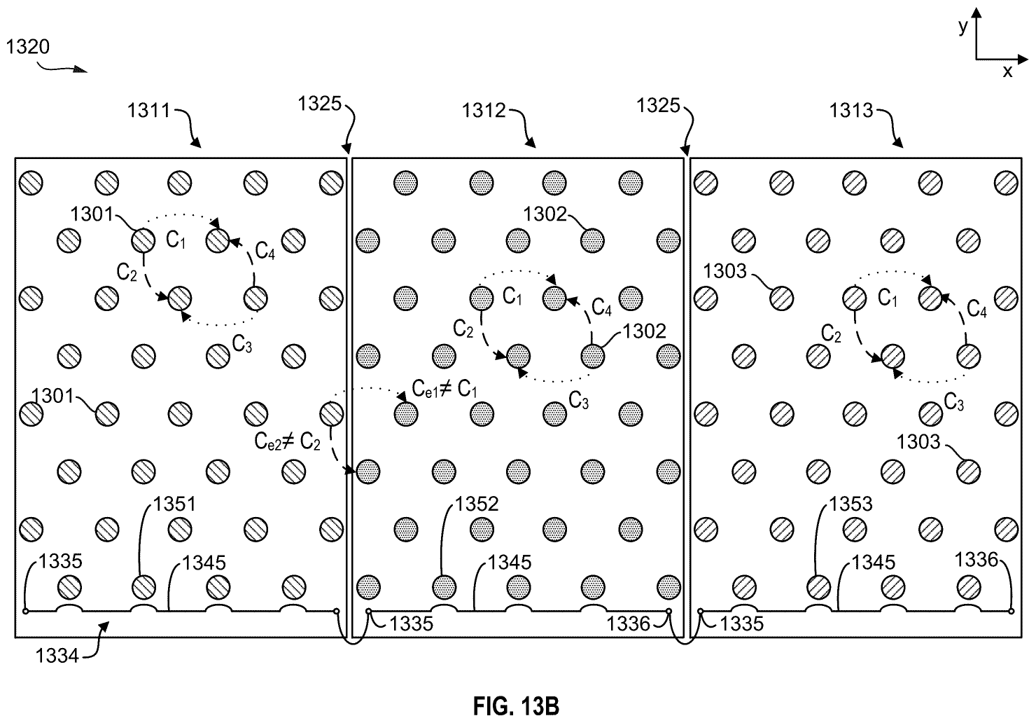

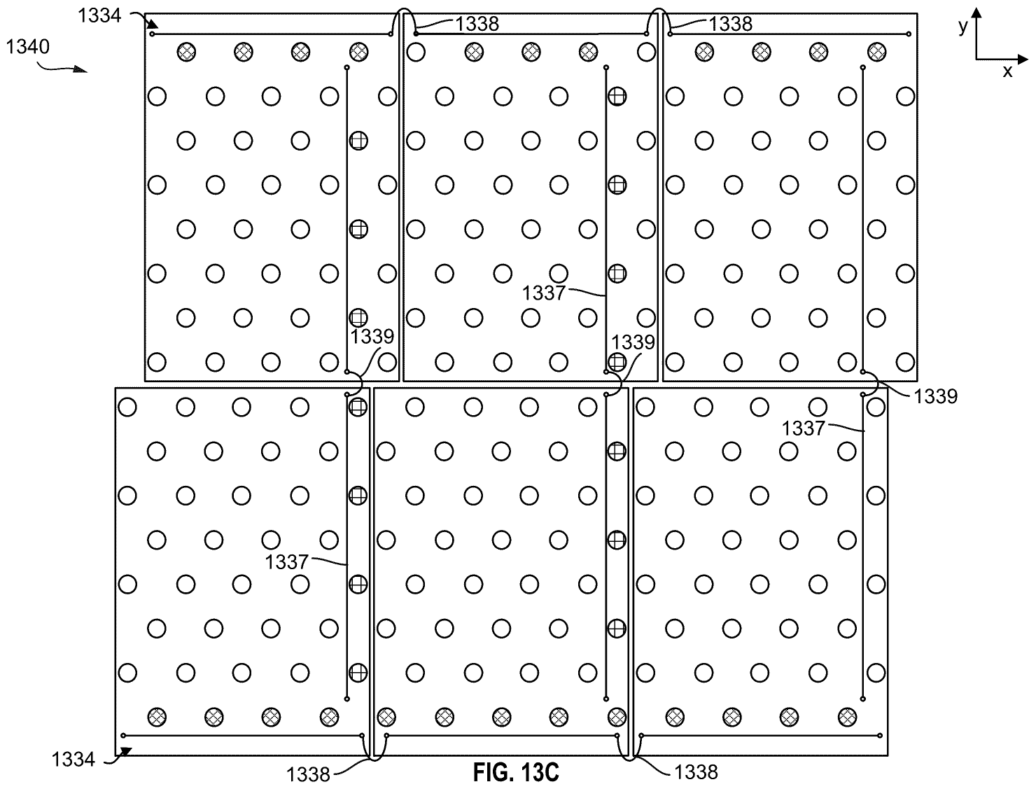

an example antenna lattice configuration for performing OTA calibration measurements for a phased array antenna system with antenna elements distributed on different printed circuit boards (PCBs), as illustrated in FIG. 13A, will then follow. An example calibration configuration that can be used to calibrate the antenna elements in the antenna lattice configuration 1300 of FIG. 13A, as illustrated in FIG. 13B, will then follow. An additional example calibration configuration that can be used to calibrate the antenna elements in the antenna lattice configuration 1300 of FIG. 13A across two dimensions, as illustrated in FIG. 13C, will then follow.

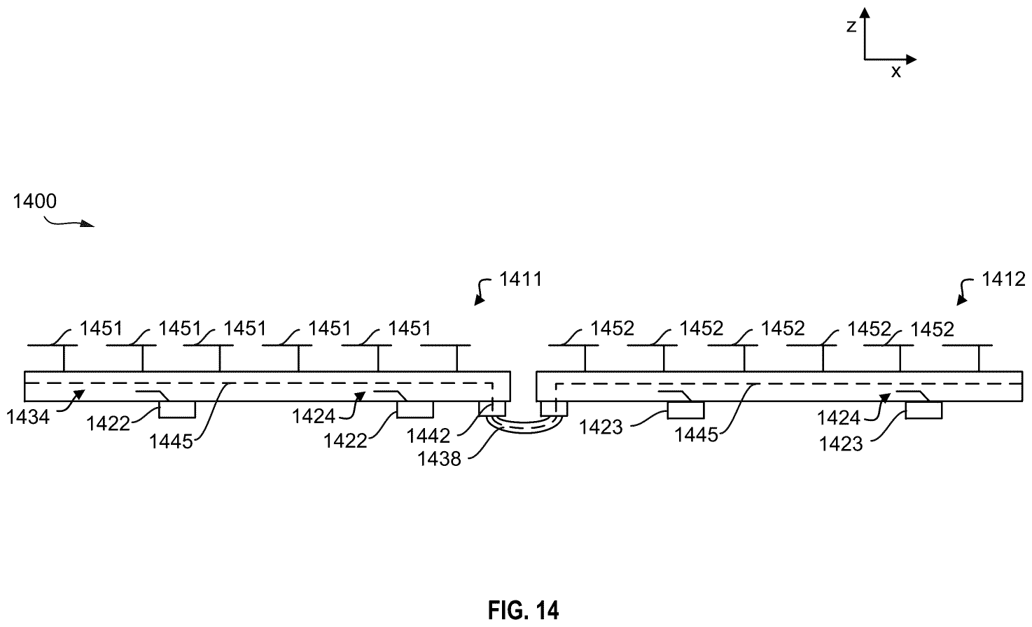

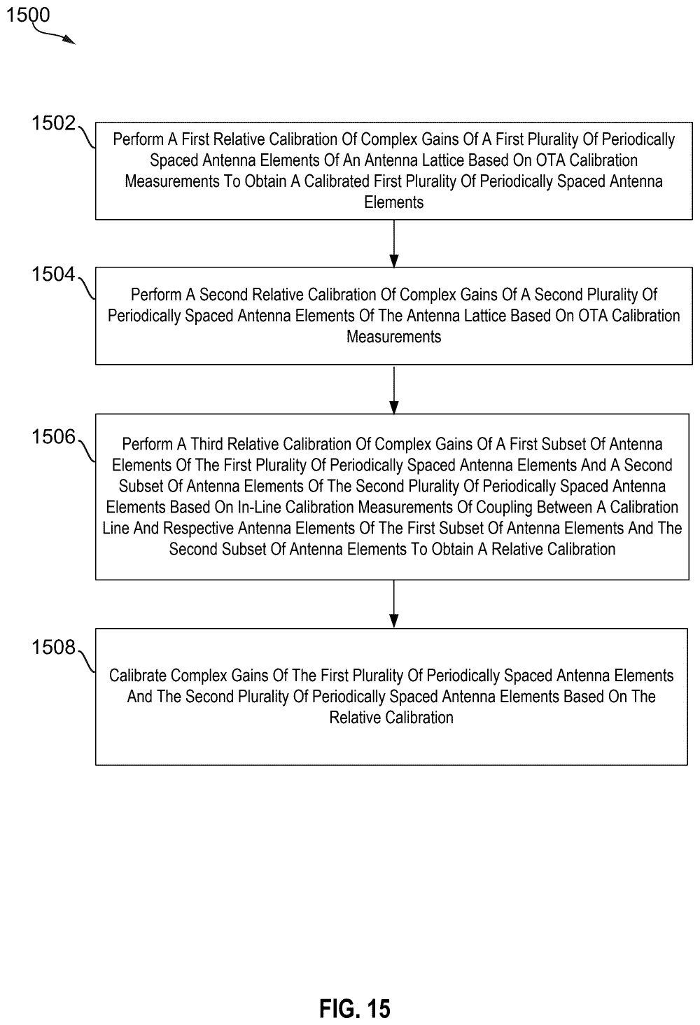

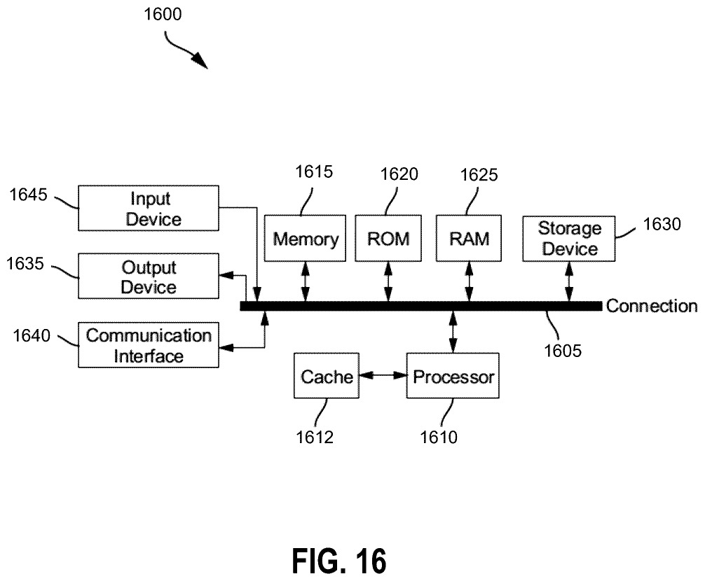

A cross-sectional view of a row of antenna elements along a calibration line extending between different PCBs of a phased array antenna system, as illustrated in FIG. 14, will then follow. A flow diagram illustrating a process for OTA calibration of antenna elements for a phased array antenna system, as illustrated in FIG. 15, will then follow. The discussion concludes with a description of an example computing system, as illustrated in FIG. 16. The disclosure now turns to FIG. 1.

FIG. 1 illustrates a not-to-scale embodiment of an antenna and satellite communication system 100 in which embodiments of the present disclosure may be implemented. As shown in FIG. 1, an Earth-based endpoint or user terminal (UT) 102 is installed at a location directly or indirectly on the Earth's surface such as a house or other building, tower, a vehicle, or another location where it is desired to obtain communication access via a network of satellites.

A communication path may be established between the UT 102 and a satellite (SAT) 104. In the illustrated embodiment, the first SAT 104, in turn, establishes a communication path with a gateway terminal 106. In another embodiment, the SAT 104 may establish a communication path with another satellite prior to communication with a gateway terminal 106. The gateway terminal 106 may be physically connected via fiber optic, Ethernet, or another physical connection to a ground network 108. The ground network 108 may be any type of network, including the Internet. While one SAT 104 is illustrated, communication may be with and between a constellation of satellites.

### Phased Array Antenna System

FIG. 2A and FIG. 2B are schematic illustrations of the electronic system of a phased array antenna system 200 in accordance with embodiments of the present disclosure. Referring to FIG. 2A, the phased array antenna system 200 is designed and configured to transmit and/or receive a combined beam composed of signals (also referred to as electromagnetic signals, wavefronts, or the like) in a preferred direction from or to an antenna aperture 212. Accordingly, the plurality of antenna elements simulates a large directional antenna. An advantage of the phased array antenna is its ability to transmit and/or receive signals in a preferred direction (i.e., the antenna's beamforming ability) without physically repositioning or reorienting the system.

In accordance with one embodiment of the present disclosure, FIG. 2A illustrates a phased array antenna system 200, which may be configured to transmit and/or receive radio frequency (RF) signals. The phased array antenna system 200 includes a phased array antenna including a plurality of antenna elements 213, 214 defining antenna aperture 212, for example, antenna elements 213, 214 distributed in one or more rows and/or columns and a plurality of phase shifters (not shown) configured for generating phase offsets between the antenna elements 213, 214. As a non-limiting example, a two-dimensional phased array antenna may be capable of two-dimensional electronically controlled beam steering. In some cases, the range of available beam steering angles can depend on the configuration of antenna elements in the two-dimensional phased array antenna. For example, a planar two-dimensional phased array may be able to attain the maximum possible range of scan angles relative to a vector that is normal to the plane of the array if the antenna element spacing across the antenna lattice 202 is chosen appropriately.

As illustrated in FIG. 2A, the plurality antenna elements 213 in the antenna lattice 202 are configured for transmitting signals and/or for receiving signals. The antenna aperture 212 of the phased array antenna system 200 is the area through which the power is radiated or received. A phased array antenna synthesizes a specified electric field (phase and amplitude) across an antenna aperture 212. As described in greater detail below, the antenna lattice 202 defining the antenna aperture 212 may include the plurality of antenna elements 213 arranged in a particular configuration that is supported physically and electronically by a printed circuit board (PCB).

Referring to FIG. 2A, the antenna aperture 212 may be grouped into subsets 204a and 204b of antenna elements. Each subset 204a, 204b of the plurality of antenna elements can comprise the M antenna elements 213, 214, which may be associated with specific digital beamformer (DBF) chips 207, 208, respectively. The remaining antenna elements 217 of the plurality of antenna elements may be similarly associated with other DBF chips (not shown) in the DBF lattice 206.

In some implementations, the goal in the system design can be to make mutual coupling measurements between transmit and receive antennas OTA such that there is enough redundancy in those measurements to eliminate the requirement for an external (flying probe, near-field or far-field source etc.) reference; phased array system self-calibrates its RF paths. In some examples, OTA measurements alone may not provide enough redundancy and may be supplemented by making mutual coupling measurements between a subset of TX or RX antennas and one or more calibration lines.

In some implementations, measurements from a calibration operation can be stored for later use. In some cases, the stored calibration measurements can be used to avoid repeated and/or redundant capture of measurements during operation of the phased array antenna. In some cases, reducing the number of measurements performed during calibration can speed up the calibration process. In one illustrative example, measurements from an initial self-calibration can be stored and reused during subsequent calibrations. In some cases, calibration measurements can be performed from scratch (e.g., without considering previous calibration measurements) during each calibration operation. For example, a phased array antenna system may perform calibration periodically during operation to keep the phased array antenna elements aligned and/or calibrated.

Referring to FIG. 2B, the phased array antenna system 200 can be a transmit (TX) phased array antenna system, a receive (RX) phased array antenna system, or a transmit and receive (TX/RX) phased array antenna system. The illustrated phased array antenna system 200 includes an antenna lattice 202 including a plurality of antenna elements 213, 214 and DBF lattice 206 including one or more DBF chips 207, 208 (which may be referred to herein as digital beamformers, DBFs, or DBF chips herein) for receiving signals from a modem 210 in the transmit (TX) direction and/or sending signals to the modem 210 in the receive (RX) direction. The DBF chips 207 and 208 and antenna elements (213, 213, 217 etc.) can be configured to transmit and/or receive a combined beam of radio frequency signals having a radiation pattern from or to the antenna aperture 212.

The configurations shown in FIG. 2A and FIG. 2B are provided for the purposes of illustration and provide illustrative example configurations that can incorporate the calibration systems and techniques described herein. Other configurations can be used without departing from the scope of the present disclosure. For example, a phased array antenna system that utilizes analog and/or hybrid beamforming schemes may be used without departing from the scope of the present disclosure.

Main Lobe and Side Lobes Emanating from a Phased Array Antenna

FIG. 3 shows a schematic 370 illustrating an example main lobe 372 and side lobes 376 emanating from an antenna array of an example phased array antenna system (e.g., phased array antenna system 200 of FIG. 2A). The schematic 370 may represent a polar plot, whereby the main lobe 372 and the various side lobes 376 represent a radiation pattern, or effective isotropic radiation pattern (EIRP), of the phased array antenna system. As illustrated in FIG. 3, the main lobe 372 may have a larger field strength compared to other lobes (e.g., side lobes 376) resulting from the transmission of the signal. The main lobe 372 may correspond to the steering direction 374 of the signal from a phased array antenna system to a satellite. In some examples, main lobe 372 may correspond to the steering direction 374 of a signal from the phased array antenna system to a user terminal (e.g., UT 102 of FIG. 1) and/or gateway terminal (e.g., gateway terminal 106 of FIG. 1). The other lobes, or side lobes 376, may be the result of the size/shape of the array aperture (e.g., antenna aperture 212 and any kind of excitation taper (e.g., amplitude taper) applied to the antenna array. These sidelobes might be worse and less predictable in case of an imperfect calibration resulting in systematic and/or random errors in the individual antenna signals (magnitude and/or phase). Therefore, the overall EIRP mask and the achievable side-lobe levels depends on the accuracy/quality of the calibration of the antenna array of the phased array antenna system.

### Phased Array Antenna Configurations for Transmitting and Receiving

FIG. 4A and FIG. 4B illustrate an all transmit (TX) configuration 400 and an all receive (RX) configuration 430 for a phased array antenna system, respectively. In the examples of FIG. 4A and FIG. 4B, the antenna elements 413, 415, 416, 414 are arranged in a row and are equally spaced in an antenna lattice (e.g., antenna lattice 202 of FIG. 2B). In some cases (e.g., during nominal operation of a phased array antenna), the antenna elements 413, 415, 416, 414 can be configured to all transmit when the phased array antenna system is in a transmit (TX) mode and can be configured to all receive when the phased array antenna system is in a receive (RX) mode. As illustrated in FIG. 4A, when the phased array antenna system is in TX mode, the front-end module (FEM) 420 can operate in a TX mode. For example, in the TX mode, the power amplifier (PA) 421 is turned on, and the low noise amplifier (LNA) 423 is switched off. As illustrated in FIG. 4B, when the phased array antenna system is in RX mode, the FEM 422 is also in RX mode. For example, in the RX mode, the PA 421 of each FEM 422 is switched off and the LNA 423 of each FEM 422 is switched on).

Calibration Configurations for Antennas with a Dual-Use Port

In some cases, the measurements required for performing OTA calibration of a phased array antenna system (e.g., phased array antenna system 200 of FIG. 2A) can depend on physical characteristics of the antenna array. One example self-calibration approach described herein can be applied to calibration of a phased array antenna with a periodic antenna lattice (e.g., antenna lattice 202 of FIG. 2A) with at least one port of each antenna element (e.g., antenna elements 213, 214, 217 of FIG. 2A) in the periodic antenna lattice being capable of dual-use during the self-calibration process. As used herein, a dual-use antenna port refers to a port of an antenna element that allows the same physical antenna port to be used for transmitting calibration signals and/or for receiving calibration signals. For example, a dual-use antenna port may be used for both transmitting signals (e.g., in a TX mode) and receiving signals (e.g., in an RX mode) during nominal use of a phased array antenna system. In some examples, a dual-use antenna port may be used exclusively for transmitting signals (e.g., in a TX only antenna array) or exclusively for receiving signals (e.g., in an RX only antenna array) during nominal use of a phased array antenna system.

FIG. 4C and FIG. 4D illustrate example calibration configurations 440, 450, respectively, illustrating OTA calibration measurements for single port antenna elements with dual-use antenna ports. In the examples of FIG. 4C and FIG. 4D, the antenna elements 413, 415, 416, 414 are arranged in a row and are equally spaced in an antenna lattice (e.g., antenna lattice 202 of FIG. 2B). FIG. 4C includes example calibration configuration 440 illustrating OTA calibration measurements taken between RFIO ports 405 of a single beamformer (BF) 407. In contrast, FIG. 4D includes an additional example calibration configuration 450 illustrating OTA calibration measurements taken between RFIO ports 405 of different BFs (e.g., BF 407 and additional BF 408).

In the illustrated examples of FIG. 4C and FIG. 4D, FEMs 420 and corresponding RFIO paths 433, 434 coupled to RFIO ports 405 are configured in a TX mode. In addition, FEMs 422 and corresponding RFIO paths 435, 436 coupled to RFIO ports 405 can be configured in an RX mode. In some cases, the antenna elements 413, 414 coupled to RFIO paths 433, 434 configured in the TX mode can transmit RF signals OTA and antenna elements 415, 416 coupled to RFIO paths 435, 436 configured in the RX mode can receive the transmitted signals. In some cases, the signals measured by the antenna elements 415, 416 can be used to perform coherent complex measurements (e.g., measuring phase and magnitude) based on the mutual coupling between TX antenna elements 413, 414 and RX antenna elements 415, 416 as illustrated by OTA paths 424, 426, 428, 432. In some implementations, FEMs 420, 422 can be implemented as FEM chips (e.g., integrated circuit (IC) chips) including a single port (e.g., a package pin, solder ball, or the like) connecting to the corresponding antenna port of the antenna elements 413, 415, 416, 414. In the illustrated examples of FIG. 4C and FIG. 4D, a switching mechanism (not shown) between PA 421 and LNA 423 is internal to the FEM chip and the PA 421 and LNA 423 are connected to the same antenna port. However, in some implementations (not shown), PA 421 and LNA 423 can have dedicated ports (e.g., package pins, solder balls, or the like) on the FEMs 420, 422 and the dedicated ports can be combined into a single port for connection to single port antenna elements using a switching mechanism external to the FEM chips without departing from the scope of the present disclosure.

### OTA Calibration Using Nominal Antenna Paths

In many practical examples, a signal radiated by the TX antenna elements (e.g., antenna elements 413, 414) can be too powerful for the RF paths of RX antenna elements (e.g., antenna elements 415, 416) such that FEMs 422 configured in an RX mode and/or the corresponding RFIO port 405 operating in RX mode can be overloaded and/or saturated. Such saturation can be due to the RX paths (e.g., RX RF paths) being designed to be very sensitive and capable of receiving extremely weak signals (e.g., below the thermal noise floor). As a result, the maximum signal strength the RX RF paths can tolerate can be many orders of magnitude smaller than the signals output by the functional/nominal TX paths (e.g., TX RF paths) of the array. In some cases, the functional/nominal TX paths may not have enough dynamic range to reduce their RF path gain (and signal strength out of antenna elements 413, 414) to avoid saturation of RX paths. For example, the dynamic range of TX paths may be limited to avoid performance degradation and/or overdesign. As a result, the RFIO ports 405 and FEMs 420 might be switched into another mode for transmitting with much lower signal levels, to be used only during the mutual coupling measurement process, which can be referred to as a calibration measurement TX mode (“mTX mode”). Since performance metrics (e.g., efficiency, linearity, etc.) are not as critical for mTX mode, it can be easier to transmit TX signals with a low power level (e.g., comparable to or just a few orders of magnitude different than target RX signals) to output from FEMs 420 of TX antenna elements 413, 414 such that RF paths of RX antenna elements 415, 416 (e.g., FEMs 422 and RFIO ports 405 in a nominal RX configuration) can receive the transmitted signals without causing saturation.

Similarly, the issue of saturating RX RF paths of RX antenna elements (e.g., antenna elements 415, 416) can be addressed during calibration of nominal TX RF paths of TX antenna elements (e.g., antenna elements 413, 414). In such an example, the goal can be calibrating the functional TX array. Accordingly, changing the RF/analog settings of the nominal TX RF paths for the TX antenna elements (e.g., antenna elements 413, 414) being calibrated may not be desirable. Instead, the RFIO ports 405 and FEMs 422 that are in RX mode when used for nominal RX operation can be switched into another configuration, which can be referred to as a calibration measurement RX mode (e.g., mRX mode). In some cases, the RFIO ports 405 and FEMs 422 can be configured in the mRX mode such that the RFIO ports 405 and/or FEMs 422 are much less sensitive. In some cases, by reducing the sensitivity of the RFIO ports 405 and/or FEMs 422 in the mRX mode, the RX paths can withstand nominal or close to nominal TX signals coming out of the TX antenna elements being calibrated. Such a reduction of sensitivity of the RX paths in the mRX mode can be acceptable since the mRX mode may only be used during calibration measurements. In some cases, the performance metrics of mRX mode are not as critical as the performance metrics of nominal RX mode (e.g., for the functional RX paths). For the purpose of simplicity, references to TX paths and RX paths that are performing mutual coupling measurements will be referred to herein as operating in the TX mode and RX mode respectively. However, the TX paths and RX paths can be assumed to be configured in a suitable mode of operation for transmitting calibration signals (e.g., mTX mode or TX mode) or receiving calibration signals (e.g., mRX mode or RX mode), unless otherwise stated.

Additional Calibration Configurations with Dual-Use Ports

As noted above, the examples of FIG. 4C and FIG. 4D illustrate calibration configurations for antenna arrays with antenna elements including a single port that is capable of functioning as a dual-use port. However, in some cases, antenna elements with multiple ports may be configured to provide a dual-use port that can be utilized for TX and/or RX during OTA calibration.

FIG. 4E illustrates an example calibration configuration 460 for calibrating a TX antenna array with antenna elements that have two antenna ports that use the functional TX port as a dual-use antenna port for calibration. As illustrated, the calibration configuration 460 includes antenna elements 463, 464, 465, 466 each having two antenna ports. In the example of FIG. 4E, the antenna elements 463, 464, 465, 466 are arranged in a row and are equally spaced in an antenna lattice (e.g., antenna lattice 202 of FIG. 2B). In one illustrative example, the antenna elements 463, 464, 465, 466 can be dual-linear polarized antennas routed to a 3-decibel (3-dB) 90-degree hybrid 425 that results in a TX port 482 and a terminated port 484. As illustrated, FEMs 467 include PAs 421 that can be coupled to TX ports 482 of respective antenna elements and used for transmitting signals from all of the antenna elements 463, 464, 465, 466 during nominal TX operation. In some cases, the FEMs 467 can include bypass switches 468 that can be configured to facilitate measurement of signals received through the TX port 482 for performing OTA calibration. In some cases, during nominal operation, bypass switches 468 included in all of the FEMs 467 can be open. In the example of FIG. 4E, passive measurement RX (mRX) paths can be coupled to the TX ports 482 via a coupler 488. In some cases, FEMs 467 can be configured to receive calibration signals by closing the bypass switches 468 and disabling the PA 421.

In the example of FIG. 4E, antenna elements 463, 464 and corresponding FEMs 467 are configured to transmit TX signals from TX ports 482. As illustrated, antenna elements 465, 466 and corresponding FEMs 467 are configured to receive the TX signals outputted from antenna elements 463, 464 OTA via TX ports 482. In some cases, the coupler 488 and its termination 489 can be outside of the FEMs 467 (e.g., on a PCB). In some examples, the coupler 488 and/or its termination 489 can be physically inside the FEM 467 (e.g., in an IC chip) without departing from the scope of the present disclosure.

In some cases, terminated port 484 can be terminated by a termination 486. In some cases, by utilizing a termination approach that is consistent across all of the antenna elements 463, 464, 465, 466, periodicity of the antenna lattice (e.g., antenna lattice 202 of FIG. 2B) can be preserved. For example, the terminated port 484 may be terminated by another TX FEM chip (e.g., for dual polarized TX array operation). In another illustrative example, the terminated port 484 can be terminated by an RX FEM chip utilizing a calibration approach similar to the example of FIG. 4E.

For example, an RX FEM may include a switchable TX path coupled to the terminated port 484 by a coupler. In some implementations, terminated port 484 can be terminated by a matched load without departing from the scope of the present disclosure. Note that, compared to the implementation of FIG. 4C (e.g., based on switching the functional path between transmitting and receiving), the efficiency degradation of the functional path in the calibration configuration 460 of FIG. 4E can be much smaller, assuming a weak coupler 488 (e.g., −20 dB coupling or less), at the expense of potentially having a more constrained link budget for mutual coupling measurements during calibration.

FIG. 4F illustrates an additional example calibration configuration 470 for calibrating a TX antenna array of antenna elements with two ports that use a port that is different from the functional TX port as a dual-use antenna port for calibration. As illustrated, the additional example calibration configuration 470 includes antenna elements 463, 464, 465, 466 each having two antenna ports. Similar to the configuration of FIG. 4E, the antenna elements 463, 464, 465, 466 can be dual-linear polarized antennas routed to a 3-dB 90-degree hybrid 475. In the example of FIG. 4F, the 3-dB 90-degree hybrid 457 can result in a TX port 472 and a calibration port 474. In the example of FIG. 4F, a bidirectional calibration path is assumed to be available as a separate pin 492 of FEM 477 (e.g., an FEM IC chip) coupled to the calibration port 474.

As illustrated, the FEMs 477 can be configured for calibration by closing switch 491 and switching off PA 421. In some cases, the configuration of FIG. 4F can be used avoid the insertion loss of a coupler (e.g., coupler 488 of FIG. 4E) along the functional TX path. In some cases, providing a separate calibration path through the calibration port 474 will not cause any efficiency degradation for the functional TX path (e.g., TX RF path) coupled to TX port 472. In the example of FIG. 4F, the RFIO ports 405 can be selectively operated in a TX mode and/or an RX mode. Accordingly, antenna elements 463, 464, 465, 466 can use calibration port 474 for transmitting and/or receiving signals during calibration. In the illustrated example, antenna elements 463, 464, are configured to transmit signals using the calibration port 474 with corresponding FEMs 477 operating in the calibration mode. As illustrated, antenna elements 465, 466 are configured to receive signals transmitted by the antenna elements 463, 464 using calibration port 474 with corresponding FEMs 477 operating in the calibration mode.

In some implementations, scattering/coupling parameters of the (passive) antenna array (e.g., antenna elements 413, 414, 415, 416 of FIG. 4A through FIG. 4D, antenna elements 463, 464, 465, 466 of FIG. 4E and FIG. 4F) can be reciprocal (assuming no magnetic material inside the antenna volume) and periodic (due to periodic spacing of antenna elements). In some cases, the combination of reciprocity and periodicity can result in some of the physically different OTA coupling paths having similar behavior (e.g., equal complex gain value, in mathematical terms). Therefore, these redundancies (e.g., equivalence of physically different OTA coupling paths) can be used to calibrate a 2D antenna array without any external reference (e.g., far field source, flying probe etc.).

In the examples of FIG. 4C and FIG. 4D, the TX and RX calibration operations corresponding to OTA path 424 are happening through the identical antenna ports of antenna element 413 (TX) and antenna element 415 (RX). In some cases, the mode of FEMs 420, 422 can be flipped such that antenna element 413 receives (RX) and antenna element 415 transmits (TX) and the coupling behavior of the flipped OTA path (e.g., in the opposite direction of OTA path 424) will be the same as the coupling behavior of OTA path 424. In addition, due to antenna lattice periodicity, OTA path 432 can be treated as a copy of the flipped OTA path (e.g., in the opposite direction of OTA path 424) shifted by two antenna elements. As a result, OTA path 424 and OTA path 432 can have identical coupling behavior. In addition, OTA path 426 and OTA path 428 can have identical coupling behavior for the same reasons. In the example configuration of FIG. 4E, the same assumptions regarding coupling behavior of rotated and/or flipped OTA paths can be applied because an identical port (e.g., TX port 482) is used for both TX and RX during calibration. In the example of FIG. 4F, the same assumptions regarding coupling behavior of rotated and/or flipped OTA paths can be applied when calibration port 474 is used for both TX and RX during calibration process.

Over-the-Air (OTA) Self Calibration with Dual-Use Antenna Ports

FIG. 5A illustrates an example calibration configuration 500 for calibrating antenna elements 502, 506, 508, 504 in a phased array antenna with antenna elements having dual-use ports. In the illustrated example, when antenna elements 502, 504 are in TX mode and antenna elements 506, 508 are in RX mode, the four element linear sub-array of antenna elements 502, 506, 508, 504 can correspond to the configuration of antenna elements 413, 415, 416, 416 shown in FIG. 4C and FIG. 4D. Accordingly, OTA complex coupling parameters associated with antenna ports of the antenna elements 502, 506, 508, 504 (e.g., excluding FEM or BF contributions) C₁, C₄, C₂, C₃ can correspond to the OTA paths 424, 426, 428, 432, respectively of FIG. 4C and FIG. 4D. As described above, the path similarities resulting from reciprocity and periodicity of the antenna lattice can result in identical coupling for physically different OTA paths such that C₁=C₃ and C₂=C₄.

When antenna element 502 is transmitting a calibration signal and antenna element 506 is receiving the calibration signal and sending it to an RFIO port (e.g., RFIO port 405 of BF 407 of FIG. 4C, RFIO port 405 of BF 407 or additional BF 408 of FIG. 4D), a complex number can be generated, at the receiver side, representing the magnitude and phase of the received signal after going through the RF path (a, 1) including TX antenna element a (e.g., antenna element 502), RX antenna element 1 (e.g., antenna element 506), and the OTA path between antenna element a and antenna element 1 relative to a coherent reference signal. The generated complex number is the output of a single measurement and can be referred to as measured value M(1a). When antenna element 502 is transmitting a calibration signal and antenna element 508 is receiving, the measured value can be referred to as measured value M(2a). Similarly, when antenna element 504 is transmitting and antenna element 506 is receiving, the measured value can be referred to as measured value M(1b) and when antenna element 504 is transmitting and antenna element 508 is receiving, the measured value can be referred to as measured value M(2b).

The complex measured values M(1a), M(2a), M(1b), M(2b) can be expressed in terms of complex coupling parameters C₁, C₄, C₂, C₃ and complex gain of RF paths of antenna elements 1, 2, a, b (e.g., antenna elements 506, 508, 502, 504) as shown in Equation (1) to Equation (4) below:

$$M ( 1 a ) = {C}_{1} {X}_{a} {X}_{1} {e}^{j ( {θ}_{a} )} {e}^{j ( {θ}_{1} )} \qquad ( 1 )$$

$$M ( 1 b ) = {C}_{2} {X}_{b} {X}_{1} {e}^{j ( {θ}_{b} )} {e}^{j ( {θ}_{1} )} \qquad ( 2 )$$

$$M ( 2 a ) = {C}_{4} {X}_{a} {X}_{2} {e}^{j ( {θ}_{b} )} {e}^{j ( {θ}_{2} )} \qquad ( 3 )$$

$$M ( 2 b ) = {C}_{3} {X}_{b} {X}_{2} {e}^{j ( {θ}_{b} )} {e}^{j ( {θ}_{2} )} \qquad ( 4 )$$

Where Xₐ, X_{b}, X₁, X₂ are the magnitude contributions for RF paths of antenna elements a, b, 1, and 2, respectively, and θₐ, θ_{b}, θ₁, θ₂ are the phase contributions for RF paths of antenna elements a, b, 1, and 2, respectively. As illustrated in Equation (5) through Equation (7) below, the system of equations shown in Equation (1) through Equation (4) above can be simplified to cancel the contributions of the complex coupling parameters C₁, C₂ C₃, C₄, and the contributions Xₐ, X_{b}, θₐ, θ_{b} of the TX paths of antenna elements a, b, leaving the remaining terms, X₁, X₂ θ₁, θ₂ as unknowns in Equation (7).

$$\frac{M ( 1 a )}{M ( 2 a )} = \frac{{C}_{1}}{{C}_{4}} \frac{{X}_{1}}{{X}_{2}} {e}^{j ( {θ}_{1} - {θ}_{2} )} \qquad ( 5 )$$

$$\frac{M ( 1 b )}{M ( 2 b )} = \frac{{C}_{2}}{{C}_{3}} \frac{{X}_{1}}{{X}_{2}} {e}^{j ( {θ}_{1} - {θ}_{2} )} \qquad ( 6 )$$

$$\frac{M ( 1 a )}{M ( 2 a )} \frac{M ( 1 b )}{M ( 2 b )} = ( \frac{{C}_{1} {C}_{2}}{{C}_{3} {C}_{4}} ) {( \frac{{X}_{1}}{{X}_{2}} )}^{2} {e}^{2 j ( {θ}_{1} - {θ}_{2} )} = {( \frac{{X}_{1}}{{X}_{2}} )}^{2} {e}^{2 j ( {θ}_{1} - {θ}_{2} )} \qquad ( 7 )$$

Referring to Equation (7), the left-hand side of the equation M(1a)/M(2a) M(1b)/M(2b) is a known complex number X_{M}e^{2j(θ}^{_{M}}⁾ which can be computed from complex measured values M(1a), M(2a), M(1b), M(2b). Taking the square root of both sides of Equation (7) yields a pair of solutions as illustrated in Equation (8) below representing a magnitude and phase difference between the complex gain of RX path 1 and the complex gain of RF path 2. The magnitude and phase difference can then be used as a compensation factor to calibrate the RX antenna elements 506, 508 with respect to each other:

$$\sqrt{\frac{M ( 1 a )}{M ( 2 a )} \frac{M ( 1 b )}{M ( 2 b )}} = \sqrt{{( \frac{{X}_{1}}{{X}_{2}} )}^{2} {e}^{- 2 j ( {θ}_{1} - {θ}_{2} )}} = \pm \frac{{X}_{1}}{{X}_{2}} {e}^{- j ( {θ}_{1} - {θ}_{2} )} \qquad ( 8 )$$

Equation (1) through Equation (8) may also be used for calibration with antenna elements 506, 508 transmitting calibration signals and antenna elements 502, 504 receiving calibration signals to calibrate TX antenna elements 506, 508 with respect to each other.

FIG. 5B illustrates an additional example calibration configuration 510. In the example of FIG. 5B a four antenna element sub-array (e.g., antenna elements 512, 516, 518, 514) is configured with a different geometry relative to the example calibration configuration 500 of FIG. 5A. In the illustrated example, the OTA complex coupling parameter between antenna element 512 and antenna element 516 can be referred to as C₁ and the OTA complex coupling parameter between antenna element 514 and antenna element 516 can be referred to as C₂. As noted above, OTA mutual coupling paths can be flipped (e.g., due to reciprocity) and/or OTA mutual coupling paths can be translated along the x and/or y axes of the antenna lattice by an integer number of antenna spacings (e.g., due to periodicity) without impacting the complex value of complex coupling parameters C₁, C₂. Accordingly, the OTA complex coupling parameter C₁ between antenna elements 512, 516 can be equal to the OTA complex coupling parameter C₃ between antenna elements 514, 518. Similarly, the OTA complex coupling parameter C₂ between antenna elements 514, 516 can be equal to the OTA complex coupling parameter C₄ between antenna elements 512, 518. Therefore, Equation (1) through Equation (8) can be applied to measurements of OTA complex coupling parameters C₁, C₂, C₃, C₄ among antenna elements 512, 516, 518, 514 to calibrate antenna elements 516, 518 with respect to each other for nominal RX operation and/or for nominal TX operation.

FIG. 5B illustrates an additional four antenna element sub-array (e.g., antenna elements 522, 526, 528, 524). As illustrated, the OTA path between antenna element 522 and antenna element 528 can be viewed as a translation of the OTA path between antenna element 512 and antenna element 516 and therefore can have the same OTA complex coupling parameter C₁. Similarly, the OTA path between antenna element 524 and antenna element 526 can have OTA complex coupling parameter C₃. The OTA path between antenna element 522 and antenna element 526 can have an OTA complex coupling parameter C₅ and the OTA path between antenna element 524 and antenna element 526 can have an OTA complex coupling parameter C₆. As described above, the OTA complex coupling parameter C₅ and OTA complex coupling parameter C₆ can be equal due to reciprocity and periodicity of the antenna lattice. Therefore, Equation (1) through Equation (8) can also be applied to measurements of OTA complex coupling parameters C₁, C₃, C₅, C₆ for the four antenna element array formed by antenna elements 522, 526, 528, 524 to calibrate antenna elements 526, 528 with respect to each other for nominal RX operation and/or nominal TX operation.

In another illustrative example shown in FIG. 5B, if antenna element 2 is receiving (e.g., the RF path of antenna element 2 is in RX mode) and all of the neighboring antenna elements are transmitting (e.g., RF paths of antenna elements a, 1, b, c, d, e are all in TX mode), the complex measured values M(2a), M(2b), M(2c), M(2d), M(2e) and/or M(21) can be used in equations that do not require performing a square root operation of complex numbers as shown in Equation (8) above. As noted above, the complex value measured between the TX path of antenna element a and the RX path of antenna element 2 can referred to as M(2a), and complex values for other OTA measurement paths can follow a similar convention. In one illustrative example, the complex measured values M(2a) and M(2c) can be used to directly determine a relative complex value (e.g., phase and amplitude) between TX paths a, c without performing a square root operation as shown in Equation (9) below:

$$\frac{M ( 2 a )}{M ( 2 c )} = \frac{{C}_{4}}{{C}_{2}} \frac{{X}_{a}}{{X}_{c}} {e}^{j ( {θ}_{a} - {θ}_{c} )} = \frac{{X}_{a}}{{X}_{c}} {e}^{j ( {θ}_{a} - {θ}_{c} )} \qquad ( 9 )$$

Therefore, using Equation (9), the relative complex value (e.g., phase and amplitude) between TX paths of antenna elements a, c can be computed without a ±pair of equally likely results. Similarly, Equation (10) below can be used directly determine a relative complex value (e.g., phase and amplitude) between TX paths of antenna elements d, 1 and Equation (11) can be used directly determine a relative complex value (e.g., phase and magnitude) between TX paths of antenna elements e, b.

$$\frac{M ( 2 d )}{M ( 21 )} = \frac{{C}_{5}}{{C}_{6}} \frac{{X}_{d}}{{X}_{1}} {e}^{j ( {θ}_{d} - {θ}_{1} )} = \frac{{X}_{d}}{{X}_{1}} {e}^{j ( {θ}_{d} - {θ}_{1} )} \qquad ( 10 )$$

$$\frac{M ( 2 e )}{M ( 2 b )} = \frac{{C}_{1}}{{C}_{3}} \frac{{X}_{e}}{{X}_{b}} {e}^{j ( {θ}_{e} - {θ}_{b} )} = \frac{{X}_{e}}{{X}_{b}} {e}^{j ( {θ}_{e} - {θ}_{b} )} \qquad ( 11 )$$

In some cases, by using Equation (9) through Equation (11) and repeating the same measurement process across the antenna elements in the antenna lattice (e.g., antenna lattice 202 of FIG. 2B) that form the array aperture of the phased array antenna system, any RF path along axis-1, axis-2, axis-3 of the antenna lattice can be calibrated with any other RF path that is two antenna elements away along axis-1, axis-2, or axis-3. As a result, four groups of antenna elements (indicated by four different shadings as shown in FIG. 5B) can be formed that cover the entire antenna lattice. After calibration, the antenna elements in a given group can be calibrated with respect to each other without any ambiguity. For example, each of the antenna elements with horizontally striped shading can be part of a group of antenna elements that are calibrated with respect to each other. However, antenna elements in different groups of antenna elements with different shadings will not be calibrated with respect to each other. For example, the group of antenna elements with horizontally striped shading will not be calibrated relative to the group of antenna elements with vertically striped shading, the group of antenna elements with diagonally striped shading, or the group of antenna elements with white shading. However, Equation (8) above can be used to calibrate between antenna elements in different groups. For example, antenna elements 512, 516, 538, 534 of FIG. 5B can correspond to antenna elements 502, 506, 508, 504 of FIG. 5A. Accordingly, Equation (8) can be used to perform a relative calibration between antenna elements included in different groups. For example, antenna element 516 with horizontally striped shading and antenna element 538 with white shading of FIG. 5B can be calibrated with respect to each other as described above with respect to calibration of antenna elements 506, 508 of FIG. 5A. However, it is not required to form Equation (8) for all antenna pairs across the antenna lattice. Instead, Equation (8) can be used calibrate entire groups of antenna elements. For example, the relative calibration of antenna element 516 and antenna element 538 with respect to each other can be used to calibrate all of the antenna elements in the group of antenna elements with horizontal shading and all of the antenna elements in the group of antenna elements with white shading with respect to each other. In some cases, reducing the number of square root operations needed to solve Equation (8) can save computation time and/or improve accuracy during a calibration procedure in a practical scenario.

### Resolving Ambiguity in Calibration Solutions

As mentioned above, Equation (8) gives two mathematically valid solutions (with 180-degree phase difference due to the ±) while only one of the solutions provides a physically correct solution that will result in a calibrated phased array antenna. Referring to Equation (8), if the expected phase offset θ₁-θ₂ is approximately known, then the ambiguity in the solution to Equation (8) can be resolved by using the result that is closest to the (approximate) expectation. For example, if the actual phase offset θ₁-θ₂ is known due to reliability & repeatability of the construction and/or electronic component predictability of a phased array antenna system, then the solution to Equation (8) that most closely matches to the expected phase values can be selected for calibrating the phased array antenna system. Specifically, the accuracy of the expected value of θ₁-θ₂ should be better than 90 degrees (90°) such that the expected value can be used to discriminate between the two solutions with equal magnitude and 180-degree phase difference. If accuracy of the expected value of θ₁-θ₂ cannot be guaranteed across different builds, across temperature cycles of the phased array, and/or over long periods of time, other redundancies may be used to choose the correct solution to Equation (8).

FIG. 5C and FIG. 5D illustrate example calibration configurations 530, 560 with symmetries in a phased array antenna that can be utilized to resolve ambiguity in the solution to Equation (8). In the examples of FIG. 5C and FIG. 5D, the antenna elements can be configured to exhibit properties of reciprocity and periodicity as described with respect to the antenna elements of FIG. 5A and FIG. 5B. However, it is notable that antenna elements in FIG. 5C and FIG. 5D have properties that may not be present in every type of antenna element that may be used in a phased array antenna. For example, the antenna elements shown in FIG. 5C are linearly polarized (LP) antenna elements with the one polarization being exactly along the y-axis. As another example, the antenna elements shown in FIG. 5D are right hand circularly polarized (RHCP) antenna elements.

FIG. 5C illustrates an example calibration configuration 530 where each of the antenna elements 533 is a linearly polarized antenna element with polarization along the y-axis. In the illustrated example, a TX antenna element 532 can transmit a calibration signal OTA. As illustrated, six RX antenna elements 534, 536, 538, 540, 542, 544 can receive the signal from TX antenna element 532 and complex measured values M can be captured for each measurement regarding antenna element 534, 536, 538, 540, 542, 544. As illustrated, antenna elements 534, 536 can have identical complex coupling parameters C1a, C1b, antenna elements 538, 540 can have identical complex coupling parameters C2a, C2b, and antenna elements 542, 544 can have identical complex coupling parameters C3a, C3b based on lattice periodicity and reciprocity. In addition, for the specific geometry of calibration configuration 530 including antenna elements polarized along the y-axis with high polarization purity, complex coupling parameters C1a, C2b, C2a, C1b can be identical if each antenna element is physically symmetric along the x-axis. In some cases, the 180-degree ambiguity between two solutions of Equation (8) when the accuracy of the expected value of θ₁-θ₂ cannot be relied upon can nevertheless be resolved using the additional constraints C1a=C2b=C2a=C1b. In practice, the antenna elements (532, 534, 536, 538, 540, 542, 544 in FIG. 5C may not have high x-axis polarization isolation or perfect physical symmetry. In such examples, complex coupling parameters C1a, C2b, C2a, C1b may still be approximately equal with some phase error that can be much smaller than 90 degrees. In such cases, complex coupling parameters C1a, C2b, C2a, C1b can still be used to resolve ambiguity between two solutions of Equation (8).

FIG. 5D illustrates an example calibration configuration 560 where each of the antenna elements 563 is a RHCP polarized antenna element with identical polarization. In the illustrated example, a TX antenna element 562 can transmit a calibration signal OTA. As illustrated, six RX antenna elements 564, 566, 568, 570, 572, 574 can receive the calibration signal from TX antenna element 562 and complex measured values M can be captured for each measurement regarding antenna elements 564, 566, 568, 570, 572, 574. As illustrated, antenna elements 564, 566 can have identical complex coupling parameters C1a, C1b, antenna elements 568, 570 can have identical complex coupling parameters C2a, C2b, and antenna elements 572, 574 can have identical complex coupling parameters C3a, C3b based on lattice periodicity and reciprocity. In addition, for the specific geometry of calibration configuration 560 including RHCP polarized antenna elements with high polarization purity, rotational (physical) symmetry and a matched termination for the left hand circularly polarized (LHCP) ports of the antenna elements, complex coupling parameters can have a magnitude/phase relationship as illustrated in Equation (12) below:

$${C}_{1 a} = {C}_{1 b} = \frac{{C}_{3 a}}{{e}^{- j ( \frac{2}{3} π )}} = \frac{{C}_{2 a}}{{e}^{- j ( \frac{4}{3} π )}} = \frac{{C}_{3 b}}{{e}^{- j ( \frac{2}{3} π )}} = \frac{{C}_{2 b}}{{e}^{- j ( \frac{4}{3} π )}} \qquad ( 12 )$$

In some examples, the ambiguity between two solutions to Equation (8) that are 180 degrees out of phase can be resolved using the constraints illustrated in Equation (12). In practice, the antenna elements 562, 564, 566, 568, 570, 572, 574 may not have high polarization isolation, perfect physical symmetry, and/or identical termination for the LHCP ports of the antenna elements. In such examples, the phase relationships illustrated in Equation (12) are not strictly true but can still be accurate enough (e.g., having a phase error much smaller than 90 degrees) and can be used to resolve the 180-degree ambiguity of Equation (8).

### OTA Calibration Using Different Antenna Element Configurations

In the description of OTA path similarities of FIG. 5A above, example calibration configuration 440 of FIG. 4C and additional example calibration configuration 450 of FIG. 4D were provided for as examples. However, the antenna elements 463, 465, 466, 464 shown in the calibration configuration 460 of FIG. 4E can also correspond to the antenna elements of FIG. 5A, FIG. 5B, and FIG. 5D, as long as the TX port 482 is used while transmitting calibration signals (e.g., by TX antenna elements 463, 464) and while receiving calibration signals (e.g., by RX antenna elements 465, 466).

Similarly, antenna elements 463, 465, 466, 464 show in additional example calibration configuration 470 of FIG. 4F can correspond to the antenna elements of FIG. 5A, FIG. 5B, and FIG. 5D, as long as calibration port 474 is used while transmitting calibration signals (e.g., by antenna elements 463, 464) and while receiving calibration signals (e.g., by antenna elements 465, 466).

FIG. 5C refers to linearly polarized antennas, therefore it can refer to configurations similar to the ones shown in FIG. 4C through FIG. 4F modified such that the polarization of the antenna elements should be changed to linear polarization. In the examples of FIG. 4E and FIG. 4F, this can be accomplished by removing the 3-dB 90-degree hybrid 425. In addition, references to the TX port 482 and terminated port 484 of FIG. 4E can be replaced by references to dual linear ports of the antenna elements 463, 465, 466, 464, which will not impact the calibration approaches described above. Similarly, references to TX port 472 and calibration port 474 of FIG. 4F can be replaced by references to dual linear ports of the antenna elements 463, 465, 466, 464.

OTA Calibration Using Dual-Use Calibration Port Different from Functional Port

As noted above, FIG. 4F illustrates an additional example calibration configuration 470 that differs from the configurations of FIG. 4C through FIG. 4E in that a calibration port 474 is used during calibration for both transmitting calibration signals and receiving calibration signals. As a result, performing relative calibration using Equation (1) through Equation (8), alone or in combination with Equation (9) through Equation (11) provides calibration of antenna elements and their RF paths in a calibration mode (e.g., mRX mode) of FEMs 477 and/or RFIO ports 405. For example, the FEMs 477 can have switch 491 closed and PA 421 turned off or idle. In some cases, in order to calibrate the functional RF paths (e.g., TX mode of FEM 477 when PA 421 is on and switch 491 is open), additional measurements may be required.

In one illustrative example, calibration of functional TX paths (e.g., functional TX RF paths) can begin by performing relative calibration using Equation (1) through Equation (11) to calibrate the RF paths of every antenna when FEMs 477 and RFIO ports 405 are in a calibration mode (e.g., mRX mode can produce a fully calibrate RX antenna array).

In some implementations, a first calibration measurement can be performed using a TX antenna element selected from any location of the antenna lattice (e.g., a location xₘ, yₙ) and an RX antenna element (e.g., at location xₘ₊ₖ, yₙ₊ₗ). In the illustrative example, location xₘ, yₙ corresponds to the location of an antenna element that is m^{th} along the x-axis (e.g., along a row of antenna elements) and n^{th} along the y-axis (e.g., along a column of antenna elements) of the antenna lattice 202, where m and n are integers. In addition, location xₘ₊ₖ, yₙ₊ₗ corresponds to the location of an antenna element offset from the antenna element at location (xₘ, yₙ) by k antenna elements along the x-axis and l antenna elements along the y-axis, where k and l are integers. In some cases, the TX antenna element at location xₘ, yₙ can be configured with its RF path in functional TX mode. For example, the FEM 477 corresponding to the TX antenna element can have PA 421 turned on and switch 491 open. In some examples, the TX antenna element can transmit a calibration signal and the RX antenna element can receive the calibration signal and a complex measured value M[(xₘ₊ₖ, yₙ₊ₗ)(xₘ, yₙ)] representing the magnitude and phase of the received signal can be generated.

In some examples, a second calibration measurement can be taken using a TX antenna element at location xₘ₊ₕ₁, yₙ₊ₕ₂ (where h1 and h2 are integers) transmitting a calibration signal and an RX antenna element at a location xₘ₊ₕ₁₊ₖ, yₙ₊ₕ₂₊ₗ receiving the calibration signal. In some cases, a complex measured value M[(xₘ₊ₕ₁₊ₖ, yₙ₊ₕ₂₊ₗ)(xₘ₊ₕ₁, yₙ₊ₕ₂)] representing the magnitude and phase of the received signal can be generated. A ratio of the first calibration measurement and the second calibration is illustrated in Equation (13) below:

$$\frac{M [ ( {x}_{m + k} {y}_{n + l} ) ( {x}_{m} , {y}_{n} ) ]}{M [ ( {x}_{m + h 1 + k} , {y}_{n + h 2 + l} ) ( {x}_{m + h 1} , {y}_{n + h 2} ) ]} = \frac{C ( {x}_{m + k} {y}_{n + l} ) ( {x}_{m} , {y}_{n} )}{C ( {x}_{m + h 1 + k} , {y}_{n + h 2 + l} ) ( {x}_{m + h 1} , {y}_{n + h 2} )} \frac{{X}_{m + k , n + l}}{{X}_{m + h 1 + k , n + h 2 + l}} \frac{{X}_{m , n}}{{X}_{m + h 1 , n + h 2}} \frac{{e}^{j ( {θ}_{m + k , n + l} + {θ}_{m , n} )}}{{e}^{j ( {θ}_{m + h 1 k , n + h 2 + l} + {θ}_{m + h 1 , n + h 2} )}} = \frac{{X}_{m , n}}{{X}_{m + h 1 , n + h 2}} {e}^{j ( {θ}_{m , n} - {θ}_{m + h 1 , n + h 2} )} \qquad ( 13 )$$

As noted above, the pairs of antenna elements used to measure OTA complex coupling parameters C₍ₓ_{ₘ₊ₖ}_{, y}_{ₙ₊ₗ}₎₍ₓ_{ₘ}_{,y}_{ₙ}₎ and C₍ₓ_{ₘ₊ₕ₁₊ₖ}_{, y}_{ₙ₊ₕ₂₊ₗ}₎₍ₓ_{ₘ₊ₕ₁}_{,y}_{ₙ₊ₕ₂}₎ are shifted (along antenna rows and columns respectively) copies of each other and lattice periodicity ensures that the OTA complex coupling parameters are equal in numerical value so they cancel out. In addition, X_{m+k,n+l}e^{j(θ}^{_{m+k,n+l}}⁾ and X_{m+h1+k,n+h2+l}e^{j(θ}^{_{m+h1+k,n+h2+l}}⁾ are magnitude and phase components of the mRX paths of the antenna elements at location xₘ₊ₖ, yₙ₊₁ and location xₘ₊ₕ₁₊ₖ, yₙ₊ₕ₂₊ₗ that were initially calibrated with respect to each other using Equation (1) through Equation (11) to be equal in amplitude and phase and therefore cancel out. Thus, Equation (13) can be simplified as shown above. In some aspects, Equation (13) can calculate a direct relationship between the functional TX RF paths of antenna elements at location xₘ, yₙ and location xₘ₊ₕ₁, yₙ₊ₕ₂. Accordingly, Equation (13) can calibrate any two RF paths (e.g., functional TX paths) with respect to each other since h1, h2 can have any integer value without impacting Equation (13).

It should be understood that Equation (1) through Equation (13), and the calibration configurations they refer to, have been described as if local measurements are captured and then Equation (1) through Equation (13) are solved for those measurements to calibrate two antenna elements at a time, and then the process is repeated sequentially to calibrate the full 2D antenna array. However, the calibration examples above are provided for the purposes of clearly illustrating the process of measuring OTA complex coupling parameters and the physical redundancies used for calibration. In some cases, calibration configurations that differ from the examples described herein can be used without departing from the scope of the present disclosure. For example, all possible measurements between any pair of antenna elements that could be used in a sequential approach and the calculations illustrated in Equations (1) through Equation (13) can be organized as a set of linear equations to be solved with a convenient mathematical approach (e.g., least squares). In some examples, hundreds or thousands of linear equations can be solved simultaneously. The exact way of solving this larger set of equations may depend on the accuracy needed and the computational resources and/or time available during the functional phased array operation and is outside the scope of the present disclosure.

### Self-Calibration Using Magnitude-Only Measurements

The examples illustrated in FIG. 5A through FIG. 5D and Equation (1) through Equation (13) assume a capability of performing coherent RF measurements between TX/RX antenna element pairs during a calibration process. Although performing coherent RF measurements between TX/RX antenna element pairs may help the calibration process to be faster and/or achieve better accuracy in some practical scenarios, coherent RF measurements between TX/RX antenna element pairs are not a fundamental part of the OTA self-calibration approach described herein.

FIG. 4G shows a calibration configuration 480 that does not require coherent measurements to perform calibration. In aspects, the calibration configuration 480 of FIG. 4G may be similar to the calibration configuration 460 of FIG. 4E, except that the path through bypass switches 468 is replaced by a detector 496. In some implementations, detector 496 can include a voltage detector, a current detector, a power detector, and/or any combination thereof. In one illustrative example, detector 496 can include an RMS (or peak) voltage detector that produces a real number output corresponding to the RMS voltage magnitude of a signal from TX port 482 and coupled via coupler 488 to the input of detector 496.

In some examples, the number output by the detector 496 can be sent to a processor using digital/data paths 497 during calibration mode. In some cases, the processor can be included in a BF (e.g., BF 407, additional BF 408 of FIG. 4A through FIG. 4D). In some examples, the processor can be included in a modem (e.g., modem 210 of FIG. 2B). In some cases, the processor can correspond to processor 1610 of the computing system 1600 of FIG. 16.

In some implementations, the measurements captured by detector 496 can be magnitude-only. In some cases, multiple measurements can be taken while adjusting the gain and phase of the TX paths to produce complex data relating the magnitude and phase relationship (e.g., a complex ratio) of the transmit paths of two different TX antenna elements (e.g., antenna element 463 and antenna element 464). For example, when the antenna elements 463, 464 are transmitting the same signal waveform simultaneously and the antenna element 465 is receiving the transmitted signals, the signal flowing towards the FEM 487 from TX port 482 of antenna element 465 is a vector sum of the signal coming from antenna element 463 and antenna element 464. Specifically, the magnitude value detected by detector 496 of antenna element 465 when TX antenna elements 463, 464 are simultaneously transmitting is proportional to the magnitude of a complex sum shown in Equation (14) below:

$${V}_{465 , ( 463 , 464 )} = \vert {C}_{424} {X}_{463} {e}^{j ( {θ}_{463} )} + {C}_{428} {X}_{464} {e}^{j ( {θ}_{464} )} \vert \qquad ( 14 )$$

Where C₄₂₄ and C₄₂₈ designate the complex coupling parameters through OTA paths 424 and 428, X₄₆₃ and X₄₆₄ designate magnitudes of the complex gain of the respective RF paths for antenna elements 463, 464, θ₄₆₃, θ₄₆₄ designate the phase of the complex gain of the respective RF paths for antenna elements 463, 464, and | | represents the magnitude of the complex value inside the bracket. In some implementations, the value V_{465,(463,464)} detected by detector 496 can be repeated measured while changing the magnitude X₄₆₃ and phase θ₄₆₃ of the RF path of antenna element 463 such that the value of V_{465,(463,464)} is minimized. The minimum value of V_{465,(463,464)} occurs when the complex gain of RF path of antenna element 463 is selected such that |C₄₂₄X′₄₆₃e^{j(θ′}^{₄₆₃}⁾+C₄₂₈X₄₆₄e^{j(θ}^{₄₆₄}⁾|=0, which means

$${C}_{424} {X}_{463}^{′} {e}^{j ( {θ}_{463}^{′} )} = - {C}_{428} {X}_{464} {e}^{j ( {θ}_{464} )} or \frac{{C}_{424} {X}_{463}^{′} {e}^{j ( {θ}_{463}^{′} )}}{{C}_{428} {X}_{464}^{′} {e}^{j ( {θ}_{464}^{′} )}} = - 1.$$

As used herein, the magnitude X′₄₆₃ and phase θ′₄₆₃ refer to the specific magnitude and phase settings along the RF path of antenna element 463 (e.g., from phase shifters, PAs 421, or the like) such that V_{465,(463,464)}=0. In some cases, knowing the values of X′₄₆₃, θ′₄₆₃ is equivalent to knowing the complex value M(1a)/M(1b) or ratio of Equation (1) to Equation (2).

In some implementations, the same search procedure can be used for minimizing the voltage value V_{466,(463,464)} when antenna element 466 is the receiving antenna element to find the magnitude and phase settings of RF path for antenna element 466 that satisfies

$$\frac{{C}_{424} {X}_{463}^{″} {e}^{j ( {θ}_{463}^{″} )}}{{C}_{428} {X}_{464}^{″} {e}^{j ( {θ}_{464}^{″} )}} = - 1 ,$$

which is equivalent to knowing M(2a)/M(2b) or ratio of Equation (3) to Equation (4). As used herein, the magnitude X″₄₆₃ and phase θ″₄₆₃ refer to the specific magnitude and phase settings along the RF path of antenna element 463 (e.g., from phase shifters, PAs 421, or the like) such that V_{466,(463,464)}=0. Therefore, the procedure described in Equation (5) through Equation (8) can be modified to solve for M(1a)/M(1b) M(2a)/M(2b) and then obtain the relative ratio of complex gain (e.g., magnitude and phase) between the RF path of TX antenna element 463 and the RF path of TX antenna element 464. In such an example, a 180-degree ambiguity similar to the ambiguity in the solution of Equation (8) still exists and can be resolved by similar procedures described above regarding the configurations shown in FIG. 4C through FIG. 4F.

### OTA Self Calibration Using Dedicated Antenna Ports (TX-Only or RX-Only) and Calibration Lines

In some cases, phased array antennas can have antenna elements with dedicated antenna ports that can operate as TX-only or RX-only during calibration such that some of the redundancies illustrated in FIG. 5A through FIG. 5D do not apply. For example, if the assumptions that C₂=C₄, C₁=C₃ or C₅=C₆ in FIG. 5A and FIG. 5B no longer hold, Equations (1) through Equation (4) cannot be simplified into Equation (8). In such a case, more redundancies internal to the phased array antenna may be needed to be able to calibrate the functional RF paths with respect to each other without using an external reference (e.g., a far-field source, a flying probe, etc.)

FIG. 6 illustrates an example calibration configuration 600 with antenna elements 613, 614, 615, 616 that have dedicated TX-only and RX-only antenna ports. For example, the antenna elements 613 can be dual-linear polarized antennas routed to a 3-dB 90-degree hybrid 625 that results in an RX port 684 and a TX port 682. As illustrated, the RX port 684 and TX port 682 can be coupled to corresponding ports of the FEMs 620, 622. As illustrated, FEMs 620, 622 can each include a PA 621 and an LNA 623. In the illustrated example, FEMs 620 are configured in a TX configuration and FEMs 622 are configured in an RX configuration. In some cases, FEMs 620, 620 can include a dedicated RX port coupled to the input of LNA 623 and a dedicated TX port coupled and the output of PA 621. In some cases, each FEM 620, 622 can include a combined IO port 626 coupled to the output of LNA 623 and the input of the PA 621. In some implementations, the output of LNA 623 and input of PA 621 can be combined using a passive or active combiner included in each FEM 620, 622. In some examples, the combined IO port 626 of each FEM 620, 622 can be routed to an RFIO port 605 of the BF 607. The specific RFIO paths shown are referred to as RFIO 653, RFIO 655, RFIO 656, RFIO 654 corresponding to antenna elements 613, 615, 616, 614, respectively.

In some examples, when a given FEM 622 is in RX mode, the LNA 623 is active, PA 621 is off (or idle), and the RFIO port 605 routed to the FEM 622 is in an RX configuration. Similarly, when an FEM 620 is in TX mode, LNA 623 is off (or idle), PA 621 is active and the RFIO port 605 routed to the FEM 620 is in a TX configuration. In one illustrative example, a complex coupling parameter (e.g., complex coupling parameter S (684.615). (682.613)) for the OTA path 632 from TX port 682 of antenna element 613 to RX port 684 of antenna element 615 can be measured when RFIO 653 is in TX mode and RFIO 655 is in RX mode (as shown in FIG. 6). Similarly, a complex coupling parameter (e.g., complex coupling parameter S (684.613). (682.615)) for a reversed OTA path (not shown) in the opposite direction of OTA path 632 from TX port 682 of antenna element 615 to RX port 684 of antenna element 613 can be measured when RFIO 655 is in TX mode and RFIO 653 in RX mode (not shown in FIG. 6). In the example calibration configuration 600 of FIG. 6, the antenna array is not assumed to have a particular physical symmetry between antenna element 613 and antenna element 615 and the complex coupling parameters for OTA path 632 and the reversed OTA path in the opposite direction of OTA path 632 are not assumed to be equal such that S_{(684,613),(682,615)}≠S_{(684,615),(682,613)}.

FIG. 7 illustrates an example calibration measurement configuration 700 for a phased array antenna system including antenna elements with dedicated antenna ports for transmit and for receive. As illustrated in FIG. 7, the calibration measurement configuration 700 includes a group of four antenna elements 702, 706, 708, 704 in a linear arrangement with corresponding OTA paths similar to the linear arrangement of antenna elements 502, 506, 508, 504 of FIG. 5A and corresponding OTA paths shown in FIG. 5A. However, in the example of FIG. 7 the antenna elements 702, 706, 708, 704 can correspond to antenna elements 613, 615, 616, 614 shown in FIG. 6. As a result, the calibration of the antenna elements 702, 706, 708, 704 does not incorporate assumption that flipped and/or translated OTA paths behave identically, and therefore complex coupling parameter C₁ is not assumed to be equal to complex parameter C₃ (e.g., C₁≠C₃) and complex coupling parameter C₂ is not assumed to be equal to complex parameter C₄ (e.g., C₂≠C₄). Accordingly, when Equation (1) through Equation (4) are generated for the complex measured values M(1a), M(2a), M(1b), M(2b) using the antenna elements 702, 706, 708, 704, cannot be simplified in the same way as illustrated by Equation (8) above.

FIG. 8A illustrates an example calibration configuration 800, incorporating additional redundancy to supplement OTA mutual coupling measurements for OTA calibration of a phased array antenna system. As illustrated in FIG. 8A, one or more calibration lines (e.g., calibration lines 802, 804, 806) can be coupled to a subset of the antenna elements of the antenna array (e.g., antenna elements 812, 814, 816, 818, 808). For example, calibration line 802 can be coupled to antenna elements 808, 816, 818, calibration line 804 can be coupled to antenna elements 812, 816, and calibration line 806 can be coupled to antenna elements 814, 818. As illustrated, the calibration configuration 800 can also include antenna elements 813 that are not coupled to any of the calibration lines 802, 804, 806.

In some cases, the one or more calibration lines 802, 804, 806 can be used to calibrate corresponding antenna elements. For example, antenna elements 812 coupled to the calibration line 804 can be calibrated relative to one another using the measurement ports mRX/mTX on both ends of the calibration line 804. Similarly, the antenna elements 808 can be calibrated relative to one another using the measurement ports mRX/mTX on both ends of the calibration line 802, and the antenna elements 814 can be calibrated using the measurement ports mRX/mTX on both ends of the calibration line 806. In some implementations, after calibrating antenna elements 808, 812, 814 using the calibration lines 802, 804, 806, the fact that the functional RF path of the calibrated antenna elements s are already calibrated relative to one other (e.g., identical phase & magnitude behavior) can be used to estimate the previously unknown complex ratios C₁/C₃ and C₂/C₄ in Equation (1) through Equation (4). In some implementations, the estimated ratios C₁/C₃ and C₂/C₄ can then be used in other parts of the antenna array where there are no calibration lines to simplify Equations (1) through Equation (4) to a form similar to Equation (8) and align the full 2D array of antenna elements.

FIG. 8B illustrates a detailed view of a subsection 810 of the antenna lattice (e.g., antenna lattice 202 of FIG. 2B) of the calibration configuration 800 of FIG. 8A including a portion of the calibration line 802. As illustrated, the portion of calibration line 802 in the subsection 810 runs along and is coupled to three antenna elements 808. As illustrated, the subsection 810 can also include antenna elements 813 of the antenna lattice that are not coupled to calibration line 802. Each section of calibration line 802 between antenna elements 808 can periodically repeat with an effective length L between antenna elements 808 (individually labeled as antenna elements 1, 2, 3). In some case, the effective length of individual sections of the calibration line 802 may not be equal but the sections of the calibration line 802 may instead have known ratios of effective lengths. In some implementations, calibration line 802 can be consistently (e.g., with an identical complex coupling ratio) coupled to the transmit/receive RF path of each antenna element 808 by a weak coupler (e.g., with a coupling factor less than-20 dB to prevent antenna efficiency degradation). In some cases, a calibration signal can be transmitted from (or received by) port A or port B and can be received by (or transmitted from) RF paths of antenna elements 1, 2, 3. In some examples, the measurements obtained from measurement pairs (A,1), (A,2), (A,3), (B,1), (B,2), (B,3) can generate enough redundancy using assumptions about the calibration line sections (e.g., equal effective lengths or known ratios of effective length) and the consistent coupling levels to the antennas such that RF paths for antenna elements 1, 2, 3 can be calibrated. In some examples, a similar technique can be used to calibrate more than three antenna elements along a calibration line. A more detailed explanation of the process for performing calibration using the calibration lines shown in FIG. 8A and/or subsection 810 of FIG. 8B is outside of the scope of the present disclosure and can be found in U.S. patent application Ser. No. 18/132,108, entitled “ANTENNA APPARATUS AND IN-LINE CALIBRATION SYSTEM FOR SAME,” which is hereby incorporated herein in its entirety and for all purposes.

FIG. 8C illustrates a calibration result 830 of a calibration performed on the antenna elements 812 using the calibration line 804. As illustrated, the RF paths (RX and/or TX) for antenna elements 819 (including individually labeled antenna elements a, b, c, d, e, f) can be magnitude and phase aligned by calibration line 804, prior to performing OTA coupling measurements. FIG. 8C also illustrates OTA calibration measurements that can be used to calibrate antenna elements 819 (including individually labeled antenna elements 1, 2, 3) using the calibrated antenna elements 812 as a reference. In the illustrated example, antenna elements 819 are configured in TX mode and the antenna elements 819 transmit calibration signals from a TX port (e.g., TX port 682 of FIG. 6) while antenna elements 812 are receiving the calibration signals OTA through an RX port (e.g., RX port 684 of FIG. 6). In one illustrative example, antenna element 1 is configured to transmit calibration signals that are received OTA by antenna element a and antenna element b. As illustrated, the OTA path between antenna element 1 and antenna element a can have complex coupling parameters S₁ and the OTA path between antenna element 1 and antenna element b can have a complex coupling parameter S₂. In some examples, a measurement between the RF path of antenna element 1 and the RF path of antenna element a can be referred to as complex measured value M(a1). Similarly, a measurement between the RF path of antenna element 1 and the RF path of antenna element b can be referred to as complex measured value M(b1). In some aspects, the complex measured values M(a1), M(b1) can be used to determine a ratio between complex coupling parameters S₁, S₂ as illustrated by Equation (15) through Equation (17) below:

$$M ( a 1 ) = {S}_{1} {X}_{a} {X}_{1} {e}^{j ( {θ}_{a} )} {e}^{j ( {θ}_{1} )} \qquad ( 15 )$$

$$M ( b 1 ) = {S}_{2} {X}_{b} {X}_{1} {e}^{j ( {θ}_{b} )} {e}^{j ( {θ}_{1} )} \qquad ( 16 )$$

$$\frac{M ( a 1 )}{M ( b 1 )} = \frac{{S}_{2}}{{S}_{1}} \frac{{X}_{a}}{{X}_{b}} {e}^{j ( {θ}_{a} - {θ}_{b} )} = \frac{{S}_{1}}{{S}_{2}} \qquad ( 17 )$$

Where Xₐ, X_{b}, are the magnitude contributions for the RF paths of antenna elements a, b, respectively, and θₐ, θ_{b} are the phase contributions for the RF paths of antenna elements a, b, respectively. The simplification of Equation (17) is possible because the RF path for antenna element a and the RF path for antenna element b were previously calibrated using the calibration line 804 such that Xₐ=X_{b} and θₐ=θ_{b}. Therefore, two captured OTA measurements (e.g., M(a1), M(b1)) can be used to calculate a value for the ratio S₁/S₂. However, a value for the ratio S₁/S₂ that is calculated based on two captured OTA measurements may not be accurate since the calibration accuracy of antenna elements 812 by the calibration line 804 may include phase error and/or magnitude error. However, additional OTA measurements using different antenna elements 812 at different locations along the calibration line can be used to calculate additional values for the ratio S₁/S₂ using Equation (15) through Equation (17). For example, an additional value for the ratio S₁/S₂ can be calculated based on measuring a calibration signal transmitted from antenna element 2 received by both antenna element c (e.g., complex measured value M(c2)) and antenna element d (e.g., complex measured value M(d2)). In another example, an additional estimate for the ratio S₁/S₂ can be calculated based on a measuring a calibration signal transmitted from antenna element 3 that is received at both antenna element e (e.g., complex measured value M(e3)) and antenna element f (e.g., complex measured value M(f3)). In some cases, the values for the ratio S₁/S₂ obtained from multiple pairs of OTA calibration measurements can be combined (e.g., averaged) into a numerical estimate of the ratio S₁/S₂.

FIG. 8D illustrates a calibration configuration 840 showing calibration of antenna elements based on OTA calibration measurements and the estimate of the ratio S₁/S₂ as described with respect to FIG. 8C above. As illustrated, the estimate ratio S₁/S₂ can be used to calibrate columns of antenna elements (e.g., columns 844, 845) that are not coupled to the calibration line 804. For example, an antenna element 1 in column 844 can be calibrated based on a pair of OTA measurements from a calibration signal transmitted by the antenna element 1 and received OTA at an adjacent pair of antenna elements a, b in column 843. In some cases, the two complex measured values M(a1)/M(b1) can be inserted into the left-hand side of Equation (15) and Equation (16). However, the ratio of the two measured complex values (e.g., M(a1)/M(b1) of Equation (15) and Equation (16) will not simplify Equation (17) since the values Xₐ,X_{b}, θₐ,θ_{b} are unknown when antenna elements a, b are chosen from column 843, which were not calibrated using the calibration line 804. However, Equation (15) and Equation (16) can be rewritten using the numerical estimate of the ratio S₁/S₂ as shown in Equation (18) below:

$$\frac{M ( a 1 )}{M ( b 1 )} \frac{{S}_{2}}{{S}_{1}} = \frac{{X}_{a}}{{X}_{b}} {e}^{j ( {θ}_{a} - {θ}_{b} )} \qquad ( 18 )$$

In some cases, the terms on the left-hand side of the Equation (18) can have numerical values. For example, complex measured values M(a1), M(b1) can have known numerical values obtained from OTA measurements and the ratio S₁/S₂ can have an estimated numerical value as described above with respect to FIG. 8C. In addition, the terms on the right-hand side of Equation (18) can represent relative the magnitude and phase values of the RF path for antenna element a and the RF path for antenna element b. In some cases, a calibrated pair of antenna elements can have equal magnitude such that Xₐ=X_{b}, and equal phase such that θₐ=θ_{b}. Accordingly, the RF paths of antenna elements a, b can be calibrated with respect to each other using a complex compensation factor determined from Equation (18).

As illustrated in the calibration configuration 850 of FIG. 8E, a similar calibration procedure can be applied for any adjacent pair of antenna elements in column 843 such that the RF paths of all the antenna elements in column 843 are calibrated with respect to each other. In addition, a similar calibration process can be used to calibrate antenna elements in all of the columns (e.g., columns 844, 845, 851, 852, 853, 854, 855, 856, 857, 858, 859, 861) of the antenna array, such that any given column has all of its antennas calibrated among themselves, as illustrated by antenna elements sharing a particular shading. As illustrated, while the individual antenna elements of each column (e.g., columns 844, 845, 856, 857, 858, 859, 861) of the antenna array can be calibrated, the calibration configuration 850 illustrates that the columns may not be calibrated relative to one another.

FIG. 8F illustrates a calibration configuration 860 that can be used to perform OTA calibration of rows of antenna elements using a reference subset of self-calibrated antenna elements 808 coupled to a calibration line 802. In the illustrated example of FIG. 8F, antenna elements 808 are assumed to be calibrated by the calibration line as indicated by black shading. In some implementations, a pair of adjacent antenna elements 862 in the same row 871 of antenna elements can transmit calibration signals to a single receiving antenna element 808 to estimate the OTA complex coupling parameter ratio S₃/S₄, using Equation (15) through Equation (17). In some cases, the estimated ratio S₃/S₄ and an equation similar equation to Equation (18) can be used to calibrate rows of antenna elements in each row of antenna elements (e.g., rows 871, 872, 873, 874, 875, 876, 877, 878) relative to one another, as indicated by antenna elements sharing a particular shading. In some cases, the calibration of columns of antenna elements as shown in FIG. 8E and the calibration of rows of antenna elements as shown in FIG. 8F can be used to complete a full 2D calibration of the antenna elements of the antenna array.

In some implementations, one or more calibration lines can be configured to couple to antenna elements in multiple rows and multiple columns of an antenna array. In some cases, antenna elements across multiple rows and multiple columns of an antenna array can be calibrated with respect to one another. In some examples, OTA calibration measurements can be captured between pairs of antenna elements and a single calibrated antenna element to estimate a complex coupling parameter ratio (e.g., S₁/S₂, S₃/S₄). In some cases, an equation similar to Equation (18) above can be used to calibrate groups of antenna elements relative to one another based on OTA calibration measurements. In some implementations, groups of antenna elements relative to one another based on OTA calibration measurements can be referred to as calibration groups. In some examples, the antenna elements calibrated relative to one another based on measurements using the one or more calibration lines may also be considered calibration groups. In some cases, the geometry of the calibration groups can vary based on the geometry of the one or more calibration lines. In some cases, a full 2D calibration of antenna elements of the antenna array can be completed based on antenna elements that are included in multiple calibration groups. By way of example and without limitation, one or more calibration lines configured to couple to antenna elements in multiple rows and multiple columns of an antenna array (not shown) can include a curved calibration line, a zig-zagging calibration line, a meandering calibration line, a piece-wise linear calibration line, and/or any combination thereof.

It should be understood that Equation (15) through Equation (18) and the measurement configurations they refer to, have been described as if local measurements are captured and then Equation (15) through Equation (18) are solved for those measurements to calibrate two antenna elements at a time, and then the process is repeated sequentially to calibrate the full 2D antenna array. However, the calibration examples above are provided for the purposes of clearly illustrating the process of measuring OTA complex coupling parameters and the and the physical redundancies (e.g., estimated ratio S₁/S₂, estimated ratio S₃/S₄) used for calibration. In some cases, calibration configurations that differ from the examples described herein can be used without departing from the scope of the present disclosure. For example, all possible measurements between any pair of antenna elements and/or between an antenna element and a calibration line that could be used in a sequential and the calculations illustrated in Equation (15) through Equation (18) can be organized as a set of linear equations (to be solved with a convenient mathematical approach (e.g., least squares). In some examples, hundreds or thousands of linear equations can be solved simultaneously. The exact way of solving this larger set of equations may depend on the accuracy needed and the computational resources and/or time available during the functional phased array operation and is outside the scope of the present disclosure.

### Self-Calibration Using Sub-Arrays of Antenna and Front-End Module

The systems and techniques described herein for performing OTA self-calibration may also be applied to antenna elements that lack dual-use ports as descried with respect to the examples of FIG. 4A through FIG. 4G and FIG. 5A through FIG. 5D such that Equations (1) through (14) cannot be applied without additional redundancies to achieve a full calibration. In addition, the systems and techniques described herein for performing OTA self-calibration in a system that lacks calibration lines to provide extra redundancy as illustrated in FIG. 8A through FIG. 8F such that Equations (15) through Equation (18) are not applicable. In some implementations, groups of antenna elements (also referred to as antenna element sub-arrays herein) formed by antenna elements that are routed to the same FEM chip and/or RFIO paths can be used as internal reference points for determining relative calibration between antenna elements of an antenna array. In some aspects, the systems and techniques assume a predictable routing of RF transmission lines (e.g., routing traces on a PCB and/or a waveguide distribution network) and/or predictable FEM chip characteristics (e.g., relative gain levels of different paths in a given FEM).

FIG. 9A through FIG. 9H illustrate different example configurations of antenna sub-arrays and configurations (e.g., combinations and/or orientations) of corresponding FEMs and/or RFIO lines routed to a BF. For example, FIG. 9A illustrates calibration configuration including a two-way FEM 922 (e.g., an FEM with two TX/RX port pairs TX1/RX1, TX2/RX2) that can control two dual port antenna elements 913 and has a single bidirectional RFIO port 925, that can be routed to a BF RFIO 905, or a passive power combiner/divider (e.g., a Wilkinson combiner/divider). For the example calibration configuration 900 of FIG. 9A, the two antennas connected to the FEM 922 are aligned along the x-axis of the antenna lattice. FIG. 9B illustrates an additional calibration configuration 910 including a three-way FEM 924 (e.g., an FEM having three TX/RX port pairs TX1/RX1, TX2/RX2, TX3/RX3) that can control three dual port antenna elements 913.

In both of the example configurations of FIG. 9A and FIG. 9B, the inclusion of a single RFIO port 925 for the two-way FEM 922 and three way FEM 924, indicates that the FEMs 922, 924 have internal RF phase and/or gain shifters to be able to control the relative RF complex gain (e.g., phase and/or magnitude) of the RF path between RFIO port 925 and TX1, the RF path between RFIO port 925 and TX2, and/or the RF path between RFIO port 925 and TX3. Similarly, the inclusion of single RFIO port 925 indicates that the FEMs 922, 924 have internal RF phase and/or gain shifters to be able to control the relative phase and/or magnitude of RF complex gain for the RF path between RX1 and RFIO port 925, the RF path between RX2 and RFIO port 925, and/or the RF path between RX3 and RFIO port 925. In some cases, the FEMs 922, 924 may include passive power combiner/dividers (e.g., a Wilkinson combiner/divider) for sharing the single RFIO port 925 between the TX/RX pairs of each FEM. In some cases, internal circuitry 926 can include phase shifters, amplifiers, filters, combiner/dividers, other electrical components, and/or any combination thereof. For the purposes of providing clear illustrations, it should be understood that any of the FEMs described in FIG. 9C through FIG. 9I, FIG. 10A through FIG. 10E, FIG. 11A, FIG. 11B, and FIG. 12 can optionally include internal circuitry 926.

FIG. 9C illustrates a linear configuration 920 where RFIO ports 925 of a first FEM 922 and a second FEM 933 are combined with a power combiner/divider 928 (e.g., a −3 dB Wilkinson combiner/divider) to form a four-element sub-array. As illustrated the antenna elements 913 in the four-element sub-array are arranged in a line of four antenna elements (e.g., a 1×4 array of antenna elements) aligned along the x-axis. FIG. 9D illustrates a rotated linear calibration configuration 930. As illustrated, the rotated linear calibration configuration 930 can be similar to the linear configuration 920 of FIG. 9C, except that the antenna elements 913 of the four-element sub-array are arranged in a 1×4 array of antenna elements aligned along the y-axis. In some examples, the x-axis and y-axis can represent orthogonal directions in the plane of a 2D antenna lattice (e.g., antenna lattice 202 of FIG. 2B).

FIG. 9E illustrates a rectangular configuration 940 where RFIO ports 925 of a first FEM 922 and a second FEM 933 are combined with a power combiner/divider 928 (e.g., a −3 dB Wilkinson combiner/divider) to form a four-element rectangular sub-array (e.g., a 2×2 array of antenna elements). As illustrated, the two dual port antenna elements 913 routed to FEM 922 are aligned along the x-axis and the two dual port antenna elements 913 routed to FEM 933 are aligned along the x-axis at a different x-coordinate. In addition, the two dual port antenna elements 913 coupled to the TX1/RX1 ports of the FEMs 922, 933 are aligned along the y-axis and the two antenna elements coupled to the TX2/RX2 ports of the FEMs 922, 933 are aligned along the y-axis at a different y-coordinate. FIG. 9E also includes indications of x-y positions (e.g., x1, y1) for each of the dual port antenna elements 913.

FIG. 9F illustrates an additional rectangular configuration 950 where RFIO ports 925 of a first FEM 922 and a second FEM 933 are combined with a power combiner/divider 928 (e.g., a −3 dB Wilkinson combiner/divider) to form a four-element rectangular sub-array (e.g., a 2×2 array of antenna elements). As illustrated, the two dual port antenna elements 913 routed to FEM 922 are aligned along the x-axis and the two dual port antenna elements 913 routed to FEM 933 are aligned along the x-axis at a different y-coordinate. As illustrated, the dual port antenna element 913 coupled to the TX1/RX1 port of the FEM 922 is aligned along the y-axis to the antenna element coupled to the TX2/RX2 port of the FEM 933. In addition, the dual port antenna element 913 coupled to the TX2/RX2 port of the FEM 922 is aligned along the y-axis to the antenna element coupled to the TX1/RX1 port of the FEM 933 at a different x-coordinate. FIG. 9F also includes indications of x-y positions (e.g., x1, y1) for each of the dual port antenna elements 913.

FIG. 9G illustrates a rotated rectangular configuration 960 that is similar to the calibration configuration of FIG. 9E except that the arrangement of the 2×2 array of antenna elements shown in FIG. 9E is rotated by 90-degrees relative to x-y axis of the antenna lattice. Similarly, FIG. 9H illustrates an additional rotated calibration configuration 970 that is similar to the calibration configuration of FIG. 9F except that the arrangement of the 2×2 array of antenna elements shown in FIG. 9F is rotated by 90-degrees relative to x-y axis of the antenna lattice.

FIG. 9I illustrates an example calibration configuration 980 for calibrating a rectangular array of antenna elements that includes four rows and four columns (e.g., a 4×4 array of antenna elements). In the illustrated example of FIG. 9I, the 4×4 array of antenna elements can include a first 2×2 array of antenna elements 982, a second 2×2 array of antenna elements 984, a third 2×2 array of antenna elements 986, and a fourth 2×2 array of antenna elements 988. In the illustrated example of FIG. 9I, the 2×2 sub-arrays of antenna elements 982, 984 are similar to the topology shown in the rectangular configuration 940 of FIG. 9E and the 2×2 sub-arrays of antenna elements 986, 988 are similar to the topology of FIG. 9E with 180 deg rotation around the x-y axis of the antenna lattice. The calibration configuration 980 of FIG. 9I is provided for the purposes of illustration and other configurations may be used without departing from the scope of the present disclosure. In some implementations, the example calibration configuration 980 of FIG. 9I can provide variation of antenna element configuration in a region of interest such that internal symmetries in the FEMs 922, 933 and the power combiner/dividers 928 can provide additional redundancies to achieve a full 2D calibration of antenna elements in a phased array antenna.

As illustrated in FIG. 9I, a parameter D₁ can be defined as the expected value of the ratio of complex RF gain of the TX1 port of FEM 922 and the TX1 port of FEM 933. Similarly, a parameter D₂ can be defined as the expected value of the ratio of complex RF gain of the TX2 port of FEM 922 and the TX2 port of FEM 933. As used herein, the complex RF gain of a TX port is defined as the RF gain between combiner/divider 928 and the output of the respective TX port (e.g., the output of a PA coupled to the TX port).

In some implementations, combiner/divider 928 can be symmetric and provided with phase matched routing from combiner/divider 928 to the RFIO port 925 of both FEM 922 and FEM 933. In such an example, D₁≈1 and D₂≈1 assuming the FEMs 922, 933 are included in FEM chips with the same physical design. In some cases, the approximate equalities D₁≈1 and D₂≈1 can result from complex gain variation of a given FEM design from one physical FEM chip/sample to another.

Referring to FIG. 9I, a parameter Δ₁₂ can be defined as the expected value of the ratio of complex RF gain of the TX1 port to the RF gain of the TX2 port of a given FEM 922, 933. In some implementations, the expected value of Δ₁₂ can be different from one (e.g., Δ₁₂≠1) due to an inherent asymmetry of RF path of the TX1 port and the RF path of the TX2 port inside the FEMs 922, 933 (e.g., an asymmetry in the physical design of the FEM chip). Although the parameters D₁, D₂, Δ₁₂ are described for the RF paths of TX ports above, the parameters D₁, D₂, Δ₁₂ can also be defined for RF paths of RX ports without any loss of generality. Equation (19) through Equation (21) below include mathematical descriptions of the parameters Δ₁₂, D₁, and D₂, respectively:

$${Δ}_{12} \approx \frac{G ( {IO}_{1} , {a}_{1} )}{G ( {IO}_{1} , {a}_{2} )} \approx \frac{G ( {IO}_{1} , {b}_{1} )}{G ( {IO}_{1} , {b}_{2} )} \approx \frac{G ( {IO}_{2} , {a}_{1} )}{G ( {IO}_{2} , {a}_{2} )} \approx \frac{G ( {IO}_{3} , {b}_{1} )}{G ( {IO}_{3} , {b}_{2} )} \approx ⋯ \qquad ( 19 )$$

$${D}_{1} \approx \frac{G ( {IO}_{1} , {a}_{1} )}{G ( {IO}_{1} , {b}_{2} )} \approx \frac{G ( {IO}_{2} , {a}_{1} )}{G ( {IO}_{2} , {b}_{1} )} \approx \frac{G ( {IO}_{3} , {a}_{1} )}{G ( {IO}_{3} , {b}_{1} )} \approx \frac{G ( {IO}_{4} , {a}_{1} )}{G ( {IO}_{4} , {b}_{1} )} \approx 1 \qquad ( 20 )$$

$${D}_{2} \approx \frac{G ( {IO}_{1} , {a}_{2} )}{G ( {IO}_{1} , {b}_{2} )} \approx \frac{G ( {IO}_{2} , {a}_{2} )}{G ( {IO}_{2} , {b}_{2} )} \approx \frac{G ( {IO}_{3} , {a}_{2} )}{G ( {IO}_{3} , {b}_{2} )} \approx \frac{G ( {IO}_{4} , {a}_{2} )}{G ( {IO}_{4} , {b}_{2} )} \approx 1 \qquad ( 21 )$$

Where IOₘ refers to the specific RFIO number of a given BF RFIO 905 (e.g., RFIO-1, RFIO-2, RFIO-3, RFIO-4), a; is the identifier of the i^{th} TX (or RX) port of FEM 922, and bⱼ is the identifier of the j^{th} TX (or RX) port of FEM 933. The parameter D₁ can have a standard deviation σ_{D1}, parameter D₂ can have a standard deviation σ_{D2} and parameter Δ₁₂ can have a standard deviation σ_{Δ12}. In some cases, the standard deviation for each parameter D₁, D₂, Δ₁₂ can depend on the complexity (e.g., number of stages, filters, phase shifters, etc.) of the RF signal path inside the FEM 922, 933 chip, fabrication variations, and/or assembly process variations.

In some cases, the parameter D₁, D₂, and/or Δ₁₂ can be utilized as internal references and therefore provide extra redundancy for OTA measurements during calibration. In some cases, the relative standard deviation of the parameters D₁, D₂, and/or Δ₁₂ can be used to determine which one to use during calibration of a particular phased array antenna. For example, using the parameter D₁, D₂, and/or Δ₁₂ with the lowest standard deviation can result in the most reliable calibration upon completion of a calibration procedure.

FIG. 10A illustrates an example calibration configuration 1000 for calibrating antenna elements in a 2D phased array antenna. For simplicity of illustration, the two separate paths connecting the TX port and RX port of a FEM to two separate ports of an antenna element are combined to single TX/RX port. However, the configurations shown in FIG. 10A through FIG. 10E, FIG. 11A, FIG. 11B, and FIG. 12 should be understood as referring to type of FEMs (e.g., FEMs 922, 933), antenna elements (e.g., antenna elements 913), and connections between FEMs and antenna elements illustrated in the example calibration configurations shown in FIG. 9A through FIG. 9I. In the example of FIG. 10A, the antenna elements 1013 connected to a given FEM 1022, 1033 are aligned along the y-axis. In addition, FEMs 1022, 1033 that are coupled to the same power combiner divider (e.g., combiner/divider 928 of FIG. 9C through FIG. 9I) and BF RFIO 1005 are aligned along the x-axis.

FIG. 10B illustrates a calibration configuration 1020 for calibrating rows of antenna elements in the calibration configuration 1000 of FIG. 10A. As shown in FIG. 10B, antenna elements 1013 (e.g., antenna elements a, b, c, d, e, f, g, h) are transmitting calibration signals (e.g., in a TX/mTX mode) and antenna elements 1014 (e.g., antenna elements (1, 2, 3, 4, 5, 6, 7, 8) are receiving the calibration signals (e.g., in an RX/mRX mode). As illustrated, the OTA path from antenna element a to antenna element 1 has a complex coupling parameter S₂ and the OTA path from antenna element b to antenna element 1 has a complex coupling parameter S₁. In some cases, the complex coupling parameters S₁, S₂ can be identical for pairs of antenna adjacent antenna elements with a translation along x-axis of the antenna lattice by an integer multiple of the x-axis antenna element spacing. For example, the OTA path from antenna element c to antenna element 3 has a complex coupling parameter S₂ and the OTA path from antenna element d to antenna element 3 has a complex coupling parameter S₁. A similar relationship between complex coupling parameters S₁, S₂ can be expected for any triple of antennas (e.g., antenna elements e, f, 5) with the same relative geometry. In some cases, complex measured values M(1a) and M(1b) can be generated from mutual coupling measurements performed between transmitting antenna elements a, b and receiving antenna element 1. Equation (22) illustrates the ratio of complex measured values M(1a) and M(1b) as shown below:

$$\frac{M ( 1 a )}{M ( 1 b )} = \frac{{S}_{2}}{{S}_{1}} \frac{{X}_{a} {e}^{j {θ}_{a}}}{{X}_{b} {e}^{j {θ}_{b}}} \approx \frac{{S}_{2}}{{S}_{1}} \qquad ( 22 )$$

$${D}_{1} \approx \frac{{S}_{2}}{{S}_{1}}$$

Similarly, complex measured values can be generated from mutual coupling measurements performed for corresponding antenna elements in the other 2×2 antenna element arrays in FIG. 10B, resulting in similar relationship, as shown in Equation (22) below:

$$\frac{M ( 1 a )}{M ( 1 b )} \approx \frac{M ( 3 c )}{M ( 3 d )} \approx \frac{M ( 5 e )}{M ( 5 f )} \approx \frac{M ( 7 g )}{M ( 7 h )} \approx \frac{{S}_{2}}{{S}_{1}} \qquad ( 23 )$$

Equation (23) illustrates that multiple mutual coupling measurements can be performed in the calibration configuration 1020 and an estimate (e.g., a best fit, least squares, etc.) for ratio S₂/S₁ can be determined. In some cases, the estimate of ratio S₂/S₁ can be directly used to align all of the antenna elements that are neighbors along the x-axis (e.g., antenna elements b, c), including the ones that are used for mutual coupling measurements (e.g., antenna element a, b) as shown in Equation (24):

$$\frac{M ( 2 b )}{M ( 2 c )} = \frac{{S}_{2}}{{S}_{1}} \frac{{X}_{b} {e}^{j {θ}_{b}}}{{X}_{c} {e}^{j {θ}_{c}}} ⟹ \frac{M ( 2 b ) {S}_{1}}{M ( 2 c ) {S}_{2}} = \frac{{X}_{b} {e}^{j {θ}_{b}}}{{X}_{c} {e}^{j {θ}_{c}}} \qquad ( 24 )$$

It should be understood that left side of Equation (24) represents a complex numerical value because the mutual coupling measurements can be captured as complex numerical values and the estimated ratio S₁/S₂ can be determined as a complex numerical value. Accordingly, the right side of Equation (24) can provide a complex compensation factor to calibrate antenna b and antenna c relative to one another. As noted above, the estimated ratio S₁/S₂ can be determined from a best fit to multiple measurement pairs from Equation (23), which can provide a more accurate value for the ratio S₁/S₂ than a single measurement pair. As a result, Equation (24) can also be used to calibrate antenna element pairs that are already assumed to be calibrated due to the similarity in FEMs (e.g., antenna element pair (a, b), (c, d), (e, f), or (g, h)). Accordingly, all of the antenna elements in a row of antenna elements (e.g., antenna elements a, b, c, d, e, f, g, h) can be calibrated relative to one another using Equation (24).

FIG. 10C illustrates a calibration outcome 1040 that corresponds to the calibration measurements described with respect to FIG. 10B and Equation (23) through Equation (24). As illustrated, each row of antenna elements in the calibration outcome 1040 can include antenna elements that are calibrated with respect to each other as indicated by antenna elements with the same shading. However, as illustrated in FIG. 9C, while antenna elements in each individual row are calibrated relative to one another, antenna elements in different rows may not be calibrated relative to one another.

FIG. 10D illustrates a calibration configuration 1060 for calibrated columns of antenna elements in the example calibration configuration of FIG. 10A. As shown in FIG. 10D, the calibration configuration 1060 utilizes the parameter Δ₁₂ to calibrate columns of antenna elements relative to one another. As illustrated, target OTA paths to be estimated are shown between antenna elements q, r, s, t, u, v, x transmitting calibration signals (e.g., in a TX/mTX mode) and antenna elements 9, 10, 11,12, 13, 14, 15, 16 receiving calibration signals (e.g., in an RX/mRX mode). As illustrated, an antenna element r can transmit calibration signals that are received by antenna elements 9, 10 over OTA paths that have complex coupling parameters S₄ and S₃, respectively. In some cases, complex measured values e.g., (M(9r) and M(10r)) can be generated from mutual coupling measurements performed between transmitting antenna elements r and receiving antenna elements 9, 10 as shown in Equation (25):

$$\frac{M ( 9 r )}{M ( 10 r )} = \frac{{S}_{4}}{{S}_{3}} \frac{{X}_{9} {e}^{j {θ}_{9}}}{{X}_{10} {e}^{j {θ}_{10}}} \approx \frac{{S}_{4}}{{S}_{3}} {Δ}_{12} \qquad ( 25 )$$

In addition, an antenna t can transmit calibration signals that are received by antenna elements 11, 12 over OTA paths that have complex coupling parameters S₄ and S₃, respectively. It should be noted that the FEMs coupled to antenna elements t, 11, and 12 can be rotated by 180 degrees relative to the antenna elements r, 9, and 10. As a result of the 180 degree rotation, the relationship between complex coupling parameters S₄ and S₃ and the parameter Δ₁₂ can be inverted as illustrated in Equation (26) below:

$$\frac{M ( 11 t )}{M ( 12 t )} = \frac{{S}_{4}}{{S}_{3}} \frac{{X}_{11} {e}^{j {θ}_{11}}}{{X}_{12} {e}^{j {θ}_{12}}} \approx \frac{{S}_{4}}{{S}_{3}} \frac{1}{{Δ}_{12}} \qquad ( 26 )$$

Equation (27) below illustrates an estimate for the ratio

$$\frac{{S}_{4}}{{S}_{3}}$$

combining Equation (25) and (Equation 26):

$$\sqrt{\frac{M ( 9 r )}{M ( 10 r )} \frac{M ( 11 t )}{M ( 12 t )}} \approx \sqrt{\frac{M ( 13 v )}{M ( 14 v )} \frac{M ( 15 x )}{M ( 16 x )}} \approx \pm \frac{{S}_{4}}{{S}_{3}} \qquad ( 27 )$$

As shown, Equation (27) provides an estimate for S₄/S₃ that includes a ±ambiguity. In some cases, the ± ambiguity can be removed using same or similar procedures with respect to resolving the ± ambiguity in Equation (8) as described in the section of the present disclosure entitled “RESOLVING AMBIGUITY IN CALIBRATION SOLUTIONS.”

FIG. 10E illustrates a calibration outcome 1080 that corresponds to the calibration measurements described with respect to FIG. 10D and Equation (25) through Equation (27). As illustrated, each column of antenna elements in the calibration outcome 1080 can include antenna elements that are calibrated with respect to each other as indicated by antenna elements with the same shading.

In some cases, once the ambiguity is resolved, any neighboring antenna pair along a column (e.g., along the y-axis of FIG. 10E) can be calibrated relative to one another to obtain calibrated columns of antennas. In some cases, the calibration of columns of antenna elements can be combined with the calibration of rows of antennas described with respect to FIG. 10C to obtain a fully calibrated 2D antenna array.

In some implementations, parameters D₁ and/or D₂ can be used obtain direct estimates for the ratio S₄/S₃. For example, FIG. 11A illustrates an additional example calibration configuration 1100 for calibrating antenna elements in a 2D phased array antenna. In the example of FIG. 11A, a first 4×4 sub-array of antenna elements 1182 includes four identical 2×2 sub-arrays of antenna elements. In the 4×4 sub-array of antenna elements 1182, four antenna elements located at x-y positions (x₁, y₇), (x₂, y₇), (x₁, y₈), and (x₂, y₈) can correspond to a 2×2 rectangular antenna element array shown in rotated rectangular configuration 960 of FIG. 9G. Similarly, four antenna elements located at x-y positions (x₃, y₇), (x₄, y₇), (x₃, y₈), and (x₄, y₈) can correspond to a 2×2 rectangular antenna element array shown in rotated rectangular configuration 960 of FIG. 9G. As illustrated, the 4×4 sub-array of antenna elements 1182 also includes four antenna elements located at x-y positions (x₁, y₅), (x₂, y₅), (x₁, y₆), and (x₂, y₆) can correspond to a 2×2 rectangular antenna element array shown in rotated rectangular configuration 960 of FIG. 9G mirrored over the x-axis. Similarly, four antenna elements located at x-y positions (x₃, y₅), (x₄, y₅), (x₃, y₆), and (x₄, y₆) can correspond to a 2×2 rectangular antenna element array shown in rotated rectangular configuration 960 of FIG. 9G mirrored over the x-axis. As illustrated, the 4×4 sub-array of antenna elements 1188 can be configured with an identical geometry to the 4×4 sub-array of antenna elements 1182. However, as illustrated in FIG. 11A, 4×4 arrays of antenna elements 1184, 1186 and corresponding FEMs and/or power dividers are rotated by 90 degrees relative to the 4×4 arrays of antenna elements 1182, 1188.

As noted above with respect to FIG. 10A, the exact orientation of FEMs and/or power dividers can be varied without departing from the scope of the present disclosure. For example, the arrangement of FEMs and/or power dividers can be varied as long as the procedure for estimating OTA complex coupling parameter ratios (e.g., S₄/S₃ or S₂/S₁) depends on the parameter 412 and either parameter D₁or parameter D₂. In some cases, capturing OTA complex coupling patterns in an antenna array that is configured such that measurements of physically interchangeable OTA paths (e.g., translated by an integer multiple of antenna spacing) depend on two different parameters 412 and D₁or D₂ ensures both ratio S₄/S₃ and ratio S₂/S₁ can be estimated by using D₁ (or D₂) without any ambiguity and further estimated using parameter Δ₁₂ without any ambiguity.

FIG. 11B illustrates an example calibration configuration 1150 utilizing a calibration approach that depends on two parameters as described with respect to FIG. 11A. As illustrated in FIG. 11B, measurements inside the 4×4 sub-array of antenna elements 1182 of signals transmitted from antenna elements 1113 with y-position y₈ and received at antenna elements 1114 with y-position y₆ can be used to estimate the ratio S₂/S₁ based on parameter D₁ and calibrate the antenna elements with y-position y₈ in the 4×4 sub-array of antenna elements 1182 relative to one another. As illustrated, measurements inside 4×4 sub-array of antenna elements 1186 of signals transmitted from antenna elements with x-position x₄ and received at antenna elements 1124 with x-position X₂ can be used to estimate the ratio S₄/S₃ based on parameter D₁ and calibrate the antenna elements 1123 with x-position x₄ in the 4×4 sub-array of antenna elements 1186 relative to one another. Therefore, ratio S₄/S₃ and ratio S₂/S₁ both can be estimated relying only parameter D₁ and an expression similar to Equation (23).

In some cases, ratio S₄/S₃ and ratio S₂/S₁ may also both be estimated based on parameter 412. For example, additional measurements inside the 4×4 sub-array of antenna elements 1182 of signals transmitted from antenna elements with x-position x₃ and received at antenna elements with x-position x₂ can be used to estimate the ratio S₄/S₃ based on parameter Δ₁₂ and calibrate the antenna elements 1123 with x-position x₃ in the 4×4 sub-array of antenna elements 1182 relative to one another. Similarly, additional measurements inside the 4×4 sub-array of antenna elements 1186 of signals transmitted from antenna elements with y-position y₃ and received at antenna elements with y-position y₂ can be used to estimate the ratio S₂/S₁ based on parameter Δ₁₂ and calibrate the antenna elements with y-position y₃ in the 4×4 sub-array of antenna elements 1186 relative to one another. In some cases, the additional measurements for estimating the ratio S₂/S₁ and the ratio S₄/S₃ can be used to improve the accuracy of the estimates for the ratio S₂/S₁ and the ratio S₄/S₃.

While the example of FIG. 11B describes calibrating antennas along rows and/or columns of antenna elements in the antenna lattice of a phased array antenna using Δ₁₂ and D₁ (or D₂). It should be understood that one parameter can be preferred over the other in determining estimates for the ratio S₂/S₁ and the ratio S₄/S₃. For example, the estimates of estimates for the ratio S₂/S₁ and the ratio S₄/S₃ leading to 2D array calibration can depend more heavily on a preferred parameter. For example, parameter Δ₁₂ depends on RF paths that are internal to a single physical FEM chip, while parameter D₁ or D₂ depend on the similarity between two physically different FEM chips with an identical design. In one illustrative example, if fabrication process variations (e.g., typical vs a fast corner case) from FEM chip to FEM chip is large such that σ_{Δ12}<<σ_{D1} and σ_{Δ12}<<σ_{D2}, then parameter Δ₁₂ can be preferred. In some cases, a non-preferred parameter, such as D₁ or D₂ in the illustrative example above, can be used to remove 180-degree ambiguity in solutions determined using the preferred parameter.

It should be understood that Equation (23) through Equation (27), and the calibration configurations they refer to, have been described as if local measurements are captured and then Equation (23) through Equation (27) are solved for those measurements to calibrate two antenna elements at a time, and then the process is repeated sequentially to calibrate the full 2D antenna array. However, the calibration examples above are provided for the purposes of clearly illustrating the process of measuring OTA complex coupling parameters and the physical redundancies used for calibration. In some cases, calibration configurations that differ from the examples described herein can be used without departing from the scope of the present disclosure. For example, all possible measurements between any pair of antenna elements that could be used in a sequential approach and the calculations illustrated in Equations (1) through Equation (13) can be organized as a set of linear equations to be solved with a convenient mathematical approach (e.g., least squares). In some examples, hundreds or thousands of linear equations can be solved simultaneously. The exact way of solving this larger set of equations may depend on the accuracy needed and the computational resources and/or time available during the functional phased array operation and is outside the scope of the present disclosure.

### Calibration of Antenna Elements at Antenna Lattice Edge

In the examples of FIG. 4A through FIG. 11B, periodic repeatability of the relationship between OTA paths across the antenna lattice (e.g., antenna lattice 202 of FIG. 2A) has been used to generate and/or simplify equations for calibrating antenna elements of the antenna lattice. For example, the measured ratio S₂/S₁ should be identical (subject to limitations resulting from finite array size and/or manufacturing accuracy) at a given location (x, y) and at any other location (x+N(x₀), y+M (y₀)) location, where M & N are integers and x₀ & y₀ are distances between periodic antenna elements along x-axis and y-axis, respectively. In some cases, antenna elements (e.g., antenna elements 213 of FIG. 2A) that are located around the edge of the antenna lattice (e.g., antenna lattice 202 of FIG. 2A) may not exhibit the same repeatability of the relationship between OTA paths. For example, repeatability of the relationship between OTA paths can be broken around the edges of an antenna lattice if there are no extra/dummy antenna elements (with terminations identical to functional antenna elements) around the active antenna lattice to prevent abrupt changes in the mutual coupling environment for the functional antennas.

In some cases, omitting extra/dummy antenna elements can be done intentionally to save space and weight of the antenna system, but can degrade the calibration accuracy of the antenna elements at the very edge. Accordingly, systems and techniques are needed for improving calibration accuracy of edge antenna elements. The systems and techniques described herein may use internal redundancies (e.g., parameters D₁, D₂, and/or 412) of sub-arrays of antenna elements (e.g., as illustrated in FIG. 9A through FIG. 9I) without relying on the OTA mutual coupling measurements around the antenna lattice edge.

FIG. 12 illustrates an example edge antenna element calibration configuration 1200. In the illustrative example of FIG. 12, sub-arrays of antenna elements formed by power dividers 1228 and FEMs (e.g., FEM 1212, FEM 1214, FEM 1222) with shared BF RFIOs 1205 have different orientations at the array edge (e.g., sub-arrays of antenna elements 1210) compared to the orientation of sub-arrays of antenna elements across the rest of the antenna lattice (e.g., sub-arrays of antenna elements 1220). As illustrated in FIG. 12, complex coupling parameter ratio S₅/S₆ can be estimated using antenna elements that are at least N antenna elements away from the edge of the antenna array, where N is an integer. As used herein, the term “edge antenna elements” hereinafter refers to antenna elements that are N or fewer antenna elements away from the edge of the antenna array. As illustrated in FIG. 12, a value of N=4 such that the first four edge antenna elements 1213 (e.g., edge antenna elements 1232, 1234, 1236, 1238) from the antenna lattice edge 1250 are excluded from the measurements for estimating the complex coupling parameter ratio S₅/S₆. As illustrated, the ratio S₅/S₆ can then be used to calibrate the edge antenna element 1232 (also referred to as edge antenna element 1) relative to non-edge antenna elements 2, 3, 4, 5 using calibration techniques similar to the techniques described with respect to FIG. 10A through FIG. 10E and Equation (23) through Equation (27).

In some cases, after the edge antenna element 1 has been calibrated relative to the non-edge antenna elements 1240 (also referred to as non-edge antenna elements 2, 3, 4, 5) the edge antenna element 1234 (also referred to as edge antenna element 0) can be calibrated relative to edge antenna element 1 by directly using an estimate of the parameter Δ₁₂. As noted above, the parameter Δ₁₂ can represent a complex gain relationship between an antenna element coupled to a TX/RX 1 port of a FEM and an antenna element coupled to a TX/RX 2 port of the same FEM. In some cases, after antenna element 0 and antenna element 1 are calibrated, edge antenna element 1238 (also referred to as edge antenna element −2) and edge antenna element 1236 (also referred to as edge antenna element −1) can be directly assumed to have same magnitude and phase to antenna 0 and 1 respectively since D₁≈1 and D₂≈1. In some cases, the parameter Δ₁₂ can be estimated by dividing Equation (25) by Equation (26) and taking a square root (e.g., instead of multiplying to obtain Equation (27). In some cases, the square root term can in turn provide measured estimates of ±412 at multiple locations. As illustrated in FIG. 12, non-edge measurement antenna elements 1223 (also referred to as non-edge measurement antenna elements a, b, c, d) can be used during OTA mutual coupling measurements. While the illustrative example of FIG. 12 uses a value of N=4, it should be understood that other values for N such as N=2, N=3, or N>4 can be used without departing from the scope of the present disclosure. In some cases, a value for N can be selected based on, without limitation, the types of antenna elements being used and/or the sensitivity of the antenna elements to array edge effects.

In some cases, the example edge antenna element calibration configuration 1200 of FIG. 12 can be modified as long as OTA mutual coupling measurements are limited to antennas that are N elements away from the antenna lattice edge 1250. It should be understood that using the approach described with respect to FIG. 12 when a standard deviation of one or more of the parameters D₁, D₂, and Δ₁₂ is greater than the variation in coupling of OTA coupling paths in different parts of the antenna lattice (e.g., variation of S₅/S₆) around the active antenna lattice edge, the calibration procedure described with respect to FIG. 12 may not be able to improve the relative calibration of the edge antenna elements. In such an example, the approach described with respect to FIG. 10A through FIG. 10E and Equations (23) through Equation (27) can be followed across the full array of antenna elements uniformly, without making any exceptions for edge antenna elements as illustrated in FIG. 12.

### Calibration of Antenna Elements on Different Printed Circuit Boards

In some cases, antenna lattices for phased array antenna systems may become large enough such that antenna elements of the antenna lattice (e.g., antenna lattice 202 of FIG. 2A) have to be distributed across multiple structures (e.g., multiple standard sized PCBs) each housing a subset of the antenna elements of the antenna lattice. In some implementations, discontinuities in the antenna lattice across the multiple PCBs can be severe enough to make the self-calibration approaches relying on OTA coupling path similarities unusable. Accordingly, systems and techniques are needed for providing self-calibration in phased array antenna systems with antenna elements of an antenna lattice distributed across multiple PCBs. FIG. 13A through FIG. 13C illustrate calibration configurations utilizing one or more calibration lines across different PCBs (e.g., PCB tiles) of a phased array antenna system. In some cases, the one or more calibration lines can be used to calibrate antenna elements on each different PCB tile with respect to each other without relying on OTA paths between the PCB tiles.

FIG. 13A illustrates an example antenna lattice configuration 1300 for performing OTA calibration measurements for a phased array antenna system with antenna elements distributed on different PCBs. In the example antenna lattice configuration 1300 of FIG. 13A, three different PCB tiles 1311, 1312, 1313 containing antenna elements of the antenna lattice are separated by gaps 1325. As illustrated in FIG. 13A, PCB tile 1311 houses the antenna elements 1301, PCB tile 1312 houses the antenna elements 1302 and PCB tile 1313 houses the antenna elements 1303. As illustrated, all of the antenna elements 1301, 1302, 1303 can be part of the same antenna lattice (e.g., antenna lattice 202 of FIG. 2A) such that their x-y positions align with a periodic antenna lattice. In some implementations, the antenna elements on a particular PCB can be calibrated relative to one another using the Equation (1) through Equation (14) and/or Equation (15) through Equation (27). For example, antenna elements having dual-use antenna ports can be calibrated using Equation (1) through Equation (14). In some cases, antenna elements without dual-use antenna ports (e.g., dedicated ports for TX mode and RX mode) can be calibrated using Equation (15) through Equation (27). After calibration is performed for antenna elements on each PCB, the antenna elements 1301 can be calibrated relative to one another, the antenna elements 1302 can be calibrated relative to one another, and the antenna elements 1303 can be calibrated relative to one another as indicated by common shadings of all antenna elements on a particular PCB. However, as illustrated in FIG. 13B, each PCB tile 1311, 1312, 1313 and corresponding antenna elements may have different relative calibrations.

As noted above, the OTA coupling paths going across the gap 1325 may not be suitable for resolving the relative calibration differences between antenna elements on different PCB tiles 1311, 1312, 1312. For example, the complex coupling parameters related to the OTA paths among a group of four antenna elements that are all on a single PCB tile 1311, 1312, 1313, can include complex coupling parameters C₁, C₂, C₃, C₄ as shown in FIG. 13A and FIG. 13B. In some cases, antenna elements located at x-y positions of the antenna lattice near the PCB edges can form four antenna element groups that include OTA paths that cross a gap 1325 between two PCB tiles. For example, antenna element 1321 can be part of a four antenna element group with antenna elements 1322 that includes OTA paths that cross over the gap 1325 between PCB tile 1311 and PCB tile 1312. As illustrated, the complex coupling parameters related to the two OTA paths over the gap 1325 can include complex coupling parameters Cₑ₁, Cₑ₂, indicating an identical geometry to the complex coupling parameters C₁, C₂. In some cases, if the gap 1325 is large enough to alter mutual coupling values, the complex coupling parameters can be altered such that C₁≠Cₑ₁ and C₂≠Cₑ₂. To the extent that a self-calibration procedure relies on OTA coupling path similarities, the discontinuity introduced by the gaps 1325 may prevent accurate calibration results across PCB tiles 1311, 1312, 1313.

FIG. 13B illustrates an example calibration configuration 1320 that can be used to calibrate the antenna elements in the antenna lattice configuration 1300 of FIG. 13A across the PCB tiles 1311, 1312, 1313. As illustrated, one or more calibration lines 1334 can be formed across all of the PCB tiles by internal (e.g., to the PCB structure) transmission lines (TLs) 1345 and jumper transmission lines 1338. In some examples, the jumper transmission lines 1338 can be external to the PCB tiles 1311, 1312, 1313. In the illustrated example of FIG. 13B, connection points 1335, 1336 of the internal TLs 1345 can be coupled to measurement ports (e.g., mRX/mTX). In addition, the internal TLs 1345 can be coupled (e.g., by a weak coupler) to antenna elements and the measurement ports can be used to calibrate the antenna elements along the calibration line. For example, antenna elements 1351, 1352, 1353 on PCB tiles 1311, 1312, 1313 can all be measured by some or all of the measurement ports coupled to the connection points 1335, 1336. In some cases, the measurements taken using the one or more calibration lines 1334 can be used to calibrate antenna elements 1351, 1352, 1353 relative to one another. After calibration using the one or more calibration lines 1334, a magnitude/phase relationship between the antenna elements across all of the PCB tiles can be formed and full calibration of the antenna elements of the antenna lattice can be achieved.

As noted above, all of the antenna elements 1351 may have been previously calibrated relative to the remaining antenna elements 1301 on PCB tile 1311. Similarly, antenna elements 1352, 1302 may have been calibrated relative to one another and/or antenna elements 1353, 1303 may have been calibrated relative to one another. As a result, the calibration provided by the calibration lines does not need to be very accurate on an antenna element to antenna element basis. For example, the calibration lines 1334 may be used to align antenna elements on different PCB tiles e.g., antenna elements 1351, 1352 antenna elements 1352, 1353, and/or antenna elements 1351, 1353) relative to one another on an “average” sense. In some examples, the calibration of antenna element groups on different PCB tiles can be used to calibration the PCB. In some cases, performing calibration on an average sense among groups of antenna elements on PCBs may compensate for reductions in accuracy of calibration measurements that can result from disruption of the periodic calibration line sections by jumper transmission lines 1338, 1339.

FIG. 13C illustrates an additional example calibration configuration 1340 for 2D calibration of an antenna lattice distributed across six PCB tiles in a 2×3 tile arrangement. As illustrated, separate calibration lines 1334 and jumper transmission lines 1338 extending horizontally and calibrations lines 1337 and jumper transmission lines 1339 extending vertically can be used to calibrate antenna elements of PCB tiles relative to one another to get a full 2D alignment among all of the antenna elements of the antenna lattice.

FIG. 14 illustrates a cross section 1400 of a row of antenna elements 1451, 1452 along a calibration line 1434 (e.g., calibration line 1334 of FIG. 13B) between different PCBs of a phased array antenna system. As illustrated in FIG. 14, FEM and/or beamformer chips 1422, 1423 on different PCB tiles 1411, 1412 are coupling to the calibration line 1434 via couplers 1424. In the illustrated example, the calibration line 1434 is formed by internal TLs 1445, a connector 1442, and an RF cable 1438. In some implementations the FEM and/or beamformer chips 1422, 1423 can perform measurements on the antenna elements 1451 of PCB tile 1411 and antenna elements 1452 of PCB tile 1412 and can determine relative phase/magnitude relationships between all of the antenna elements 1451, 1452. In turn, the determined phase/magnitude relationships can be used to calibrate the antenna elements 1451 as a group against antenna elements 1452 as a group, which can in turn be used to obtain relative calibration between all of the antenna elements on PCB tile 1411 and all of the antenna elements on PCB tile 1412.

FIG. 15 is a flow diagram illustrating a process 1500 for over-the-air (OTA) calibration of antenna elements for a phased array antenna system.

At block 1502, the process 1500 includes performing a first relative calibration of complex gains of a first plurality of periodically spaced antenna elements of an antenna lattice based on OTA calibration measurements to obtain a calibrated first plurality of periodically spaced antenna elements.

At block 1504, the process 1500 includes performing a second relative calibration of complex gains of a second plurality of periodically spaced antenna elements of the antenna lattice based on OTA calibration measurements.

At block 1506, the process 1500 includes performing a third relative calibration of complex gains of a first subset of antenna elements of the first plurality of periodically spaced antenna elements and a second subset of antenna elements of the second plurality of periodically spaced antenna elements based on in-line calibration measurements of coupling between a calibration line and respective antenna elements of the first subset of antenna elements and the second subset of antenna elements to obtain a relative calibration.

At block 1508, the process 1500 calibrating complex gains of the first plurality of periodically spaced antenna elements and the second plurality of periodically spaced antenna elements based on the relative calibration.

In some cases, a first carrier comprises the first plurality of periodically spaced antenna elements and a second carrier comprises the second plurality of periodically spaced antenna elements. In some examples, the antenna lattice is disrupted by a gap between the first carrier and the second carrier. In some implementations, the calibration line is connected across the gap between the first carrier and the second carrier.

In some cases, a first calibration measurement port on the first carrier is coupled to the calibration line and a second calibration measurement port on the second carrier is coupled to the calibration line.

In some examples, each antenna element of the first plurality of periodically spaced antenna elements and each antenna element of the second plurality of periodically spaced antenna elements comprises a respective dedicated transmit port and a respective dedicated receive port.

In some implementations, each antenna element of the first plurality of periodically spaced antenna elements and each antenna element of the second plurality of periodically spaced antenna elements comprises a respective dual linearly polarized antenna port coupled to a respective −3 dB 90-degree hybrid coupler, wherein each respective dedicated transmit port comprises a first circularly polarized port of the −3 dB 90-degree hybrid coupler and each respective dedicated receive port comprises a second circularly polarized port of the −3 dB 90-degree hybrid coupler.

In some implementations, a third plurality of periodically spaced antenna elements included in the antenna lattice and coupled to a third carrier. In some cases, complex gains of the third plurality of periodically spaced antenna elements are calibrated based on OTA calibration measurements. In some examples, a fourth plurality of periodically spaced antenna elements included in the antenna lattice and coupled to a fourth carrier. In some implementations, complex gains of the third plurality of periodically spaced antenna elements are calibrated based on OTA calibration measurements. In some cases, the calibration line and one or more additional calibration lines are configured to obtain relative calibration measurements of respective subsets of the first, second, third, and fourth plurality of periodically spaced antenna elements and one or more calibration components are configured to calibrate complex gain between antenna elements of the first plurality of periodically spaced antenna elements, the second plurality of periodically spaced antenna elements, the third plurality of periodically spaced antenna elements, and the fourth plurality of periodically spaced antenna elements based on in-line calibration measurements between the respective subsets of the first, second, third, and fourth plurality of periodically spaced antenna elements and a plurality of calibration lines, wherein the plurality of calibration lines includes the calibration line and the one or more additional calibration lines.

In some examples, a third carrier comprises the third plurality of periodically spaced antenna elements and a fourth carrier comprises the fourth plurality of periodically spaced antenna elements and the first carrier, the second carrier, the third carrier, and the fourth carrier comprise, respectively, a first PCB, a second PCB, a third PCB, and a fourth PCB arranged in a rectangular lattice.

In some cases, periodicity of the antenna lattice is disrupted between the first plurality of periodically spaced antenna elements and the second plurality of periodically spaced antenna elements, periodicity of the antenna lattice is disrupted between the first plurality of periodically spaced antenna elements and the third plurality of periodically spaced antenna elements, periodicity of the antenna lattice is disrupted between the third plurality of periodically spaced antenna elements and the fourth plurality of periodically spaced antenna elements, and periodicity of the antenna lattice is disrupted between the second plurality of periodically spaced antenna elements and the fourth plurality of periodically spaced antenna elements.

In some examples, one or more processes, such as capturing calibration measurements, computing calibration adjustments, computing parameters of a phased array antenna, and/or any combination thereof may be performed by one or more computing devices or apparatuses. In some examples, the phased array antenna systems, FEMs, BF modules, RFIO circuits, and/or other components described herein can be implemented by a UT or SAT shown in FIG. 1 and/or one or more computing devices with the computing device architecture 1600 shown in FIG. 16. In some cases, such a computing device or apparatus may include a processor, microprocessor, microcomputer, or other component of a device that is configured to carry out one or more operations described herein. In some examples, such computing device or apparatus may include one or more antennas for sending and receiving RF signals. In some examples, such computing device or apparatus may include a modem for sending, receiving, modulating, and demodulating RF signals.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

In some cases, one or more operations described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which any operations are described is not intended to be construed as a limitation, and any number of the described operations can be combined in any order and/or in parallel to implement the processes.

FIG. 16 illustrates an example computing device architecture 1600 of an example computing device which can implement various techniques and/or operations described herein. For example, the computing device architecture 1600 can be used to implement at least some portions of the UTs 102, SATs 104, and/or gateway terminals 106 shown in FIG. 1, phased array antenna system 200 of FIG. 2A and FIG. 2B, calibration configuration 440 of FIG. 4C, calibration configuration 450 of FIG. 4D, calibration configuration 460 of FIG. 4E, calibration configuration 470 of FIG. 4F, and/or calibration configuration 480 of FIG. 4G and perform at least some of the operations described herein. The components of the computing device architecture 1600 are shown in electrical communication with each other using a connection 1605, such as a bus. The example computing device architecture 1600 includes a processing unit (CPU or processor) 1610 and a computing device connection 1605 that couples various computing device components including the computing device memory 1615, such as read only memory (ROM) 1620 and random access memory (RAM) 1625, to the processor 1610.

The computing device architecture 1600 can include a cache of high-speed memory connected directly with, in close proximity to, or integrated as part of the processor 1610. The computing device architecture 1600 can copy data from the memory 1615 and/or the storage device 1630 to the cache 1612 for quick access by the processor 1610. In this way, the cache can provide a performance boost that avoids processor 1610 delays while waiting for data. These and other modules can control or be configured to control the processor 1610 to perform various actions. Other computing device memory 1615 may be available for use as well. The memory 1615 can include multiple different types of memory with different performance characteristics. The processor 1610 can include any general purpose processor and a hardware or software service stored in storage device 1630 and configured to control the processor 1610 as well as a special-purpose processor where software instructions are incorporated into the processor design. The processor 1610 may be a self-contained system, containing multiple cores or processors, a bus, memory controller, cache, etc. A multi-core processor may be symmetric or asymmetric.

To enable user interaction with the computing device architecture 1600, an input device 1645 can represent any number of input mechanisms, such as a microphone for speech, a touch-sensitive screen for gesture or graphical input, keyboard, mouse, motion input, speech and so forth. An output device 1635 can also be one or more of a number of output mechanisms known to those of skill in the art, such as a display, projector, television, speaker device. In some instances, multimodal computing devices can enable a user to provide multiple types of input to communicate with the computing device architecture 1600. The communication interface 1640 can generally govern and manage the user input and computing device output. There is no restriction on operating on any particular hardware arrangement and therefore the basic features here may easily be substituted for improved hardware or firmware arrangements as they are developed.

Storage device 1630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1625, read only memory (ROM) 1620, and hybrids thereof. The storage device 1630 can include software, code, firmware, etc., for controlling the processor 1610. Other hardware or software modules are contemplated. The storage device 1630 can be connected to the computing device connection 1605. In one aspect, a hardware module that performs a particular function can include the software component stored in a computer-readable medium in connection with the necessary hardware components, such as the processor 1610, connection 1605, output device 1635, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using signals and/or computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication devices, or integrated circuit devices having multiple uses including application in wireless communications and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

The embodiments of the invention in which an exclusive property or privilege is claimed are defined as follows:

1. An apparatus comprising:
an antenna lattice comprising a first plurality of periodically spaced antenna elements coupled to a first carrier and a second plurality of periodically spaced antenna elements coupled to a second carrier, wherein periodicity of the antenna lattice is disrupted between the first plurality of periodically spaced antenna elements and the second plurality of periodically spaced antenna elements;
a calibration line coupled to a first subset of antenna elements of the first plurality of periodically spaced antenna elements and a second subset of antenna elements of the second plurality of periodically spaced antenna elements, wherein the calibration line comprises a plurality of calibration line segments between pairs of antenna elements included in at least one of the first subset of antenna elements or the second subset of antenna elements and wherein respective effective lengths of the plurality of calibration line segments are known; and
one or more calibration components configured to:
perform a first relative calibration of complex gains of the first plurality of periodically spaced antenna elements based on over-the-air (OTA) calibration measurements to obtain a calibrated first plurality of periodically spaced antenna elements;
perform a second relative calibration of complex gains of the second plurality of periodically spaced antenna elements based on OTA calibration measurements;
perform a third relative calibration of complex gains of the first subset of antenna elements and the second subset of antenna elements based on in-line calibration measurements of coupling between the calibration line and respective antenna elements of the first subset of antenna elements and the second subset of antenna elements to obtain a relative calibration; and
calibrate complex gains of the first plurality of periodically spaced antenna elements and the second plurality of periodically spaced antenna elements based on the relative calibration.

2. The apparatus of claim 1, wherein the first carrier comprises a first printed circuit board (PCB) and the second carrier comprises a second PCB.

3. The apparatus of claim 2, wherein the antenna lattice is disrupted by a gap between the first PCB and the second PCB.

4. The apparatus of claim 3, wherein the calibration line is connected across the gap between the first PCB and the second PCB.

5. The apparatus of claim 2, wherein:
a first calibration measurement port on the first PCB is coupled to the calibration line; and
a second calibration measurement port on the second PCB is coupled to the calibration line.

6. The apparatus of claim 1, wherein each antenna element of the first plurality of periodically spaced antenna elements and each antenna element of the second plurality of periodically spaced antenna elements comprises a respective dedicated transmit port and a respective dedicated receive port.

7. The apparatus of claim 6, wherein each antenna element of the first plurality of periodically spaced antenna elements and each antenna element of the second plurality of periodically spaced antenna elements comprises a respective dual linearly polarized antenna port coupled to a respective port of a −3 decibel (dB) 90-degree hybrid coupler, wherein each respective dedicated transmit port comprises a first circularly polarized port of the −3 dB 90-degree hybrid coupler and each respective dedicated receive port comprises a second circularly polarized port of the −3 dB 90-degree hybrid coupler.

8. The apparatus of claim 1, further comprising:
a third plurality of periodically spaced antenna elements included in the antenna lattice and coupled to a third carrier, wherein complex gains of the third plurality of periodically spaced antenna elements are calibrated based on OTA calibration measurements;
a fourth plurality of periodically spaced antenna elements included in the antenna lattice and coupled to a fourth carrier, wherein complex gains of the third plurality of periodically spaced antenna elements are calibrated based on OTA calibration measurements;
one or more additional calibration lines configured to obtain relative calibration measurements of respective subsets of the first, second, third, and fourth plurality of periodically spaced antenna elements; and
one or more calibration components configured to calibrate complex gain between antenna elements of the first plurality of periodically spaced antenna elements, the second plurality of periodically spaced antenna elements, the third plurality of periodically spaced antenna elements, and the fourth plurality of periodically spaced antenna elements based on in-line calibration measurements between the respective subsets of the first, second, third, and fourth plurality of periodically spaced antenna elements and a plurality of calibration lines, wherein the plurality of calibration lines includes the calibration line and the one or more additional calibration lines.

9. The apparatus of claim 8, wherein the first carrier, the second carrier, the third carrier, and the fourth carrier comprise, respectively, a first PCB, a second PCB, a third PCB, and a fourth PCB arranged in a rectangular lattice.

10. The apparatus of claim 9, wherein:
periodicity of the antenna lattice is disrupted between the first plurality of periodically spaced antenna elements and the second plurality of periodically spaced antenna elements;
periodicity of the antenna lattice is disrupted between the first plurality of periodically spaced antenna elements and the third plurality of periodically spaced antenna elements;
periodicity of the antenna lattice is disrupted between the third plurality of periodically spaced antenna elements and the fourth plurality of periodically spaced antenna elements; and
periodicity of the antenna lattice is disrupted between the second plurality of periodically spaced antenna elements and the fourth plurality of periodically spaced antenna elements.

11. A method for calibrating a phased array antenna, comprising:
performing a first relative calibration of complex gains of a first plurality of periodically spaced antenna elements of an antenna lattice based on OTA calibration measurements to obtain a calibrated first plurality of periodically spaced antenna elements;
performing a second relative calibration of complex gains of a second plurality of periodically spaced antenna elements of the antenna lattice based on OTA calibration measurements;
performing a third relative calibration of complex gains of a first subset of antenna elements of the first plurality of periodically spaced antenna elements and a second subset of antenna elements of the second plurality of periodically spaced antenna elements based on in-line calibration measurements of coupling between a calibration line and respective antenna elements of the first subset of antenna elements and the second subset of antenna elements to obtain a relative calibration; and
calibrating complex gains of the first plurality of periodically spaced antenna elements and the second plurality of periodically spaced antenna elements based on the relative calibration.

12. The method of claim 11, wherein a first carrier comprises the first plurality of periodically spaced antenna elements and a second carrier comprises the second plurality of periodically spaced antenna elements.

13. The method of claim 12, wherein the antenna lattice is disrupted by a gap between the first carrier and the second carrier.

14. The method of claim 13, wherein the calibration line is connected across the gap between the first carrier and the second carrier.

15. The method of claim 12, wherein:
a first calibration measurement port on the first carrier is coupled to the calibration line; and
a second calibration measurement port on the second carrier is coupled to the calibration line.

16. The method of claim 12, further comprising:
a third plurality of periodically spaced antenna elements included in the antenna lattice and coupled to a third carrier, wherein complex gains of the third plurality of periodically spaced antenna elements are calibrated based on OTA calibration measurements;
a fourth plurality of periodically spaced antenna elements included in the antenna lattice and coupled to a fourth carrier, wherein complex gains of the third plurality of periodically spaced antenna elements are calibrated based on OTA calibration measurements;
the calibration line and one or more additional calibration lines are configured to obtain relative calibration measurements of respective subsets of the first, second, third, and fourth plurality of periodically spaced antenna elements; and
one or more calibration components are configured to calibrate complex gain between antenna elements of the first plurality of periodically spaced antenna elements, the second plurality of periodically spaced antenna elements, the third plurality of periodically spaced antenna elements, and the fourth plurality of periodically spaced antenna elements based on in-line calibration measurements between the respective subsets of the first, second, third, and fourth plurality of periodically spaced antenna elements and a plurality of calibration lines, wherein the plurality of calibration lines includes the calibration line and the one or more additional calibration lines.

17. The method of claim 16, wherein the first carrier, the second carrier, the third carrier, and the fourth carrier comprise, respectively, a first PCB, a second PCB, a third PCB, and a fourth PCB arranged in a rectangular lattice.

18. The method of claim 17, wherein:
periodicity of the antenna lattice is disrupted between the first plurality of periodically spaced antenna elements and the second plurality of periodically spaced antenna elements;
periodicity of the antenna lattice is disrupted between the first plurality of periodically spaced antenna elements and the third plurality of periodically spaced antenna elements;
periodicity of the antenna lattice is disrupted between the third plurality of periodically spaced antenna elements and the fourth plurality of periodically spaced antenna elements; and
periodicity of the antenna lattice is disrupted between the second plurality of periodically spaced antenna elements and the fourth plurality of periodically spaced antenna elements.

19. The method of claim 11, wherein each antenna element of the first plurality of periodically spaced antenna elements and each antenna element of the second plurality of periodically spaced antenna elements comprises a respective dedicated transmit port and a respective dedicated receive port.

20. The method of claim 19, wherein each antenna element of the first plurality of periodically spaced antenna elements and each antenna element of the second plurality of periodically spaced antenna elements comprises a respective dual linearly polarized antenna port coupled to a respective −3 dB 90-degree hybrid coupler, wherein each respective dedicated transmit port comprises a first circularly polarized port of the −3 dB 90-degree hybrid coupler and each respective dedicated receive port comprises a second circularly polarized port of the −3 dB 90-degree hybrid coupler.
